(19) United States
(12) Patent Application Publication
(10) Pub. No.: US 2012/0101881 A1
(43) Pub. Date: Apr. 26, 2012

(54) LOYALTY PROMOTION APPARATUSES, METHODS AND SYSTEMS

(76) Inventors: Mary Theresa Taylor, San Francisco, CA (US); Karen L. Cervenka, Belmont, CA (US); Shilpak Mahadkar, Oakland, CA (US); Barbara Elizabeth Patterson, South San Francisco, CA (US)

(21) Appl. No.: 13/115,933

(22) Filed: May 25, 2011

Related U.S. Application Data
(63) Continuation-in-part of application No. 12/624,184, filed on Nov. 23, 2009.
Application No. 12/624,184 is a continuation-in-part of application No. PCT/US2009/065810, filed on Nov. 24, 2009.
Application No. PCT/US2009/065810 is a continuation of application No. 12/624,184, filed on Nov. 23, 2009.
(60) Provisional application No. 61/117,846, filed on Nov. 25, 2008.
(60) Provisional application No. 61/117,846, filed on Nov. 25, 2008.

(51) Int. Cl. G06Q 30/02

(52) U.S. Cl. 705/14.13; 705/14.38; 705/14.36

(57) ABSTRACT

The LOYALTY PROMOTION APPARATUSES, METHODS AND SYSTEMS (“L-PROMO”) transforms consumer credentials, consumer opt-in activities, and, merchant campaign setup inputs via L-PROMO components into a financial transaction and offer redemption outputs. In one implementation, a method is disclosed, comprising: receiving consumer identifying information from a consumer electronic wallet vehicle; receiving merchant information and a proposed transaction from a merchant terminal; initiating consumer payment by sending a payment approval to an electronic wallet account; receiving a request to apply a promotional offer; determining consumer eligibility to apply the promotional offer to the proposed transaction; applying the promotional offer to the proposed transaction by returning credits to the consumer based on terms of the promotional offer; sending transaction details to the consumer; and sending a message to a social network indicating the transaction on the consumer's social media page.

### RELATED APPLICATIONS

This application is a National Stage Entry and continuation-in-part of, and hereby claims priority under 35 U.S.C. §§119, 120, 365 and 371, to corresponding PCT Application No. PCT/US2009/065810, entitled “Promotional Item Identification In Processing Of An Acquired Transaction On An Issued Account,” filed on Nov. 24, 2009, which in turn claims priority to pending U.S. patent application Ser. No. 12/624,184, entitled “Promotional Item Identification In Processing Of An Acquired Transaction On An Issued Account,” filed on Nov. 23, 2009, and U.S. provisional patent application Ser. No. 61/117,846, filed on Nov. 25, 2008, entitled “Promotional Item Identification In Private Label And Co-Brand In-Store Processing Of An Acquired Transaction On An Issued Account Applicant hereby claims priority for Patent Cooperation Treaty Patent.”

This application is a continuation-in-part of, and hereby claims priority under 35 U.S.C. §120, to pending U.S. patent application Ser. No. 12/624,184, entitled “Promotional Item Identification In Processing Of An Acquired Transaction On An Issued Account,” filed on Nov. 23, 2009, which in turn claims priority under 35 U.S.C. §119 to U.S. provisional patent application Ser. No. 61/117,846, filed on Nov. 25, 2008, entitled “Promotional Item Identification In Private Label And Co-Brand In-Store Processing Of An Acquired Transaction On An Issued Account Applicant hereby claims priority for Patent Cooperation Treaty Patent.”

The entire contents of the aforementioned applications are herein expressly incorporated by reference

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to electronic financial transactions, and more particularly, to LOYALTY PROMOTION APPARATUSES, METHODS AND SYSTEMS.

### BACKGROUND

Consumers may collect coupons to buy products and redeem the coupon afterwards. For example, a consumer may cut a paper coupon from a magazine, and bring it to a cashier when purchasing. The cashier may verify the coupon, and enter the content of the coupon associated with the purchased product. After the purchase, the consumer may mail a receipt of the purchase and a copy of the coupon to the coupon provider (e.g., a manufacturer, etc.). Upon verification of the purchase and the coupon, the coupon provider may redeem the coupon for the consumer, e.g., providing a rebate amount to the consumer.

### BRIEF DESCRIPTION OF THE DRAWINGS

The accompanying appendices and/or drawings illustrate various non-limiting, example, innovative aspects in accordance with the present descriptions:

FIGS. 1A-1B show block diagrams illustrating data flows between MBC-Platform server and affiliated entities within various embodiments of the L-PROMO;

FIGS. 2A-2C show logic flow diagrams illustrating embodiments of the L-PROMO;

FIGS. 3A-3C show logic flow diagrams illustrating enrollment experience within embodiments of the L-PROMO;

FIGS. 4A-4D show logic flow diagrams illustrating merchant campaign management within embodiments of the L-PROMO;

FIG. 5A shows an example integration of L-PROMO and electronic wallet within embodiments of the L-PROMO;

FIGS. 5B-5G show example screenshot diagrams illustrating embodiments of the L-PROMO;

FIGS. 6A-6E show example screenshot diagrams illustrating consumer mobile applications within embodiments of the L-PROMO;

FIGS. 7A-7L show example screenshot diagrams illustrating consumer/merchant experience within alternative embodiments of the L-PROMO;

FIGS. 8A-8L show logic flow diagrams and block diagrams illustrating alternative embodiments of the L-PROMO;

FIG. 9 provides an example implementation of data compartmentalization within embodiments of the L-PROMO;

FIGS. 10A-D show application user interface diagrams illustrating example features of a mobile app in some embodiments of the L-PROMO;

FIGS. 11A-C show data flow diagrams illustrating an example card-based transaction in some embodiments of the L-PROMO;

FIGS. 12A-D show logic flow diagrams illustrating example aspects of executing a card-based transaction in some embodiments of the L-PROMO;

FIGS. 13A-13C provide a logic flow diagram and example screen shots illustrating aspects of loyalty points conversion offers within embodiments of the L-PROMO; and

FIG. 14 shows a block diagram illustrating embodiments of a L-PROMO controller;

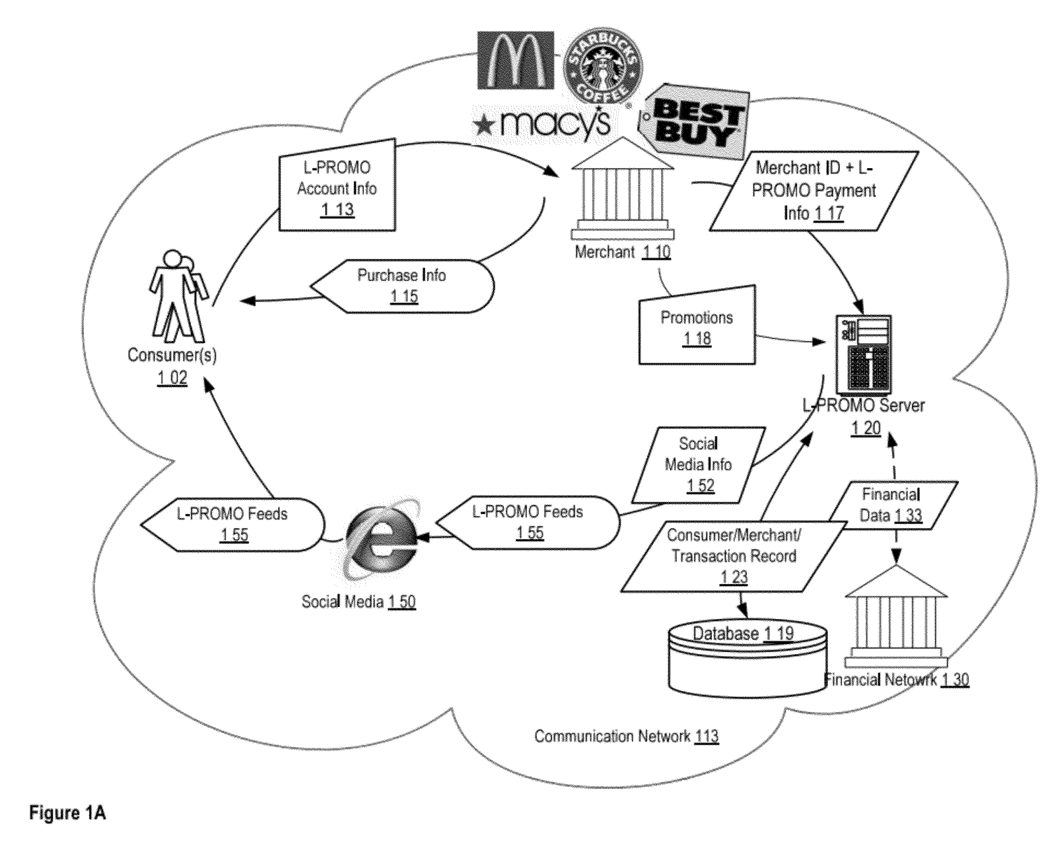

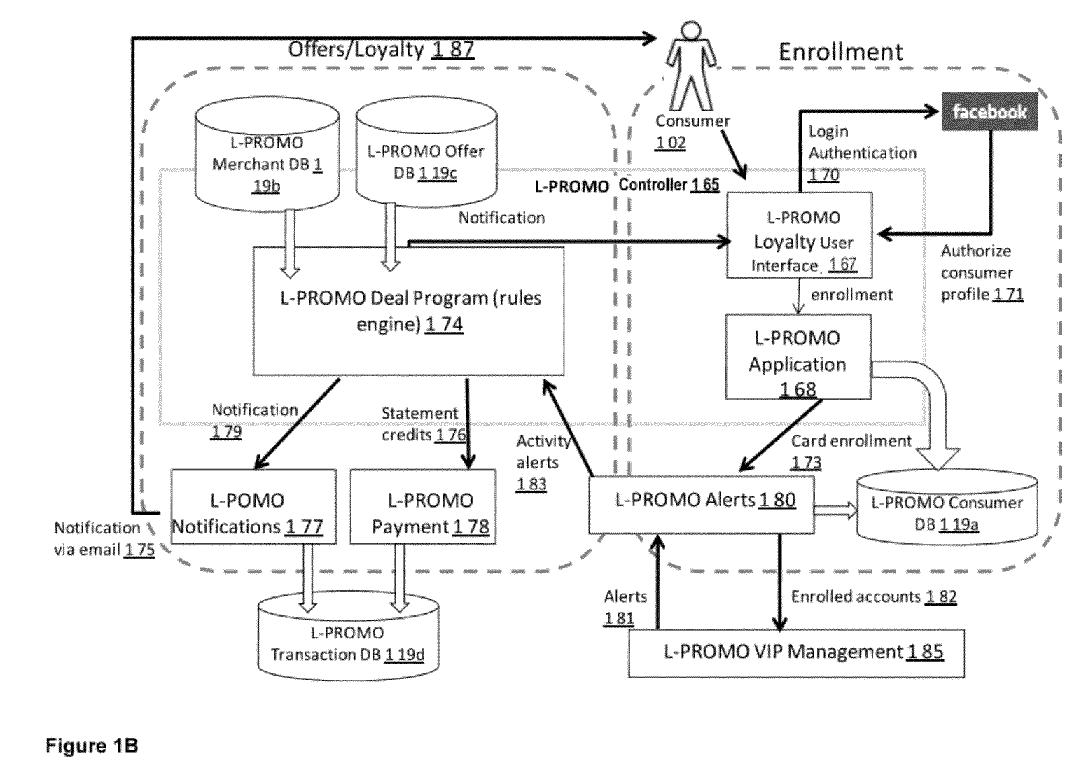

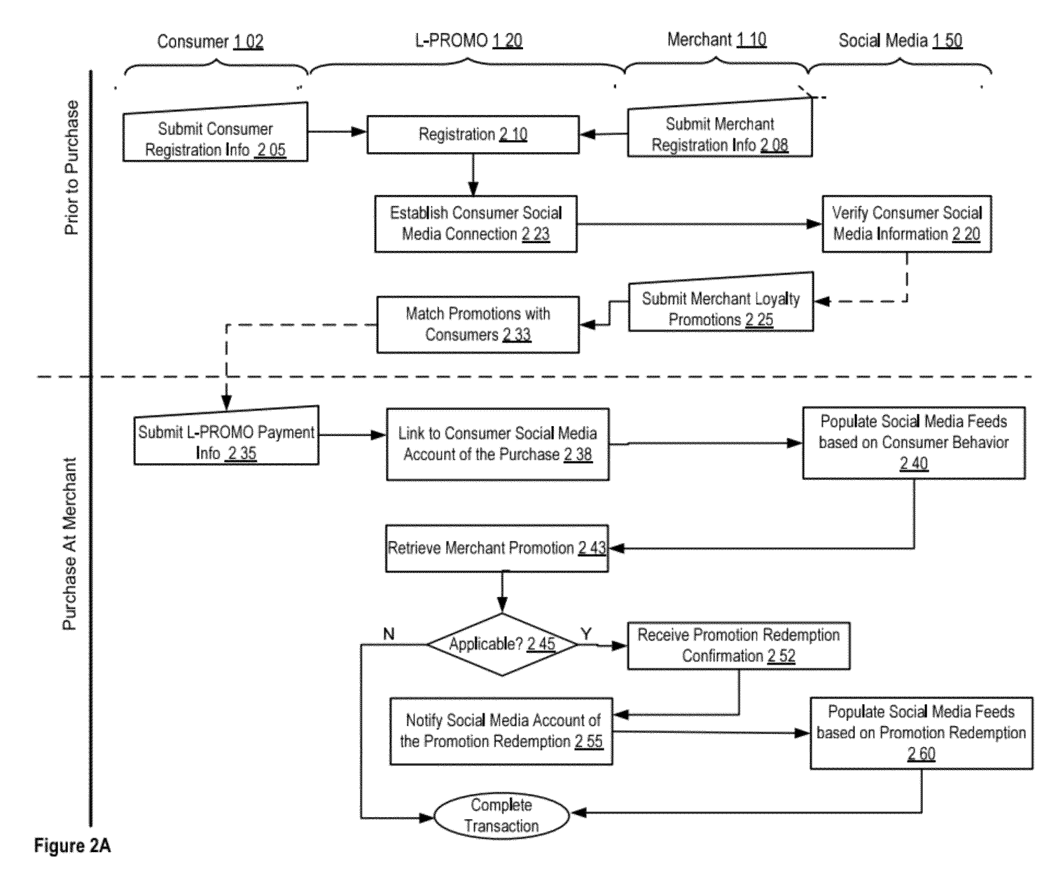

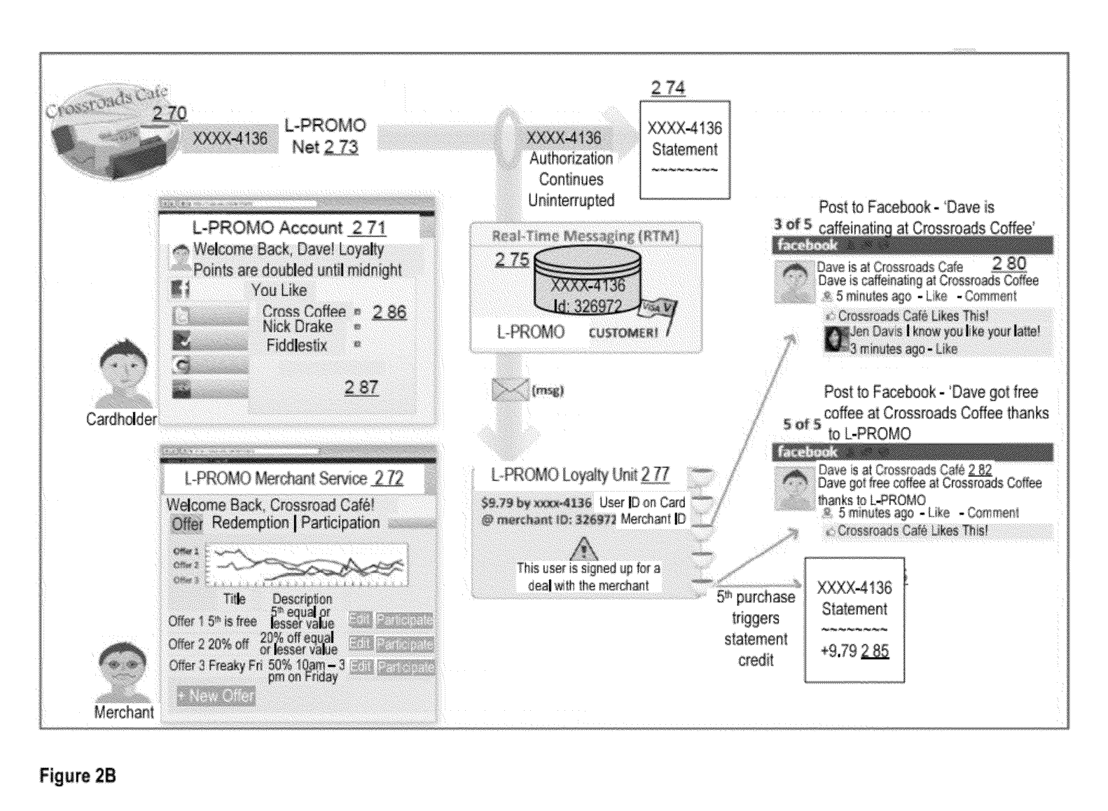

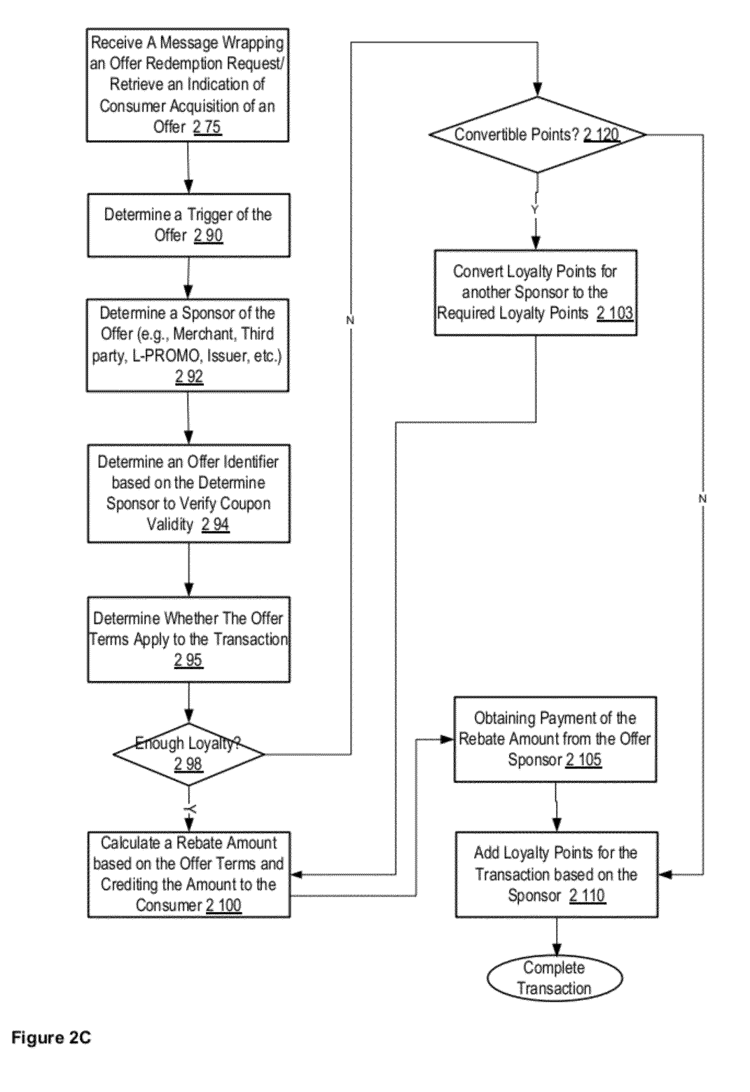

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The LOYALTY PROMOTION APPARATUSES, METHODS AND SYSTEMS provides a platform which bridges merchants and consumers in offers and promotion matching. In one implementation, merchants may offer deals to consumers in an social/mobile setting via the L-PROMO platform, and the consumers may redeem offers and share offers and their purchasing experience with friends via the L-PROMO platform.

### L-PROMO

FIG. 1A shows a block diagram illustrating data flows between MBC-Platform server and affiliated entities within various embodiments of the L-PROMO. Within various embodiments, one or more consumers user(s) 102, L-PROMO server 120, L-PROMO database(s) 119, merchants 110, mobile carrier 125, financial network(s)/system(s) 130, and/or social media 150 are shown to interact via various communication network 113.

In one embodiment, a consumer 102, may be associated with a L-PROMO account, which may be linked to the consumer's one or more of a bank account, a L-PROMO service account, a merchant membership account, and/or the like, and also linked to the consumer's social media account, such as Facebook, Twitter, and/or the like. For example, a consumer may establish a L-PROMO account with the L-PROMO server which may comprise an electronic wallet linked the user's Bank of America checking account, a Chase credit card account, a Sam's Club membership account, and/or the like. The consumer may also provide credentials of his Facebook account, Twitter account, and/or the like to the L-PROMO account to bridge social media with his electronic wallet.

In one embodiment, upon registering with L-PROMO, the consumer 102 may provide L-PROMO account information 113 to a merchant 110 during checkout. For example, the consumer 102 may swipe a L-PROMO enabled card at a point of sale (POS) terminal at the merchant store. For another example, the consumer may submit his L-PROMO card information during an online purchase transaction to a merchant site. The merchant 110 may in turn provide purchase information 115 (e.g., a receipt, etc.) to the consumer.

In one embodiment, the merchant 110 may submit a merchant ID and the consumer's L-PROMO payment information 117 to the L-PROMO server 120 for promotions/offers redemption and payment processing. In another embodiment, the merchant may submit information with regard to promotions, offers, rewards, and/or the like 118 to the L-PROMO server 120. For example, the merchant may provide loyalty discounts to a consumer when the L-PROMO has verified that the consumer has repeated purchasing record with the merchant.

In one embodiment, the L-PROMO server 120 may process the payment request, and communicate with a financial network 130 to exchange financial data 133 to perform the financial transaction. In another implementation, the L-PROMO server 120 may be integrated with a financial payment platform.

In one embodiment, the L-PROMO server 120 may generate L-PROMO feeds 155 indicating the consumer's purchase with the merchant, and/or the redemption of an applicable loyalty promotion. Such L-PROMO feeds may be propagated to the social media together with the consumer's social media account information 152 associated with the consumer's L-PROMO account.

FIG. 1B illustrates an implementation of L-PROMO component interactions in one embodiment of the L-PROMO. The L-PROMO platform may contain a number of modules and/or data stores. A L-PROMO controller 165 may serve a central role in some embodiments of L-PROMO operation, serving to orchestrate the reception, generation, and distribution of data and/or instructions to, from and between target device(s) and/or client device(s) via L-PROMO modules and in some instances mediating communications with external entities and systems.

In one embodiment, the L-PROMO controller 165 may be housed separately from other modules and/or databases within the L-PROMO system, while in another embodiment, some or all of the other modules and/or databases may be housed within and/or configured as part of the L-PROMO controller. For example, the L-PROMO controller may be associated with a L-PROMO web server housed in a financial institution. For another example, the L-PROMO control may comprise remote control access component, such as a web applet running on a L-PROMO consumer user interface, and/or the like. Further detail regarding implementations of L-PROMO controller operations, modules, and databases is provided below.

In one embodiment, the L-PROMO Controller 205 may be coupled to one or more interface components and/or modules. In one embodiment, the L-PROMO Controller may be coupled to a L-PROMO loyalty user interface (UI) 167. The user interface 167 may be configured to receive user inputs and display application states and/or other outputs. The UI may, for example, allow a user to adjust L-PROMO system settings, select communication methods and/or protocols, initiate a remote display mode, engage mobile device application features, identify possible target/client device(s) and/or the like. In one implementation, the user interface 210 may include, but not limited to devices such as, keyboard(s), mouse, stylus(es), touch screen(s), digital display(s), and/or the like.

In one implementation, the L-PROMO loyalty user interface 167 may allows consumers 102 to enroll and provide card information. In another implementation, the L-PROMO UI 167 may facilitate integration with social networks (e.g., Facebook) for consumer enrollment and consumer (e.g., Facebook) profile access. For example, the L-PROMO may provide consumer login authentication 170 to Facebook via the L-PROMO UI 167 to establish connection with the social media platform, and the Facebook may in turn authorize consumer profile 171 to be connected to the created L-PROMO account.

In one embodiment, the L-PROMO Controller may further be coupled to a L-PROMO applications engine 168, configured to run device application software. In one implementation, the L-PROMO applications engine 168 may manage consumer enrollment and consumer offer history, and facilitate application user integration along with backend integration with L-PROMO modules and/or data stores. For example, an application run by the L-PROMO applications engine 167 may comprise a web application, which may receive consumer L-PROMO enrollment 173 information, and store it in the L-PROMO consumer database 119a.

In one implementation, the L-PROMO application 168 may send card enrollment information 173 to a L-PROMO alerts module 180, which may generate consumer activity alerts. For example, the L-PROMO alerts module 180 may send consumer activity alerts 183, such as consumer clicks on an offer, consumer has transacted with a merchant, and/or the like, to a L-PROMO deal program engine 174. For another example, the L-PROMO alerts module 180 may send enrolled accounts information 182 to a L-PROMO VIP management module 185 for record, which may in turn send VIP customer alerts 181 to the L-PROMO alerts module 180, e.g., the VIP customer's transaction history, membership updates, and/or the like.

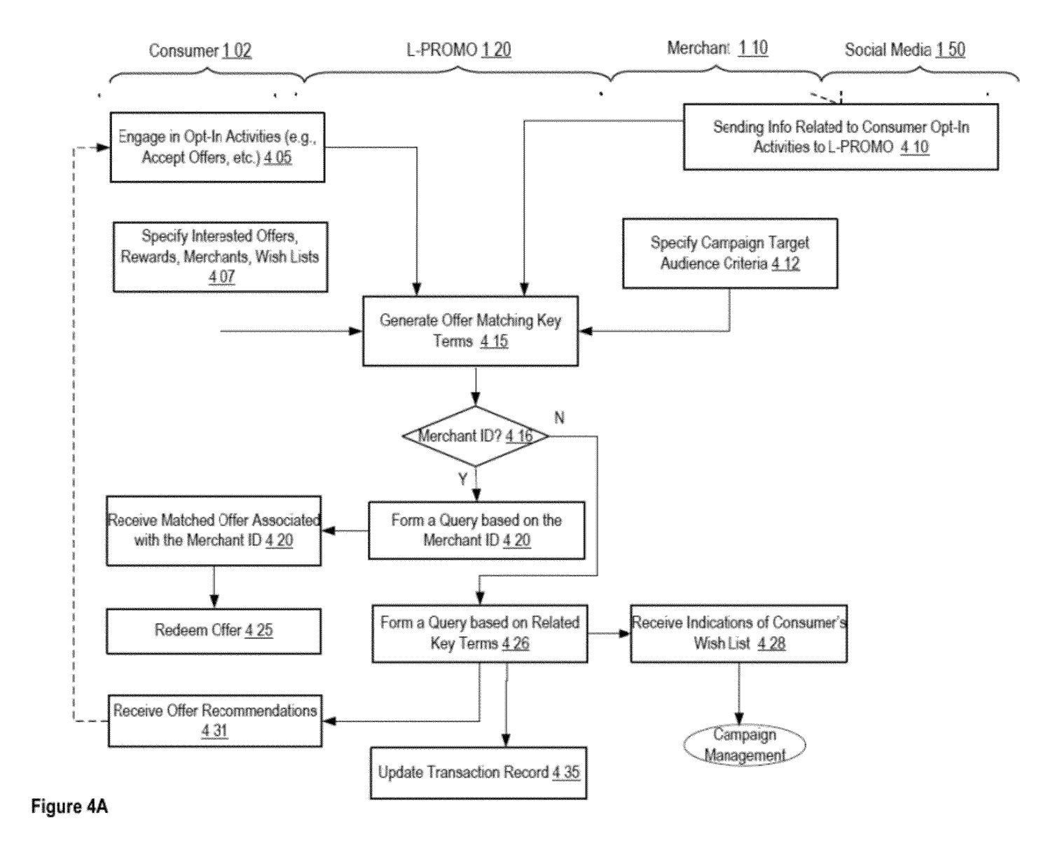

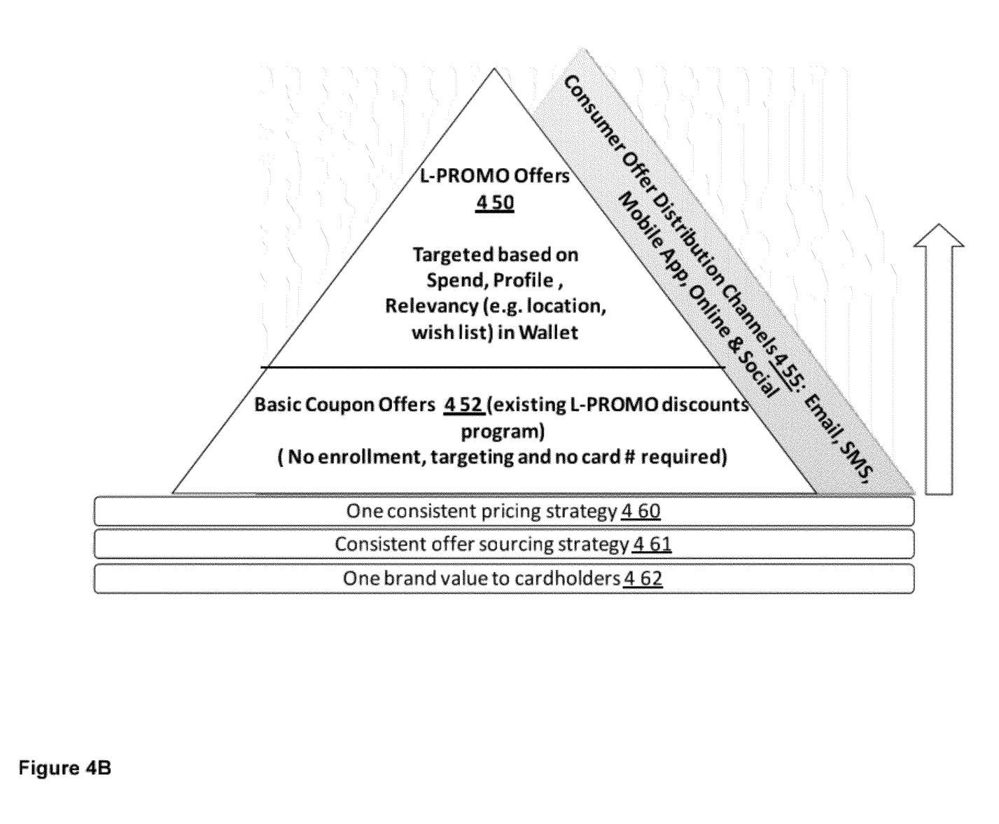

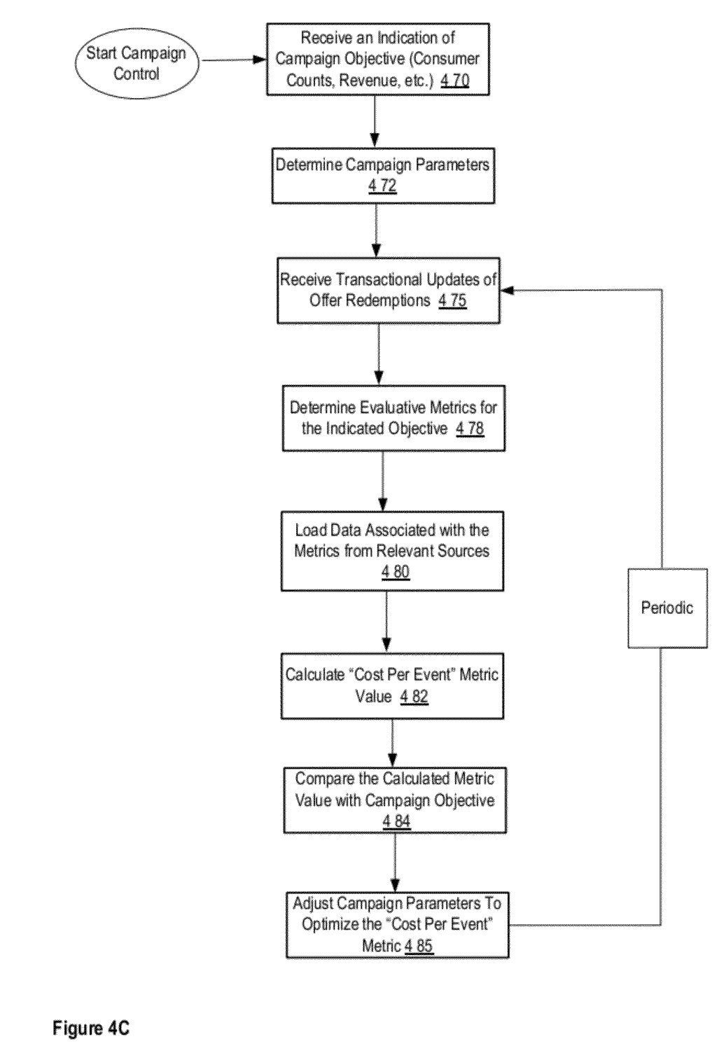

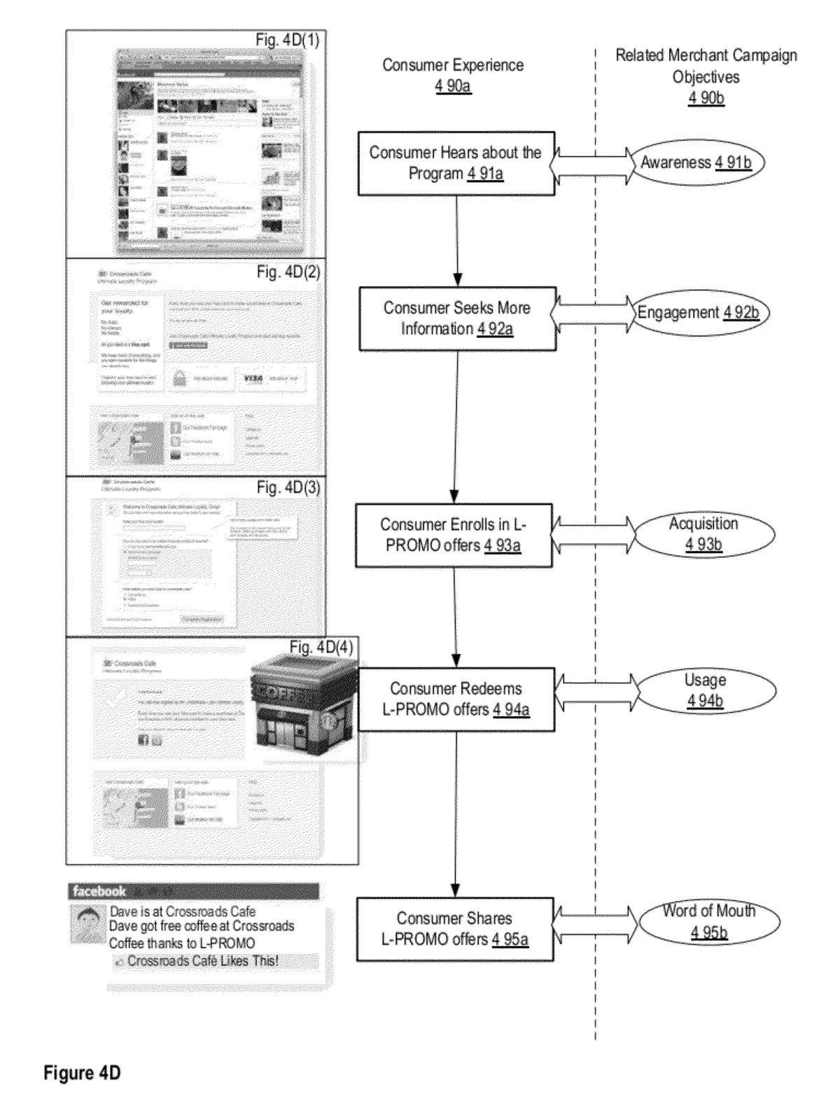

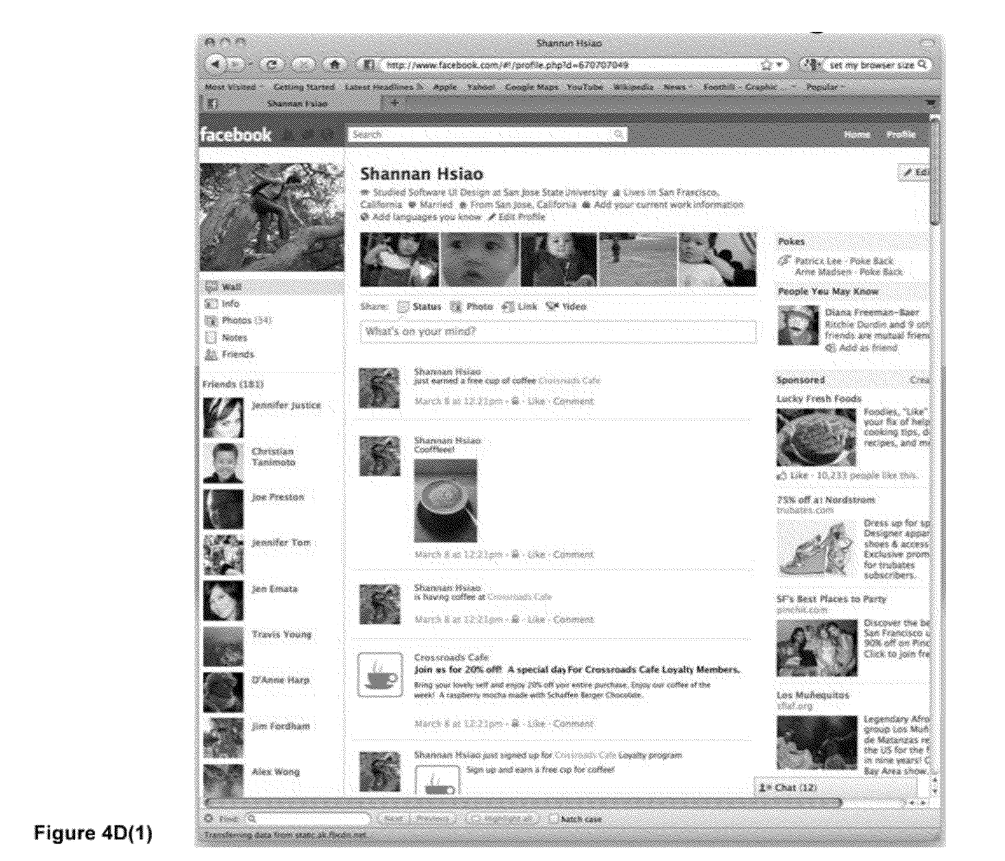

In one implementation, the L-PROMO Controller 165 may further be coupled to the L-PROMO deal program engine 174, configured to interface with and/or process deal information, offer redemption information sent from L-PROMO notification module 177 and L-PROMO payment module 178. The L-PROMO deal program engine 174 may offer management engine to qualify transactions against offer rules, process alerts, statement credits and notifications. For example, the L-PROMO deal program engine 174 may receive consumer activity alerts 183, based on which the L-PROMO deal engine 174 may match offers stored in the L-PROMO offer database 119c with a consumer 102, as further discussed in FIG. 4A. The L-PROMO deal program engine 174 may generate notifications of new offers, consumer offer redemption, and/or the like, and send the notification 179 to the L-PROMO notifications module 177. The L-PROMO deal engine may further generate requests for offer redemption, e.g., rebate points issuance 176, etc., to L-PROMO payment module 178, all of which may be stored in the L-PROMO transaction database 119d upon completion of the transaction.

In a further implementation, the L-PROMO deal engine 174 may send notification to the social media, e.g., Facebook, via the L-PROMO UI 167, to populate merchant offers. For example, a merchant Facebook page may post offers received from the L-PROMO deal engine 174. For another example, a consumer's Facebook account may receive recommendation of offers based on the offer matching conducted at L-PROMO deal engine 174.

In a further implementation, the L-PROMO deal engine 174 may process consumer alerts, identify offers based on consumer transactions, apply statement credits for consumers. For example, the L-PROMO notification module 177 may send notification of offer recommendations 187, offer redemption details, transaction details, and/or the like to a consumer 102 via email 175. For example, the consumer 102 may have registered an email address during enrollment with L-PROMO by entering the email address through L-PROMO UI 167.

In one implementation, the L-PROMO controller 165 may further be coupled to a plurality of databases configured to store and maintain L-PROMO data, such as, but not limited to a L-PROMO consumer database 119a, a L-PROMO merchant database 119b, a L-PROMO offer database 119c, a L-PROMO transaction database 119d, and/or the like. In one embodiment, the L-PROMO modules may establish data records of registered consumers, merchants, promotions, past transactions and redemptions for storage in the databases 119a-d. For example, A merchant registry at the L-PROMO may comprise data entries such as, but not limited to merchant ID, merchant URL, position coordinates, latitude, longitude, offer notifications, messaging campaign settings, campaign management, offer delivery, messaging, redemption, analytics, and/or the like.

For example, an exemplar XML code of a merchant record may take a form similar to the following:

```
<Merchant>
      <MerchantID>
      123456789
      </MerchantID>
      <MerchantName>
      All Grocery
      </MerchantName>
      </MerchantAddress>
      111 White road
      </MerchantAddress>
      <MerchantGPSInfo>
          N 66666 W 7777777
      </MerchantGPSInfo>
      ...
      </MerchantTerminalID>
      11111111
      </MerchantTerminalID>
      <MerchantLicenseInfo>
                  .....
      </MerchantLicenseInfo>
      <MerchantWebsite>
      www.allGrocery.com
      </MerchantWebsite>
      <MerchantParticipatingSite>
          <Site1>
              www.amazon.com
          </Site1>
          ...
      </MerchantParticipatingSite>
      <MerchantProduct>
          <Product1>
              <ProductID>
                  00023213
              </ProductID>
              <ProductBrand>
                  Green Farm
              </ProductBrand>
              <ProductBarCode>
                  ...
              </ProductBarCode>
              ...
          </Product1>
              ...
      </MerchantProduct>
      <MerchantOffer>
          <OfferCode>
          898989898
          </OfferCode>
          <OfferInstruction>
          30% OFF BAKERY AT 3rd Purchase
          </OfferInstruction>
          <OfferCurrency>
          Store Points
          </OfferCurrency>
      ...
      </MerchantOffer>
      ...
</Merchant>
```

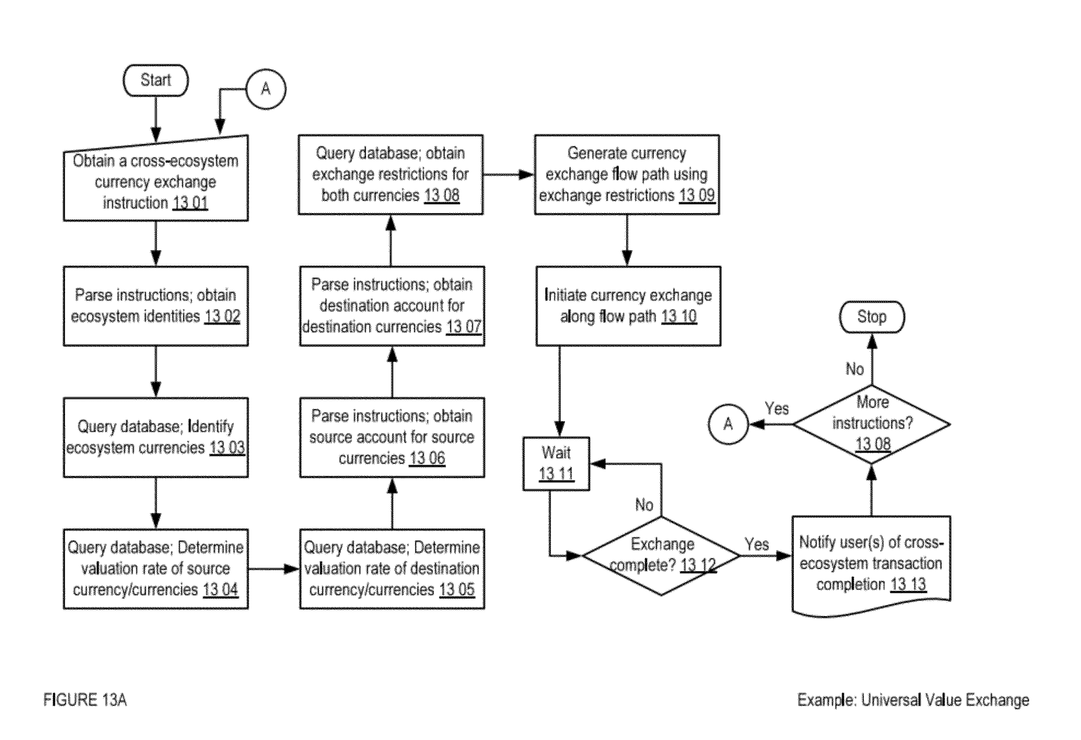

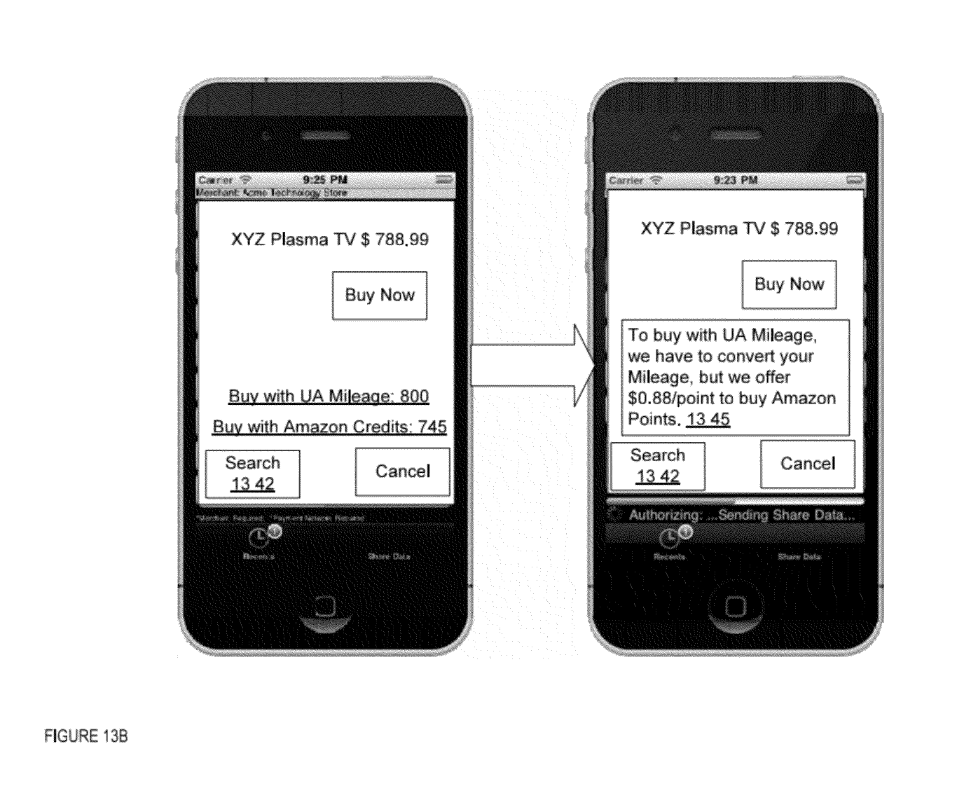

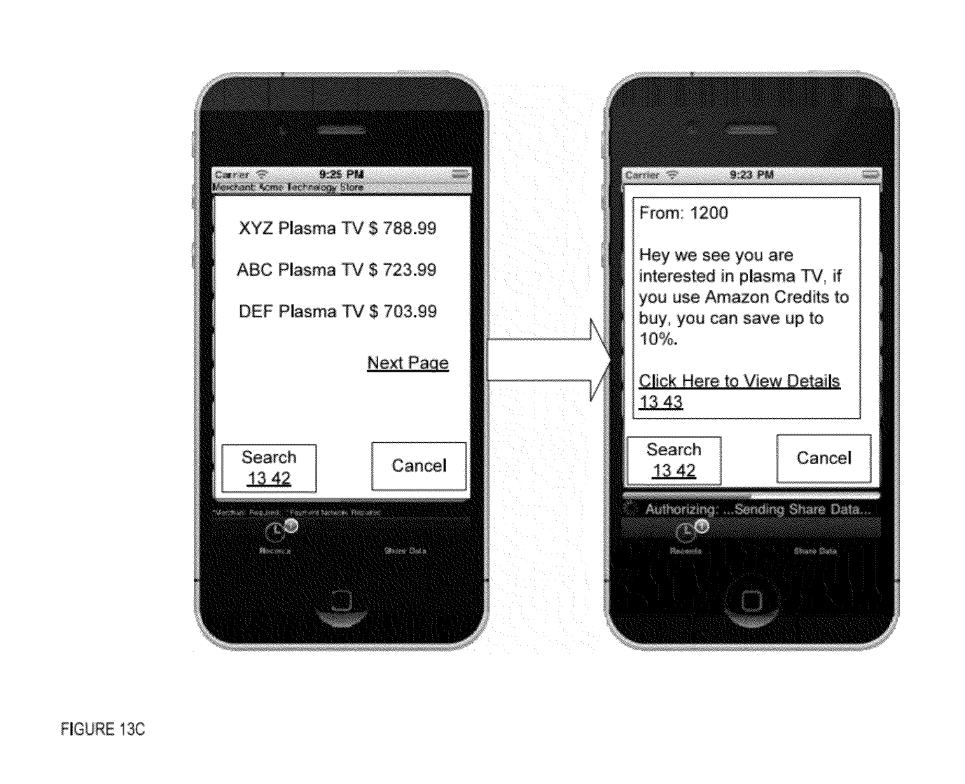

Further implementations of the L-PROMO databases 119a-d are discussed in FIG. 13.

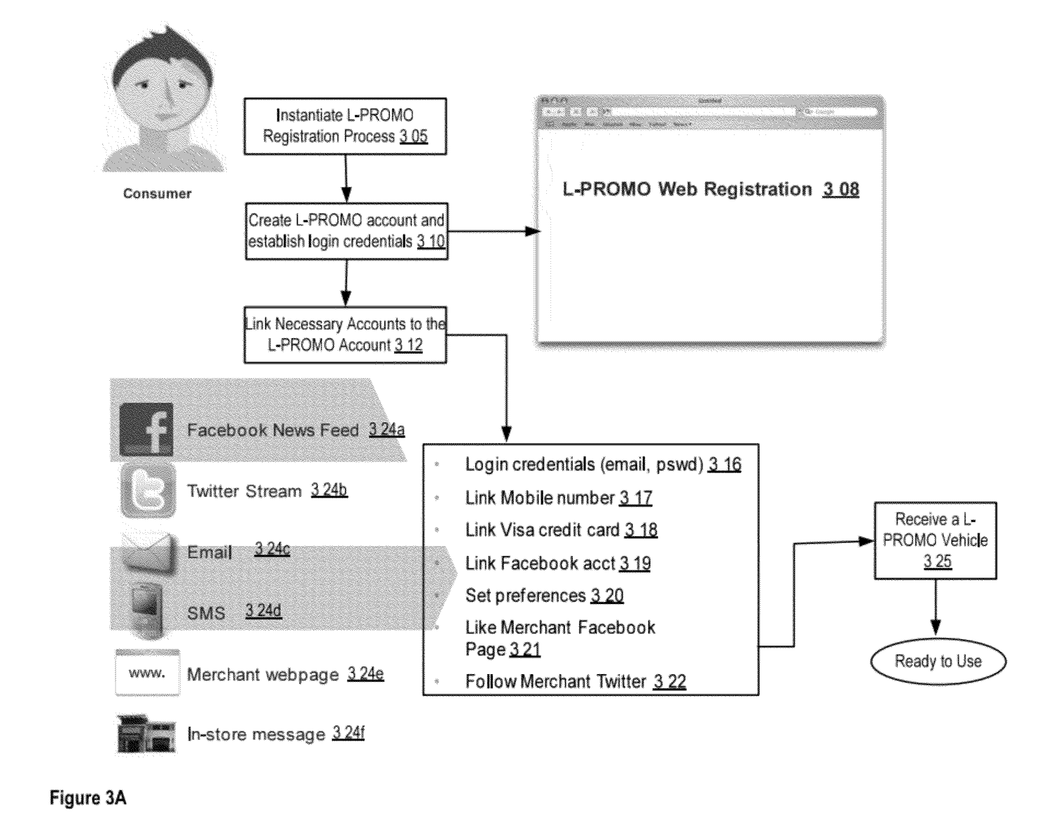

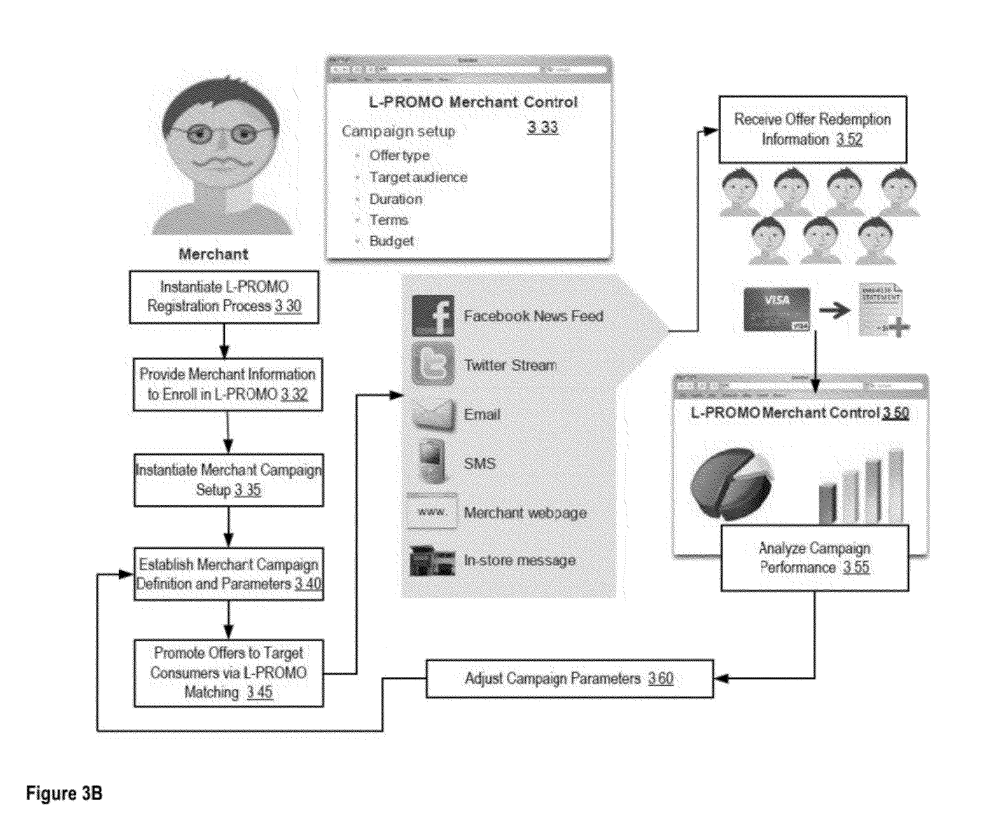

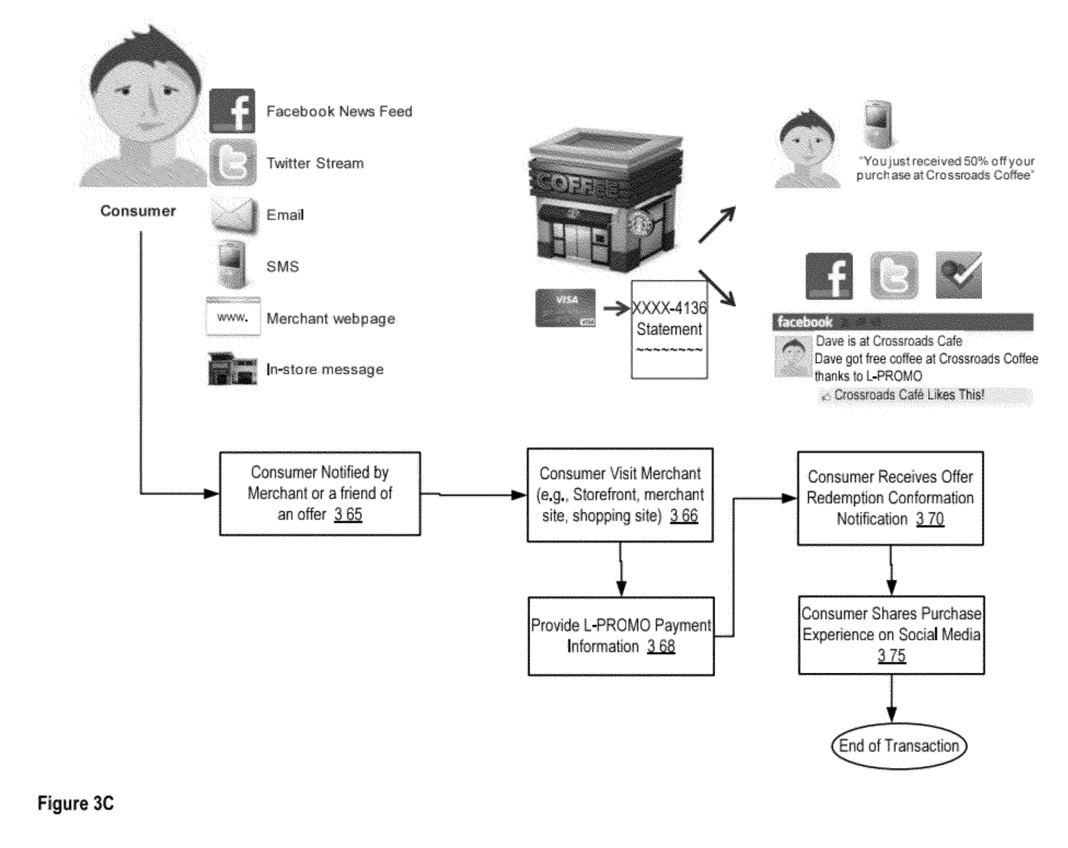

FIG. 2A provides a logic flow diagram illustrating embodiments of the L-PROMO. In one embodiment, the consumer 102 and a merchant 110 may register with the L-PROMO 120 prior to any purchase transaction. For example, in one implementation, the consumer 102 may submit identifying information (e.g. consumer name, address, phone number, email address, social media account, and/or the like) and financial information to associate his bank account information, merchant membership information, and/or the like, and social media account information (e.g., Facebook, Twitter, Yelp, etc.) 205 to the L-PROMO 120 to create a L-PROMO account. In another implementation, the merchant no may enroll in the L-PROMO 120 by providing 208 its identification information, geographical location information, website URL information, and/or the like. In one implementation, the merchant may be registered as a brand, e.g., the brand “GAP” may be registered associated with its retail stores, etc. In another implementation, a merchant may register as a promotion partner with another merchant, e.g., merchants as promotion partners may issue bundled offers, such as, “get 15% off all GAP jeans with any purchase of FreeBrand T-Shirt,” etc. In one embodiment, the L-PROMO may establish consumer social media connections 223. For example, the L-PROMO may verify consumer social media information 220 with a social media network 150, and bundle the consumer's social media accounts (e.g., Facebook, Yelp, Twitter, etc.) with the consumer's L-PROMO account. In another example, the L-PROMO may further establish a mobile communication channel with the consumer's L-PROMO account. For example, the consumer may register a cellular phone number, an Apple account, etc. with L-PROMO so as to receive mobile updates from L-PROMO. Further implementations of consumer and merchant enrollment are discussed in FIGS. 3A-3B.

In one implementation, upon registration, a merchant may submit merchant promotions, offers, rewards, and/or the like to the L-PROMO 225. For example, the merchant may devise a product campaign and issue offers to consumers to promote loyalty promotions. In one implementation, the merchant may devise individual targeted campaign promotions based on statistic data of targeted consumers via a L-PROMO merchant campaign platform. Further implementations of merchant campaign experience is discussed in FIG. 3C.

In one embodiment, upon receiving merchant promotion details, L-PROMO may match merchant promotions and offers with consumers 233 to facilitate target campaign. In one implementation, the L-PROMO may query the L-PROMO database for consumer transaction activities related to a merchant promotional offer, and populate a matched offer to the consumer's L-PROMO account. In another implementation, the L-PROMO may receive indications from the merchant with regard to a group of targeted consumers. For example, a merchant may desire to provide a promotion on “15% off business class flight” to consumers who have a Starwood account registered with the L-PROMO. Further implementations of targeted campaign and offer matching is discussed in FIG. 4A.

In a further embodiment, upon registration, the L-PROMO may bridge with consumers in a variety of vehicles. For example, the L-PROMO may issue a magnetic stripe L-PROMO card to the consumer so that the consumer may swipe the L-PROMO card at a store registry during checkout, or enter the card number information for online shopping. For another example, the L-PROMO may cooperate with carriers to provide smartphone applications for NFC handshakes. For another example, a merchant may equip L-PROMO products barcode/NFC plate reading machines at its POS terminals.

In one embodiment, upon registration, a L-PROMO consumer may shop with his L-PROMO account for payment. The consumer may submit his L-PROMO account information for payment 235. For example, the consumer may swipe his L-PROMO card at a POS terminal in a merchant store, or enter the L-PROMO card number during online shopping checkout, or engage a L-PROMO enabled smartphone for NFC checkout. The merchant may forward the received L-PROMO payment information to the L-PROMO platform 120, which may then in turn retrieve consumer's bank accounts and/or the social media accounts to process payment 238. In one implementation, the L-PROMO may generate a message describing the consumer's purchase, link the message to social media, and populate the social media feeds to the social media networks 240. For example, if a consumer attempts to buy a pair of Gap jeans at a Gap store, L-PROMO may generate a Facebook status update showing the consumer “buys a Gap boot cut jeans.” In a further implementation, the L-PROMO transaction may provide a merchant ID to the L-PROMO platform so that the social media status updates may comprise an address of in-store purchase.

In one embodiment, the L-PROMO may retrieve merchant promotions 243 to apply to the purchase. In one implementation, the L-PROMO may retrieve offers that have already been matched to the consumer's L-PROMO account at 233 and determine whether any offers are applicable. In another implementation, the L-PROMO may form a query in real-time to search for the most update related merchant offers, e.g., based on the merchant brand name, etc.

In one embodiment, the L-PROMO may parse the contents of the merchant offer and determine whether it is applicable 245 to the instant transaction. In one implementation, a merchant offer may be conditional, based on the consumer's loyalty. In one implementation, the L-PROMO may query on the consumer's past transactions to determine loyalty. In another implementation, the L-PROMO account may associate loyalty points of a consumer for every purchase at a particular merchant, and may determine whether the accumulated loyalty points for the particular merchant/brand are sufficient to redeem a merchant offer. For example, a conditional loyalty offer may provide a “50% off of all coffee” if the consumer has bought more than three cups of coffee at a coffee shop.

In one embodiment, if the consumer is eligible to apply an offer at 245, the merchant may receive a notification of promotion redemption confirmation 252, and provide a receipt of the transaction after promotion offer has been applied to the consumer. The L-PROMO may also link to the consumer's social media account in real-time and notify the transaction with promotion redemption 255. In one implementation, the social media may populate social media feeds based on the promotion redemption 260, e.g., automatically posting a Facebook status update showing the consumer “enjoying a 50% off mocha latte at Starbucks.”

If the offer is not applicable at 245, e.g., when the consumer has not engaged in sufficient loyalty purchase to redeem the offer, etc., or after the offer has been successfully redeemed, the L-PROMO may complete the transaction. In one implementation, the L-PROMO may add up the purchase to the consumer's loyalty points associated with the L-PROMO account. In one implementation, the loyalty points calculation logics may be provided by the merchant. For example, the consumer may gain one loyalty point for Starbucks coffee whenever he bought a cup of coffee from a Starbucks store. For another example, the consumer may gain Gap loyalty points based on different products he bought from a Gap store, e.g., 15 points for purchasing a Gap T-shirt, 50 points for purchasing a pair of Gap jeans, etc. The merchant may set loyalty program parameters via a L-PROMO merchant campaign platform, as further illustrated in FIG. 3B.

In one embodiment, for merchants, the L-PROMO may provide a way to engage with consumers to create community and social communication, resulting in increased loyalty and revenues, and an easy to use, self-service merchant control panel for loyalty/offers campaign management and analytics allowing businesses to quickly set-up and modify offers and targeting. The L-PROMO may further integrate social engagement with consumers based upon “triggers” (e.g., check-in, swipe, like) helping businesses with propagation of messages on merchant social presence (e.g., Facebook/Twitter) using ‘Alerts’ services

In one embodiment, for the consumers, the L-PROMO may allow access to lower price points (i.e., discounts) and exclusive “deals” which are relevant and easy to redeem, and receive relevant offers at the point of transaction (i.e., while shopping) or based upon “intent” (e.g., wish-list, check-in, search) with easy to manage opt-in or opt-out preference management. The L-PROMO may also facilitate easy and convenient offer redemption with integrated offer fulfillment at the point of transaction online or in-store and instant gratification with communication of offer qualification and realized savings/benefit.

FIG. 2B illustrates an example of the L-PROMO merchant-consumer interaction within embodiments of the L-PROMO. In one embodiment, a consumer, e.g., a L-PROMO cardholder, purchase a cup of coffee at “Crossroads Café” 270, which is L-PROMO participating merchant. The consumer may swipe the L-PROMO card at the cashier, which may transmit the L-PROMO card number to a L-PRPOMO network for payment processing.

In one implementation, the L-PROMO network may communicate with a consumer's bank account to authorize payment whereby the transaction may appear on the consumer's bank statement 274. In another implementation, the L-PROMO payment processing unit may identify the consumer as a L-PROMO customer and send the verification to a L-PROMO loyalty unit 277 via a real-time messaging (RTM) platform 275. In one implementation, the L-PROMO loyalty unit may obtain a user ID based on the L-PROMO card number, and also a merchant ID which was originally sent from the cashier registry at 270.

In one embodiment, the L-PROMO loyalty unit may query for offers based on the merchant ID, and retrieve offers issued by the merchant “Crossroads Café.” For example, the merchant “Crossroads Café” may enter offers via a L-PROMO merchant service portal 272, and set up different loyalty offers. For example, the Crossroads Café may provide an offer entitled “freaky Fridays” having “50% off between 10 am and 3 pm on Fridays.” Another example offer may be a referral offer, such as “20% of when you shop with a friend.” For another example, the Crossroads Cafe may issue an offer based on loyalty purchase, such as “5^{th} purchase of equal or lesser value free.”

In one embodiment, the L-PROMO loyalty unit may determine whether the instant purchase transaction is eligible for any of the offers provided by the merchant ID. If yes, e.g., it is the 5^{th} purchase of the same latte from the consumer, the L-PROMO loyalty unit may apply the offer “5^{th} purchase of equal or lesser value free” to the transaction. In one implementation, the L-PROMO may provide a real-time rebate of the purchasing amount to the consumer's bank account, which may be reflected in the bank statement 285.

In a further embodiment, the L-PROMO may generate status updates and link to the consumer's Facebook account. For example, the consumer's Facebook page may automatically populate a Facebook status update, such as “Dave is caffeinating at Crossroads Café” 280, when L-PROMO receives an indication of the consumer's transaction. For another example, when the loyalty offer has been successfully redeemed, such as the consumer obtains a free 5^{th} cup of coffee, the L-PROMO may link to the consumer's Facebook account and automatically post another Facebook update, e.g., “Dave got free coffee at Crossroads Coffee thanks to L-PROMO” 282. In one implementation, the consumer's friends may view the consumer's Facebook status updates with regard to Crossroads Café, and become interested in the same merchant. Thus Crossroads Café may attract more new consumers.

In further implementation, such social media posts may provide the offer to other consumers as long as the consumers see the news feed. For further examples of Facebook news feeds, merchants may post to own wall, merchant/L-PROMO may post to user wall in consideration of merchant, user likes merchant page, merchant auto-comments on user post, merchant gets access to user likes. For further examples of Twitter streams, consumers may follow merchant; merchant may follow the consumer; consumer retweets merchant tweet, user auto-tweets about the merchant, deals when you come with a follower.

In one implementation, the consumer's purchase may be automatically added to his L-PROMO account history. For example, the consumer may access his L-PROMO account via a web application 271, and view a list of the merchants he has shopped with. For example, after shopping with Crossroads Café, the consumer's L-PROMO account may add “You like Crossroads Café” 286 to the consumer's L-PROMO account history. In a further implementation, the L-PROMO may recommend merchants to the consumer based on his previous purchase. For example, after the Crossroads Café purchase, the L-PROMO may recommend related merchants, such as other coffee shops (e.g., “Tully's Coffee” 287) to the consumer.

FIG. 2C provides a logic flow diagram illustrating L-PROMO offer redemption within embodiments of the L-PROMO. In one embodiment, while processing payment of the purchase by deducting the original amount of the transaction from the consumer's bank account (e.g., at 274), the L-PROMO may receive a message (e.g., 275) wrapping an offer redemption request, e.g., a (Secure) Hypertext Transfer Protocol (“HTTP(S)”) GET message in the form of data formatted according to the eXtensible Markup Language (“XML”), specifying transaction details, consumer information, and/or an offer redemption request.

In one embodiment, an example data structure offer redemption trigger message may take a form similar to the following:

```
<Message>
      <MessageID> 123456 </MessageID>
      <OfferID> 55556 </OfferID>
      <MessageTime> 19:00 </MessageTime>
      <MessageDate> 04.04.2004 </MessageDate>
      <MsgTransaction>
          <TransactionID> 777777 </TransactionID>
          <TransactionTime> 19:00 </TransactionTime>
          <TransactionDate> 04.04.2004 </TransactionDate>
          <MerchantID> 326972 </MerchantID>
          <MerchantName> Crossroads Café </MerchantName>
          <TransactionAmount> $5.75 </TransactionAmount>
          <PaymentType>  Visa </PaymentType>
          <PaymentAccount> ****4136 </PaymentAccount>
          ...
      </MsgTransaction>
      <MsgConsumer>
          <ConsumerID> JohnSmith1982 </ConsumerID>
          <ConsumerName> John Smith </ConsumerName>
          <ConsumerPayment> **** 4136 </ConsumerPayment>
      ...
      </MsgConsumer>
      <MsgOfferRequest>
          <Trigger> L-PROMO </Trigger>
          <OfferTag> AZ00999 </OfferTag>
          ...
      </MsgOfferRequest>
      ...
</Message>
```

In one implementation, the L-PROMO may determine a trigger of the offer based on the received message 290. For example, in one implementation, the consumer may provide a coupon at the checkout, and the cashier may scan the coupon, and/or enter a coupon code at the POS. For another example, the consumer may enter a coupon code during online shopping. For a further example, the coupon redemption request may be triggered by a third party, an offer issuer, and/or an offer acquirer e.g., a shopping site, etc., which may automatically provide an offer to any purchase occurred on the shopping site.

In another implementation, the L-PROMO may retrieve an indication of consumer acquisition of an offer and automatically wrap the offer redemption request in the message without the consumer triggering it during the purchase. For example, a consumer may click on an offer page on the Internet, “like” a friend's recommendation of an offer on Facebook, and/or the like, and such consumer opt-in activities may be forwarded to the L-PROMO which may in turn associate the offer with the consumer' L-PROMO account. During checkout, the L-PROMO may form a query to determine whether any stored offers in the consumer's L-PROMO account may be applicable to the purchase. For example, if the consumer is shopping at “Crossroads Café,” the L-PROMO may search down a list of offers associated with the consumer's L-PROMO account (e.g., based on a merchant ID, etc.) to identify whether there is any “Crossroads Café” offers available, and automatically apply the offer to the purchase without the need for the consumer to further trigger the redemption.

As show in the above example XML code, the offer redemption request message may comprise an offer tag, which may serve as an identifier of the offer. In one embodiment, the L-PROMO may retrieve details of the offer from a L-PROMO offer database to verify the offer 294. For example, the L-PROMO may form a query based on the offer tag in the offer database to verify the validity of the offer. If the query returns no result, the L-PROMO may deny the offer redemption request as the offer does not exist or is not L-PROMO redeemable.

In one embodiment, if such offer is verified with L-PROMO, the L-PROMO may determine a sponsor 292 based on the offer data record. For example, the offer may be sponsored by L-PROMO, the merchant (e.g., Crossroads Café, etc.), a third party (e.g., Groupon, etc.), an offer issuer (e.g., Amazon.com, etc.), and/or the like.

In one implementation, the L-PROMO may determine whether the offer terms may apply to the transaction indicated in the received message 295. In one implementation, the offer record may comprise offer redemption conditions and rules. For example, the offer may be redeemable within a certain amount of time period. For another example, the offer may be redeemable when the transactional amount exceeds a threshold. For another example, the offer may be redeemable when the consumer is a member of the offer issuer (e.g., Amazon). For another example, the offer may be redeemable if the consumer has sufficient loyalty points with the offer issuer, and/or the like.

In one embodiment, an example data structure offer redemption trigger message may take a form similar to the following:

```
<Offer>
    <OfferID> 55556 </OfferID>
    <OfferName> 5th Free </OfferName>
    <OfferType> Loyalty </OfferType>
    <OfferSource>
        <SourceType> MerchantID </SourceType>
        <SourceID> 36297 </SourceID>
        <IssueDate> 03.03.2004 </IssueDate>
        ...
    </OfferSource>
    <Rule>
        <OfferStartDate> 04.04.2004 </OfferStartDate>
        <EndDate> 05.04.2004 </EndDate>
        <EligibleRetailers>Starbucks, Pete's, Dunkin
Donuts</EligibleRetailers>
        <EligibleProducts>Warm Drinks</EligibleProducts>
        <loyaltyPointRequirement> 5 </loyaltyPointRequirement>
        <AllowLoyaltyConversion> Yes </AllowLoyaltyConversion>
        <Conversion>
            <Conversion1>
                <SourcePoint> Amazon </SourcePoint>
                <DestinationPoint> Crossroads Café Cup
                </DestinationPoint>
                <ConversionRate> 5/1 </ConversionRate>
                <RequestConsumerAuthorization>
                yes
                <RequestConsumerAuthorization>
                ...
            </Conversion1>
        ...
        </Conversion>
        <ReturnCredit> Transactional Amount </ReturnCredit>
        ...
    </Rule>
    ...
</Offer>
```

In one embodiment, if there is sufficient loyalty associated with the consumer's L-PROMO account 298 (e.g., the L-PROMO may verify that the consumer has purchased 5 cups of coffee from Crossroads Café in the above example), the L-PROMO may calculate a rebate amount based on the offer terms and crediting the amount to the consumer's bank account 2100. For example, in the above example, the offer specifies the rebate amount is equal to the transactional amount (e.g., a free coffee), and then the L-PROMO may retrieve the transactional amount from the received message at 275, and credit such amount to the consumer. For another example, if the offer rule provides a 30% discount to the transaction, the L-PROMO may then calculate a rebate amount equivalent to 30% of the original transactional amount and credit it to the consumer.

In one implementation, the L-PROMO may then obtain payment of the rebate amount from the offer sponsor 2105. For example, if the merchant (e.g., Crossroads Café) sponsors the offer, the L-PROMO may collect payment of the rebate amount from the merchant. For another example, if a L-PROMO partner (such as Amazon, Groupon, etc.) issues the offer, the L-PROMO may seek for compensation of the rebate amount from the partners.

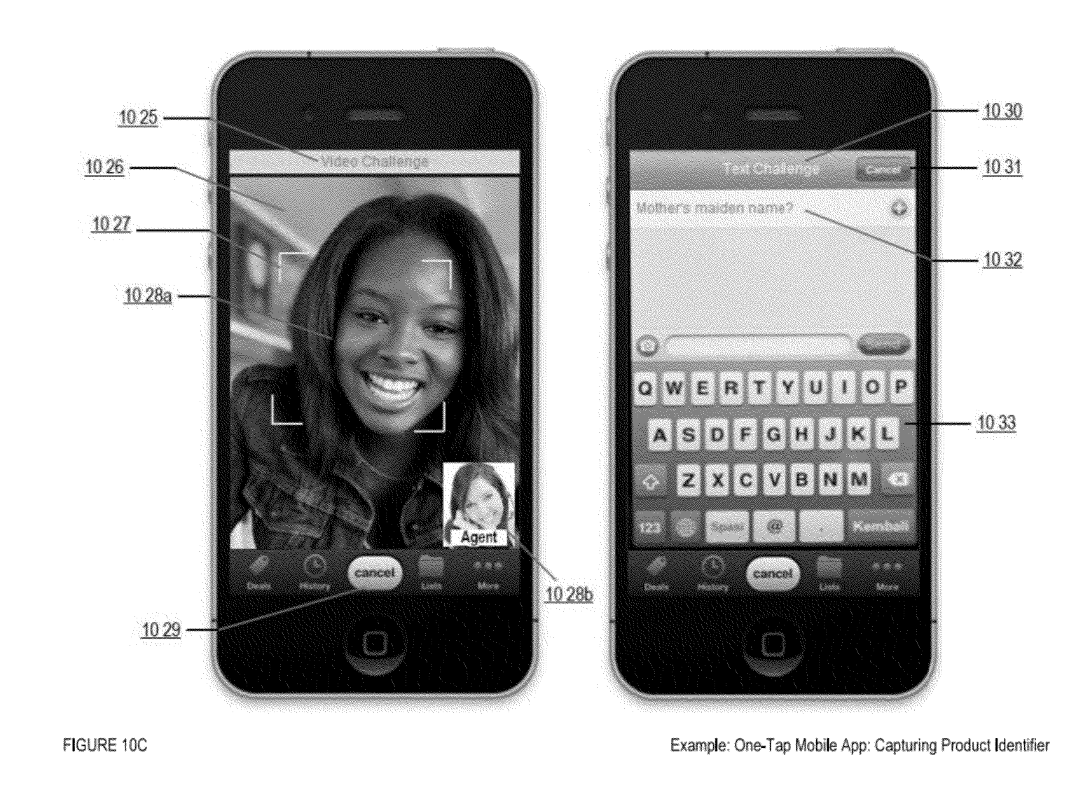

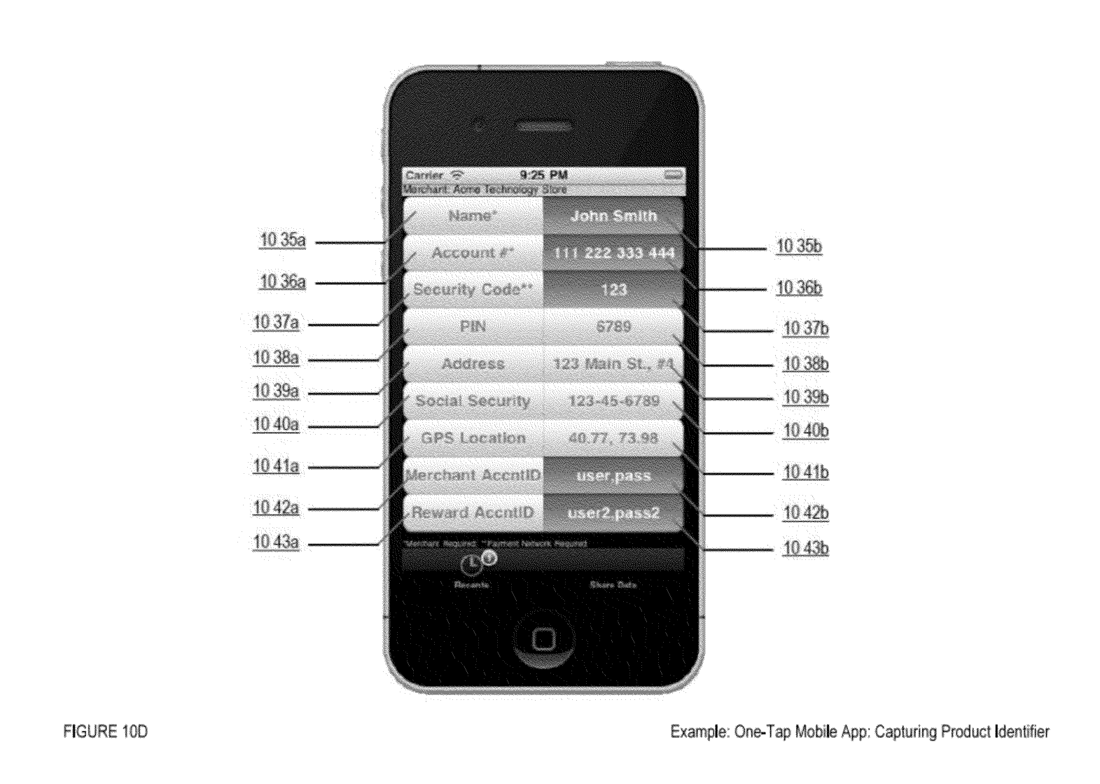

In another embodiment, the L-PROMO determines the consumer does not have sufficient loyalty points at 298 (e.g., the consumer has only bought 3 coffees at Crossroads Café while the example offer above requires at least 5), the L-PROMO may determine whether the offer rules permit points conversion 2120. In one implementation, the consumer may have loyalty points from other merchants, third party vendors, and/or the like, and may convert such loyalty points to redeem the instant offer. If the offer allows points conversion, the consumer may be prompted to select whether he would like to authorize points conversion. For example, the consumer at Crossroads Café may be inquired by a cashier at the POS that whether he is willing to use 10 Amazon points to redeem the free coffee offer. In one implementation, should the consumer allow such conversion, the L-PROMO may convert loyalty points from another loyalty program sponsor to the required loyalty points to redeem the offer 2103 (e.g., see FIG. 10 1017, 1018 for related examples).

In one embodiment, if loyalty points conversion is allowed per the offer rule, the L-PROMO may determine an exchange rate of each of the source and destination points. For example, in one implementation, the L-PROMO may retrieve currency and/or points exchange rates of the various types of currency and/or points sources in a relational database using a hypertext preprocessor (PHP) script utilizing Structured Query Language (SQL) commands. In some implementations, the L-PROMO may similarly determine the currency exchange rates of the loyalty types of the points destinations. In some implementations, the L-PROMO may retrieve and parse cross-ecosystem point conversion instructions, and obtain account information (e.g., account name, account number, routing number, password, security codes, CVV number, etc.) for the source points. For example, in one implementation, if an offer indicates the offer is redeemable at the 5^{th} purchase of the same product, but allows a consumer to convert Amazon points, e.g., 5 points equivalent to a product purchase, such conversion instructions may be pre-submitted and stored in a point conversion table with the L-PROMO. In another implementation, conversion instructions may be associated with the offer rules. In one embodiment, FIGS. 13A-13C show various point exchange logic flows and user interface embodiments.

In one implementation, prior to completion of the transaction, the L-PROMO may add loyalty points for the transaction 2110 to the consumer's L-PROMO account based on loyalty point calculation rules provided by the loyalty sponsor. For example, Crossroads Café may credit 1 loyalty point to each purchase of 1 coffee; then after the consumer has bought a coffee at Crossroads Café, the L-PROMO may add 1 point to the consumer's Crossroads Café loyalty.

FIG. 3A provides a flow diagram illustrating L-PROMO consumer enrollment within embodiments of the L-PROMO. In one embodiment, a consumer may initiate L-PROMO registration process 305. For example, the consumer may register with L-PROMO via a web application 308. For another example, the consumer may download and install a smartphone component on his smartphone (e.g., Apple iPhone, BlackBerry, etc.). In one implementation, the consumer may create a L-PROMO account and establish login credentials 310 by providing a L-PROMO account name, password, confirmation email address, etc.

Upon creating a L-PROMO account and providing basic consumer credentials, the L-PROMO may link necessary consumer accounts to the created L-PROMO account 312. In one implementation, the L-PROMO may store the consumer login credentials 316, such as, but not limited to consumer name, consumer contact, consumer email, password, and/or the like with the L-PROMO account. In another implementation, the L-PROMO may link the consumer's mobile number 317 to the consumer's L-PROMO account. In another implementation, the L-PROMO may link the consumer's bank accounts to the L-PROMO account for payment processing, e.g., a Visa credit card 318, etc. In another implementation, the L-PROMO may link the consumer's social media accounts to the L-PROMO account, such as the Facebook account 319, twitter account, etc.

In a further implementation, the consumer may manage his L-PROMO accounts via the web application 308. For example, the consumer may set preferences 320 of his L-PROMO account, such as, but not limited to selecting interested merchants, notification methods, receiving offer updates frequency, and/or the like. In a further implementation, the consumer may like a merchant's Facebook page 321, follow a merchant's twitter 322, and/or the like, to receive commercial offers.

For example, in one implementation, upon linking social media accounts and mobile numbers with the L-PROMO account, the consumer may manage his L-PROMO account to receive merchant offers via Facebook news feed 324a, Twitter stream 324b, email 324c, mobile text messages 324d, and/or the like. In a further implementation, the consumer may view messages related to L-PROMO offers posted by the merchant or his friends status update, and click on the message or navigate to the L-PROMO consumer webpage to view and/or retrieve the offer.

The L-PROMO may associate merchant profile with the consumer's L-PROMO account profile by providing a merchant webpage URL 324e to the consumer, e.g., sending an invitation to the consumer to view the most up-to-date offers on the merchant website. In a further implementation, a consumer may receive in-store messages 324f of the most updated offers from a merchant during the checkout process, upon submitting L-PROMO account information for payment. In a further implementation, the consumer may modify L-PROMO parameters to indicate offers that he is interested in. For example, the consumer may submit a category of merchant (e.g., grocery, electronics, etc.), a brand name (e.g., Starbucks, BestBuy, etc.), and/or the like.

In one implementation, after linking social media accounts, the consumer may In a further implementation, after registration, the consumer may receive a L-PROMO vehicle 325 ready to use. For example, the consumer may receive a L-PROMO card.

FIG. 3B provides a flow diagram illustrating L-PROMO merchant enrollment and campaign set up within embodiments of the L-PROMO. In one implementation, merchants (e.g., small businesses) may not have resources for campaign management and analytics. They may have to make quick decisions and gauge the results with a little data and a lot of intuition. The L-PROMO may provide a merchant application, e.g., an add-on application to the merchant's Facebook page for campaign set up. In one implementation, the L-PROMO merchant application may allow the merchant make incremental changes from a “best guess” baseline, and provide results graphically and intuitively—link the results to modifications the merchant makes. The L-PROMOP may also guide the merchant in the realm of reaching out to targeted customers through their social networks to obtain campaign feedbacks.

In one embodiment, a merchant may initiate a L-PROMO registration process 330, and provide merchant information to enroll in L-PROMO 332. For example, the merchant may provide the merchant's name, address, brand information, retail store addresses, product information, and/or the like to the L-PROMO merchant enrollment platform.

In one implementation, upon enrollment, the merchant may instantiate a merchant campaign setup 335. In one implementation, the merchant may open a L-PROMO merchant control panel 333 and establish campaign parameters 340, such as, but not limited to offer type (e.g., a loyalty offer, a general discount, etc.), target audience, duration, terms, budget, and/or the like. For example, a merchant “Crossroads Café” may establish a campaign including a loyalty offer for a “free 5^{th} cup of equal of lesser value,” setting a duration of three months. The Crossroads Cafe may further set the target audience to be consumers who specify they are interested in coffee, gourmet food, and/or the like, or consumers who are social media contacts (e.g., Facebook friends, etc.) of existing Crossroads Café consumers.

In one embodiment, the merchant may promote offers to target consumers via L-PROMO offer matching engine 345, as further discussed in FIG. 4. In one implementation, merchant offers may be presented to a consumer via a variety of ways. For example, the merchant may post offers via Facebook news feed from the merchant's Facebook page, via Twitter stream, via emails and/or mobile messages to subscribed consumers, post offers on the merchant's webpage, and/or provide in-store discount offers.

In one embodiment, when a consumer shops with the merchant, the merchant may receive offer redemption information 352, and store the offer redemption record for campaign performance analysis. In one implementation, the merchant ma analyze campaign performance 355 via a L-PROMO merchant control panel 350 based on statistical data of the offer redemptions, and adjust campaign parameters 360 based on the performance. In one implementation, the merchant may adjust campaign parameters on a periodic basis based on performance feedbacks, as further implemented in FIG. 4B.

FIG. 3C provides a flow diagram illustrating consumer loyalty offer redemption within embodiments of the L-PROMO. In one embodiment, a consumer may be notified by a merchant or a friend of an offer 365. For example, the consumer may view the merchant posts a new offer via Facebook new feeds, twitter updates, email, mobile messages, merchant's website and/or the like. For another example, the consumer may be aware of a merchant offer via a friend's social media updates. For example, as shown in one example in FIG. 2B, when the consumer successfully redeems an offer, the consumer's Facebook account may automatically post a message generated by the L-PROMO, e.g., “Dave got free coffee at Crossroads Coffee thanks to L-PROMO” at 285. In one implementation, if “Dave's” friend “Jennifer” sees this Facebook status feeds, and becomes interested in a free coffee, she might click on the Facebook feeds, and be directed to details of the merchant's offer, e.g., the merchant's Facebook page, the merchant website, and/or the like. In a further implementation, when “Jennifer” clicks on the Facebook feeds, her Facebook account may feed the click to her L-PROMO account, indicating “Jennifer” may be interested in Crossroads Café offers, and the L-PROMO may in turn associate Crossroads Café offers with her L-PROMO account for her future purchase.

In one embodiment, after being notified of a merchant offer, the consumer may visit a merchant store to purchase products and redeem such offer 366. For example, the consumer may walk in a merchant store to shop, and/or visit a merchant shopping site for online purchase. In one implementation, the consumer may provide his L-PROMO payment information (e.g., the card number, etc.) 368 during checkout. For example, as shown in FIG. 3C, the consumer may swipe his L-PROMO card to purchase coffee at a Crossroads coffee shop, and L-PROMO may apply a 50% off offer to the transaction.

In one implementation, the discount may be directly apply to the transaction. For example, in one implementation, the L-PROMO may send a message of 50% offer to the cashier at the Crossroads Coffee, and the purchasing price may be taken 50% off at the cashier.

In an alternative implementation, the 50% discount offer may take a form similar to an instant “rebate.” For example, upon receiving consumer's L-PROMO card number, the L-PROMO platform may process and authorize payment of the transaction without interruption, e.g., at the regular price of Crossroads Coffee. The L-PROMO may then retrieve the 50% off Crossroads coffee offer, and apply it to the consumer purchase by returning an amount equivalent to a half of the transactional amount to the consumer's bank account.

In one implementation, upon successful redemption of an offer, the L-PROMO may notify the consumer of the offer redemption status. For example, the consumer may receive a mobile message 37o from the L-PROMO at his registered mobile phone with the L-PROMO account. For another example, the consumer's L-PROMO account may automatically share the purchasing experience by posting a status update with regard to the purchase and offer redemption on the consumer's social media page, e.g., showing the consumer “got a 50% off coffee at Crossroads Coffee.”

FIG. 4A provides a logic flow diagram illustrating merchant consumer offer matching within embodiments of the L-PROMO. In one embodiment, a consumer may gain access to rewards/offers based on context and community, and the merchant may set up self-service loyalty/offers campaign management integrated with commerce management, payment processing, and business intelligence.

In one implementation, the L-PROMO may obtain indications of consumer interested offers via various ways. For example, in one implementation, consumers 102 may engage in opt-in activities to accept offers/invitations received from known merchant, friend referral 405, e.g., by clicking on an offer link sent in the email, by downloading an offer from merchant poster (e.g., NFC, 2D Barcode (QR), URL), and/or the like. For another example, a consumer may accept offer invitation at point of transaction, e.g., offer delivery integrated with checkout (e.g., a delight box with contextual offers), offer redemption/fulfillment at point of transaction (in-store CP or online CNP).

In another implementation, a consumer may edit his L-PROMO profile to specify offers he is interested in via a L-PROMO consumer web application 407. For example, a consumer may specify a category of merchant offers that he is interested in, e.g., electronics, coffee, grocery, apparel, etc. For another example, the consumer may specify a merchant brand name, e.g., Crossroads Café, etc. For another example, the consumer may receive recommendations based upon wish-list additions or searches, check-in integration with location based services (e.g., Facebook Places, Foursquare) for delivery of contextual offers.

In another implementation, a consumer may receive offers via a social media platform, e.g., via posting of messages on consumer social feed based on friends' explicit opt-in activities, integration with merchant social messaging and consumer dialog via merchant social presence, and/or the like.

In one embodiment, the merchant 110 and/or the social media 150 may send information related to consumer opt-in activities to the L-PROMO platform 410. For example, a merchant store may send a notification to the L-PROMO when a consumer accepts an in-store coupon. For another example, when a consumer views an offer from a friend's status update on social media (e.g., a Twitter stream, Facebook news feed, etc.) and clicks on the message to view the offer, the consumer's social media account may link to the consumer's L-PROMO account to notify the consumer's interests in the selected merchant and offers.

In another embodiment, a merchant 110 may specify campaign target audience 412 when setting up an offer. For example, a merchant may request the offers be promoted to L-PROMO registered consumers who have previously shopped with the merchant. For another example, a merchant may request the offers be promoted to L-PROMO registered consumers whose residential addresses are within a zip code range.

In one embodiment, the L-PROMO may generate merchant-consumer offer matching key terms 415 based on the information collected at 405˜412. In one implementation, the L-PROMO may determiner whether there is a merchant ID associated with the matching 416. For example, in one implementation, if a consumer has specified an interested merchant associated with a merchant ID, or accepts an offer associated with a merchant ID 416, the L-PROMO may form a query based on the merchant ID 420 to retrieve promotions and offers associated with the merchant ID. In another implementation, for each offer provided by the merchant, the L-PROMO may form a query on the target consumers and promote the offer associated with the merchant ID to the queried target consumers. In one implementation, the consumer may then receive matched offer associated with the merchant ID 420, e.g., via email, Facebook news feed, Twitter stream, and/or the like. The consumer may then proceed to redeem the offer 425.

In another embodiment, there is no merchant ID indicated for the offer matching at 416, e.g., the L-PROMO may initiate a matching for consumer's specified merchant categories, wish list of offers, and/or the like. The L-PROMO may form a query in the received list of merchant offers based on the related key terms 426, e.g., category terms “electronics,” “coffee,” etc., to match existing offers to a consumer's interests.

In one implementation, the L-PROMO may further send indications of consumer's wish list of offers 428 to a merchant. For example, if a consumer has specified in his wish list a “free vanilla latte at Crossroads Café,” the L-PROMO may send the wish list offer to the merchant “Crossroads Café.” For another example, if a consumer has a wish of “free vanilla latte,” the L-PROMO may form a query based on the key term “vanilla latte” and send the consumer's wish to merchants who provide “vanilla latte,” so that the merchants are able to learn the consumer's demands for their campaign management.

In one implementation, the consumer may receive offer recommendations 431 based on the query results of the offer matching. For example, if a consumer has specified he is interested in “coffee” coupons, and the L-PROMO may then match offers from “Crossroads Café” to him, and promote the offers to him via email, mobile messages, Facebook news feed, Twitter stream, and/or the like. The consumer may then opt to accept the offers at 405.

In one implementation, the L-PROMO may update transaction record 435 to record the offer matching results, and offer redemptions 435.

FIG. 4B provides a diagram illustrating merchant campaign management within embodiments of the L-PROMO. In one embodiment, the L-PROMO may facilitate merchant/SMB self-service loyalty programs delivered to consumers in-store, online, on mobile, or in social. In one embodiment, the L-PORMO may provide payment processors access to new revenue streams by delivering value added services for merchant setup and management of loyalty/rewards campaigns and reward redemption/fulfillment; empowering merchants to easily manage their loyalty campaigns with a low cost, simple service. In one implementation, the L-PROMO payment processors (e.g., VISA) may provide merchants a self-service control panel for the setup and management of loyalty programs including targeted consumer messaging, offer delivery, offer redemption/fulfillment and campaign analytics linked to transaction data.

In one implementation, the L-PROMO may facilitate consistency in the pricing strategy and approach for structuring fees and licensing services across the payment processor (e.g., VISA). For example, in one implementation, a merchant may bridge the existing basic coupon offers 452 (e.g., no enrollment, targeting and no card issuance) with the L-PROMO offers 450, based on the branch value to cardholders 462, using consistent offer sourcing strategy 461 and a consistent pricing strategy 460.

In one implementation, the merchant (e.g., small businesses) may simplify their loyalty campaigns with a self-service UI, and/or easy to integrate APIs, for campaign and program management as well as access to business analytics. For example, using a L-PROMO merchant application, the merchant may devise L-PROMO offers 45o based on consumer spend, profile, relevancy (e.g., location, wish list) in the L-PROMO consumer account to design market campaign, and distribute the offers via a variety of consumer registered channels 455, e.g., email, SMS, mobile application, online and social settings, and/or the like. For another example, in one implementation, the merchant may adopt crowd-sourced (through merchant self service) for local campaign, and/or Visa sourced (through Visa direct sales force and through Visa merchant aggregators) for a national campaign.

In one implementation, the L-PROMO may provide a single portal in each payment processor (e.g., VISA) channel (online, mobile & social) for consumers (e.g., Consumers should not be confused with multiple Visa sites for enrolling in offers and other services from a branding perspective).

FIG. 4C provides a logic flow diagram illustrating merchant campaign setup and management within embodiments of the L-PROMO. In one embodiment, a merchant may start campaign control by instantiating a L-PROMO merchant campaign service user panel. The L-PROMO may receive an indication of campaign objective, such as new consumer counts, revenue expectation, and/or the like, 470.

In one embodiment, the merchant may establish campaign objectives 490b to reflect consumer experience 490a with the L-PROMO, as shown in FIG. 4D, which provides a diagram illustrating examples of campaign objectives within embodiments of the L-PROMO. For example, an objective of awareness 491b may describe the experience as to how the consumers hear about the campaign program 491a, e.g., when consumer is exposed to the program/offer via merchant's FB page, ad, poster, search results, etc. For example, the awareness objective may be a number of new offer acceptances, e.g., the number of clicks on a Facebook link of the merchant campaign, and/or the like.

In another implementation, the merchant may set an objective of engagement 492b, which is related to consumer experience in seeking for more information of an offer 492a. For example, the engagement objective may be related to a re-direction from a Facebook page to the merchant website, a consumer's viewing an offer within a L-PROMO consumer user interface, and/or the like.

In another implementation, the merchant may set an objective of acquisition 493b, which is related to consumer experience in enrolling in a L-PROMO offer 493a. For example, the enrollment may be triggered when a consumer add an offer to his L-PROMO account.

In another implementation, the merchant may set an objective of usage 494b, which is related to consumer experience in offer redemption 494a. For example, the usage may be related to the number of transactions including the offer redemption.

In another implementation, the merchant may set an objective of a word of mouth (WOM) value 495, which is related to the consumer sharing L-PROMO offers on social media 4951 with friends. For example, the WOM value may be related to a number of referrals who become interested in an offer after a consumer has posted the offer on the social media, e.g., the number of visits of the Facebook news feed of the offer redemption.

In one embodiment, the merchant may then determine campaign parameters for the campaign 472, such as, but not limited to offer type, offer duration, offer target audience, offer germs, budget, and/or the like. The merchant may then receive transactional updates of the offer redemptions and sales data 475 via the L-PROMO platform.

In one implementation, the merchant may load various sales data to analyze the campaign performance 480. The merchant may determine evaluative metrics for an indicated objective of the campaign 478, and calculate “Cost per Event” metric value 482 accordingly.

For example, for an awareness objective, the L-PROMO may adopt a Cost per Impression (CPM) metric, e.g., a fee for every exposure to the campaign/offer, number of impressions, etc. The CPM data record may have fields such as the impression date, the impression ID, a campaign ID, data source, and/or the like. Such data may be obtained from partner data feeds (e.g., Facebook insights), media agency, and/or the like.

For another example, for engagement objective, the L-PROMO may evaluate a Cost per Click/Cost per Visitor/Click Thru Rate (CPC/CPV/CTR), e.g., a fee for every pre-defined event (click or visitor). clicks through rate equal to the clicks divided by the number of impressions. The CPC/CPV/CTR data record may comprises fields such as, but not limited to date, unique ID, visitors, visits, views, events, clicks, and/or the like. Such data may be loaded from partner data feeds, SEM agency, Google analytics, program activity logs, and/or the like.

For another example, for enrollment/acquisition objectives, the L-PROMO may evaluate a Cost per Acquisition (CPA), e.g., a fee for every acquired customer (enrollment in program or incremental purchase), number of enrollments, conversion rate, conversion lag, and/or the like. The CPA data record may comprises fields such as date, unique ID, enrollment confirmation, transactions, and/or the like. Such data may be loaded from L-PROMO enrollment Logs, Google Analytics, and/or the like.

For another example, for usage objective, the L-PROMO may evaluate a Cost per Action/Cost per Redemption (CPA/CPR), e.g., a fee for every desired usage action calculated as the number of purchases/redeemed offers/shared offers), number of transactions, number of redemptions, credits, and/or the like. The CPA/CPR data record may comprises fields such as date, unique ID, transaction ID, transaction amount, redemption amount, redemption rules, and/or the like. Such data may be loaded from partner data feeds, transaction Logs, TAQC, and/or the like.

In further implementations, the L-PROMO may load related data for analytics from Google analytics (e.g., via Google account access) for web analytics data, Facebook insights, Twitter/Foursquare feeds for social media data, Visa net for transaction data, L-PROMO application logs for program action data, and/or the like.

In one implementation, the L-PROMO may compare the calculated metric values with the campaign objective 484 to adjust the campaign parameters to optimize the “Cost Per Event” metrics 485. For example, in one implementation, the merchant may establish that consumers may be credited based on specified purchase patterns. For another example, the merchant may track “awareness” campaign to gauge CPM and click through rates for CPC. For another example, merchant may pay for clicks/visitors to website if for e.g., website is heavily branded or routes through their main site. In a further implementation, the merchant may target existing customers, so merchant may evaluate how much incrementally the program generates within a group of targeted consumers.

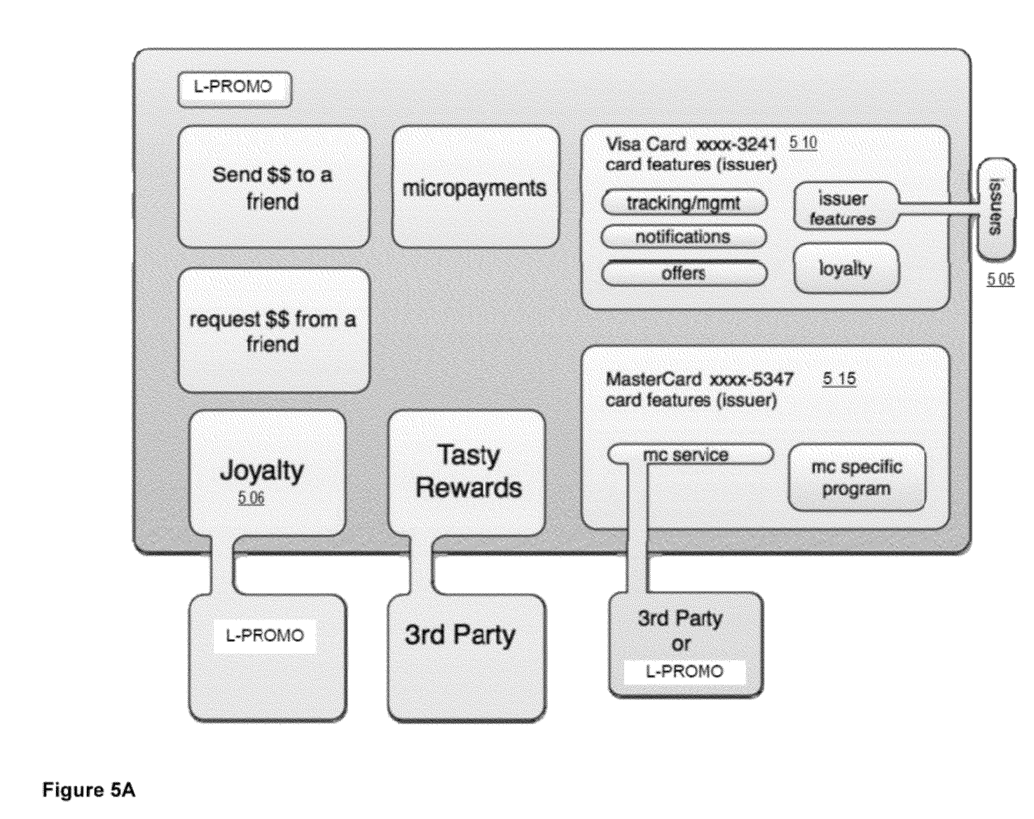

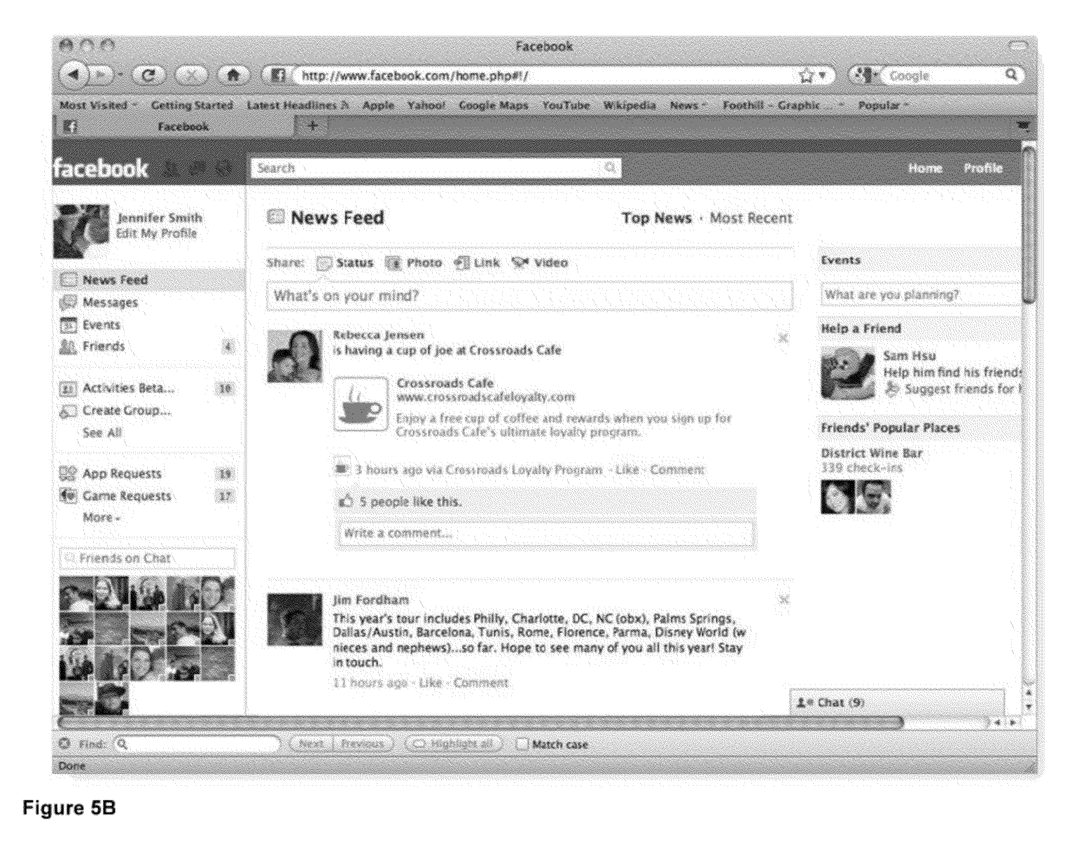

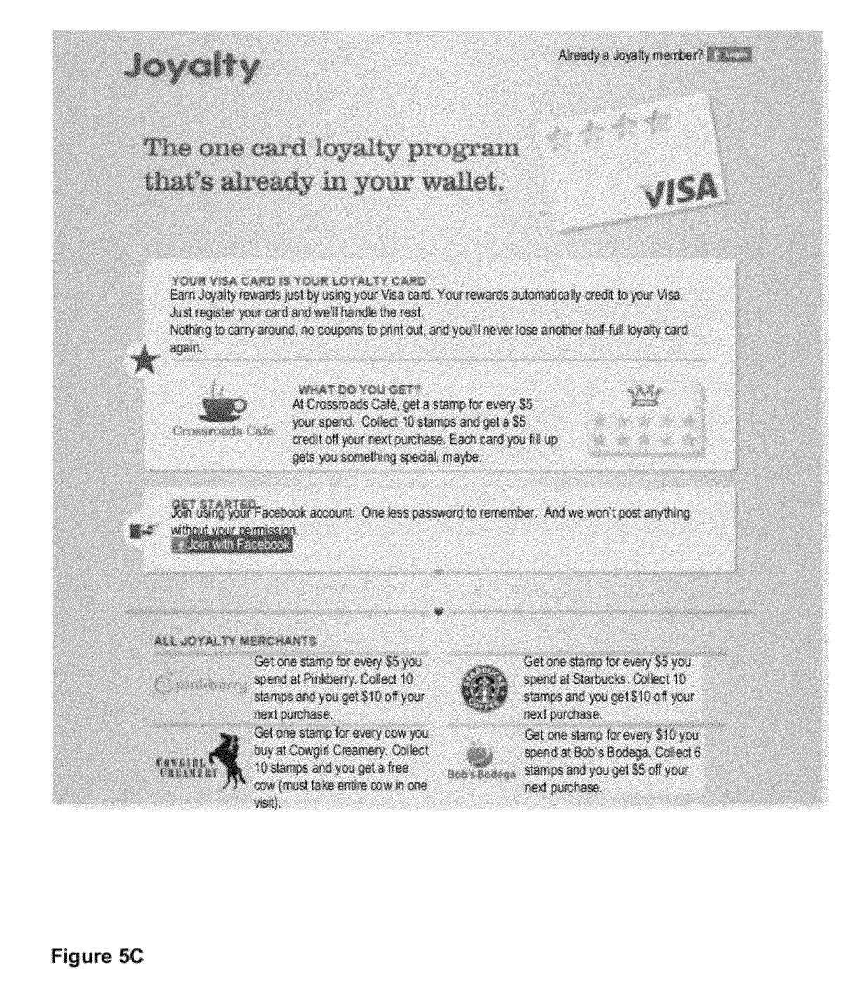

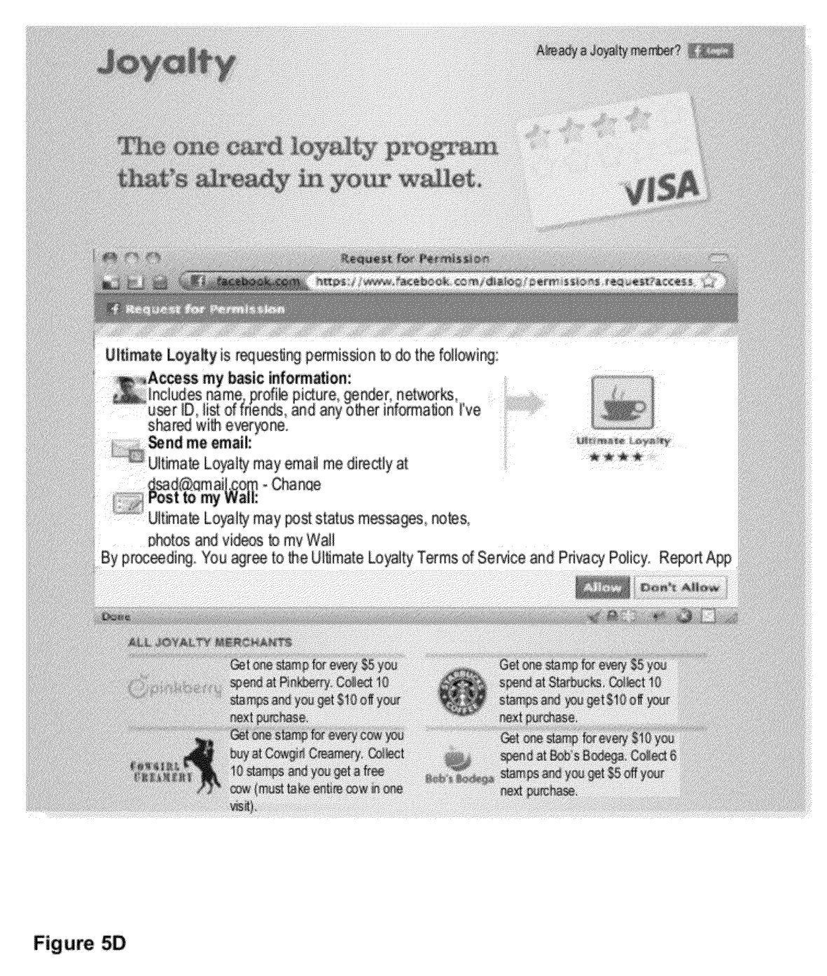

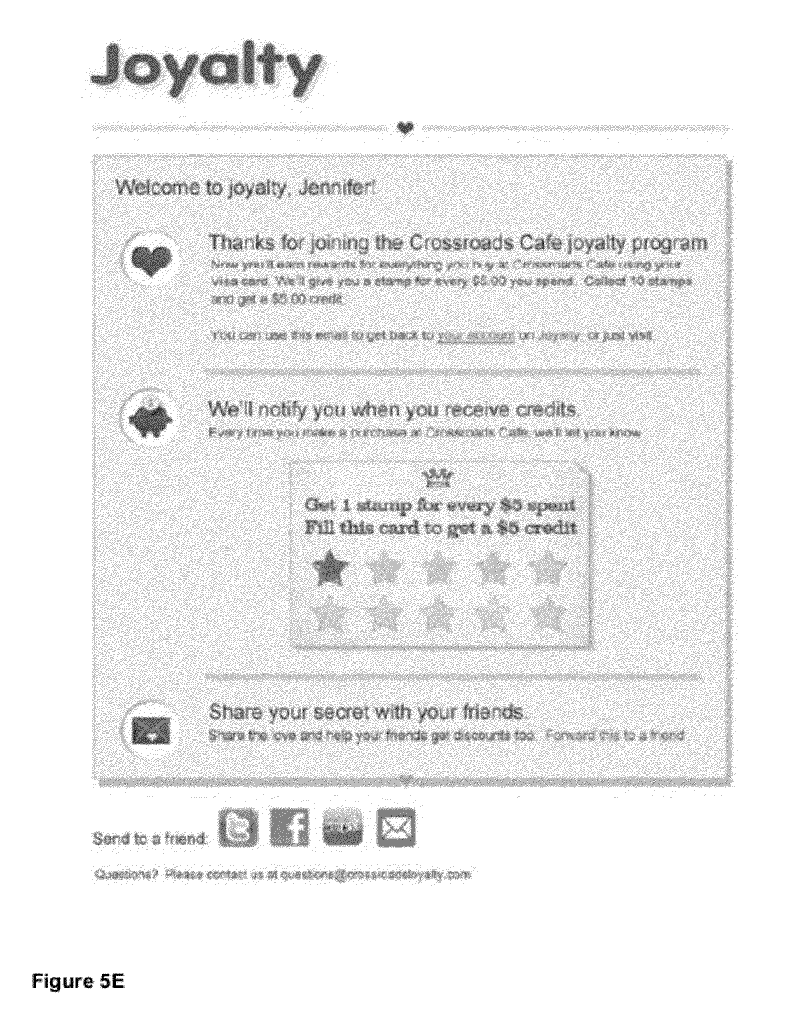

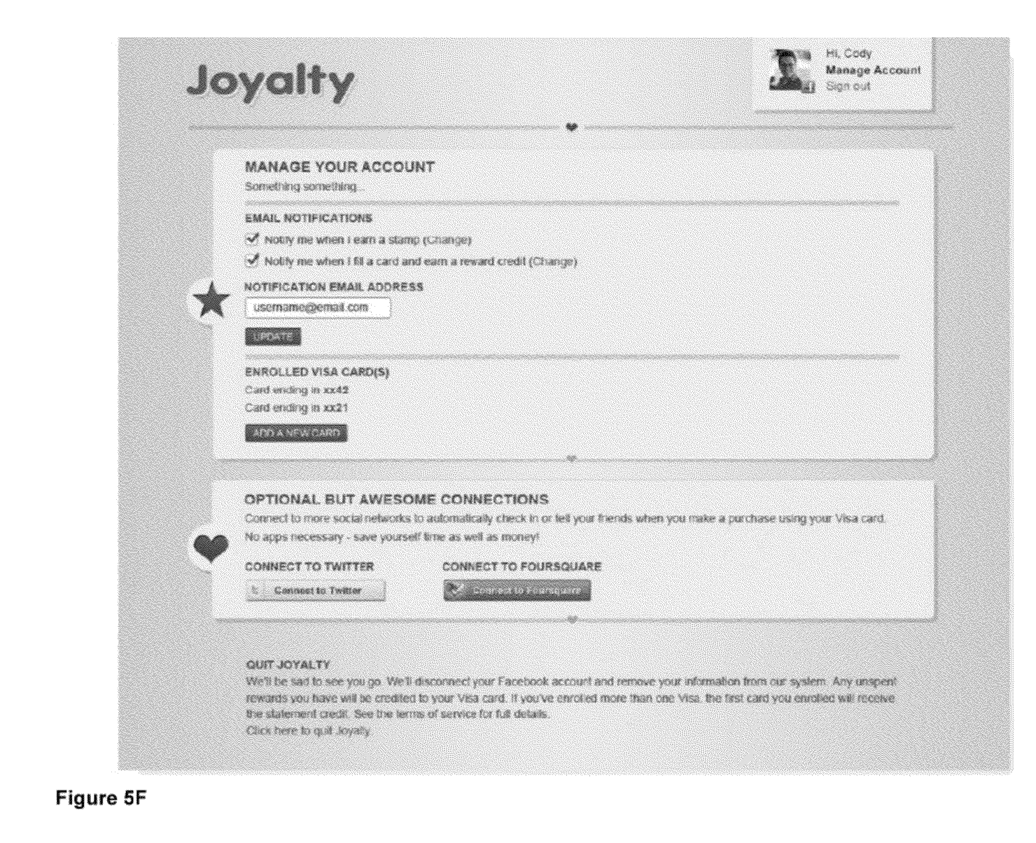

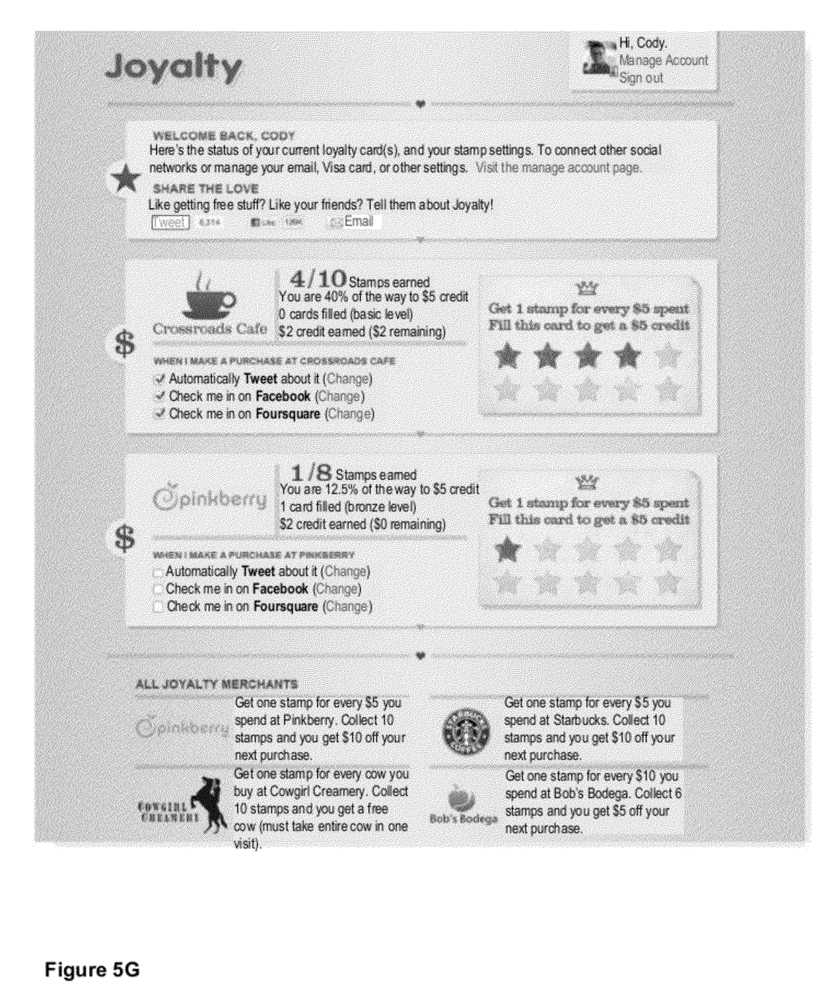

FIGS. 5A-5G provide example screen shots illustrating consumer experience within embodiments of the L-PROMO. In one embodiment, as shown in FIG. 5A, the L-PROMO may bridge with a partner network (e.g., Joyalty 506) for L-PROMO deployment. In one implementation, the L-PROMO may provide issuers 505 with an effective means for engagement with consumers to drive “top of wallet” and minimize costs of rewards programs. The L-PROMO may increase card usage and spend with delivery of relevant offers at the point of transaction using the issuer control panel/API to manage offer targeting for issuer or co-brand partner merchants (e.g., offer additional rewards or incentives to encourage use of specific card portfolios). The L-PROMO may reduce expense of issuer rewards program using Visa managed service for offers/loyalty management and messaging of programs to differentiate issuer services.

In another embodiment, the L-PROMO may provide payment processor e.g., Visa facilities to deliver value added services resulting in increased merchant, consumer, and issuer use of Visa platform services protecting core revenue streams and enabling new revenue streams. The L-PROMO may increase merchant and consumer preference for Visa services because they like the ease of use, reliability and security as well as the money they save and quality of support/service Visa provides, and additional economies of scale from the use of existing platform services through integration with TAQC and Alerts and new revenue streams from delivery of campaign management, offer distribution, online/in-store offer fulfillment/redemption, and analytics.

For example, in one implementation, as shown in FIG. 5A, L-PROMO may integrate loyalty program with a consumer's electronic wallet (e.g., a Visa card 510, a Master Card 515, etc.). In one implementation, the L-PROMO combined with Visa platform may promote lively developer environment by demonstrating the power of mixing in components to the wallet. The L-PROMO may utilize Visa Wallet to add L-PROMO deals/loyalty offerings to go inside the wallet. In a further implementation, the L-PROMO may bridge with the MasterCard and others to offer L-PROMO deals to consumers.

FIG. 5B illustrates an example screen showing user experience of a viral entry point, e.g., a L-PROMO automatic news feed on Facebook. FIG. 5C shows an example splash page via Joyalty, which may communicate value proposition to consumer, enumerate benefits and prompt user to get started. In FIG. 5D, consumers' Facebook accounts may automatically connect to the Joyalty/L-PROMO enrollment, which may remove enrollment steps and allow L-PROMO payment network (e.g., Visa) to collect opt-in permissions for social operations. In FIG. 5E, the L-PROMO and/or Joyalty may send welcome emails to registered consumers, which may introduce the user to the new service, and may show them their new virtual loyalty card. In FIG. 5F, the L-PROMO and/or Joyalty may allow additional opt-ins may include Twitter, FourSquare, Yelp, Groupon, ScoutMob, and/or the like. Users may opt out of individual purchase-level notifications, and may be reassured that their card information will not be used to charge the card. In FIG. 5G, a consumer may receive loyalty offers from his L-PROMO account and the associated rules. For example, a consumer may have to spend the credit where he or she earns it, or it may be good upon the next visit after earning, and/or the like.

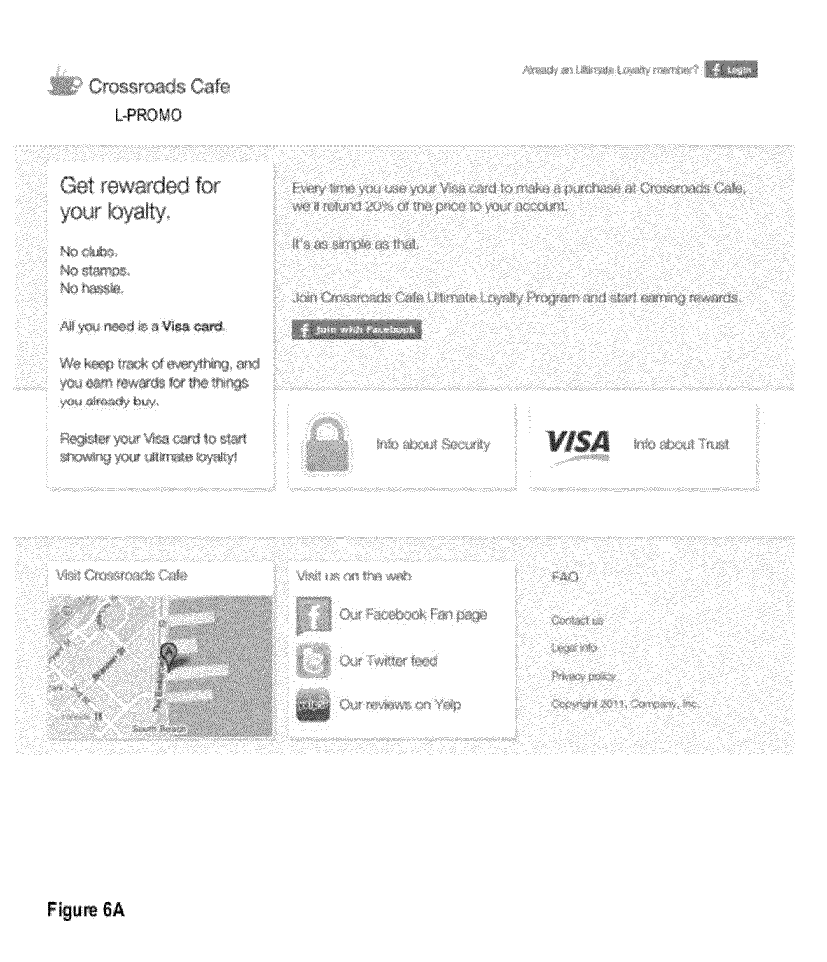

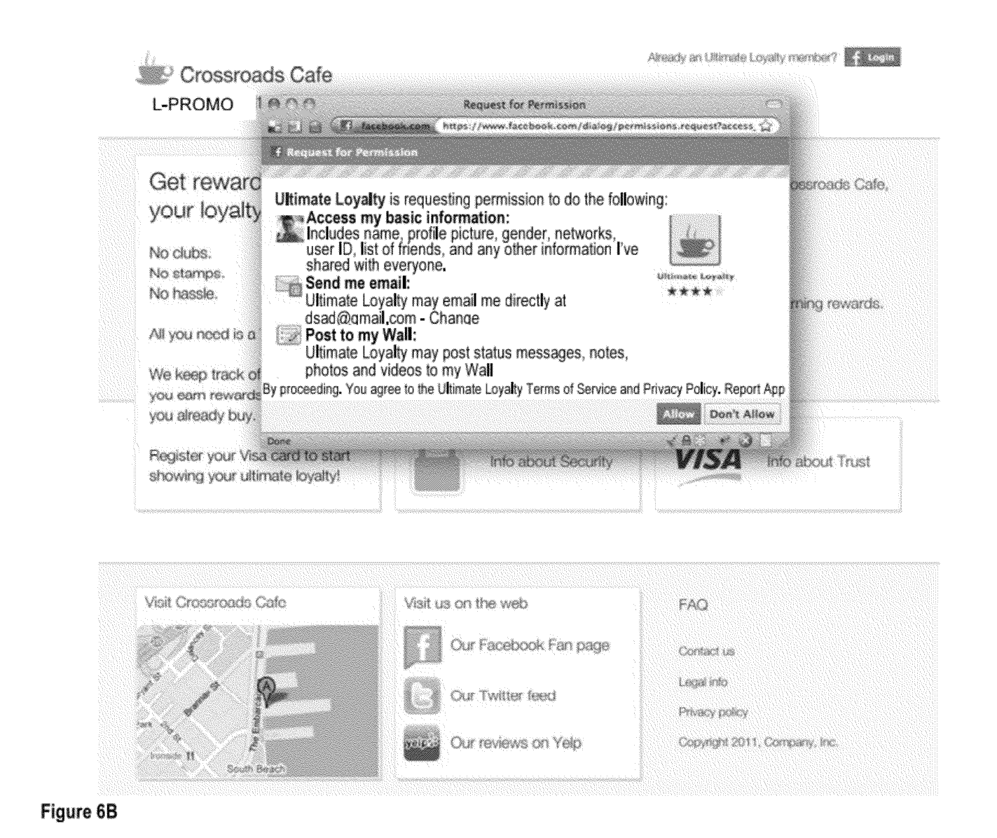

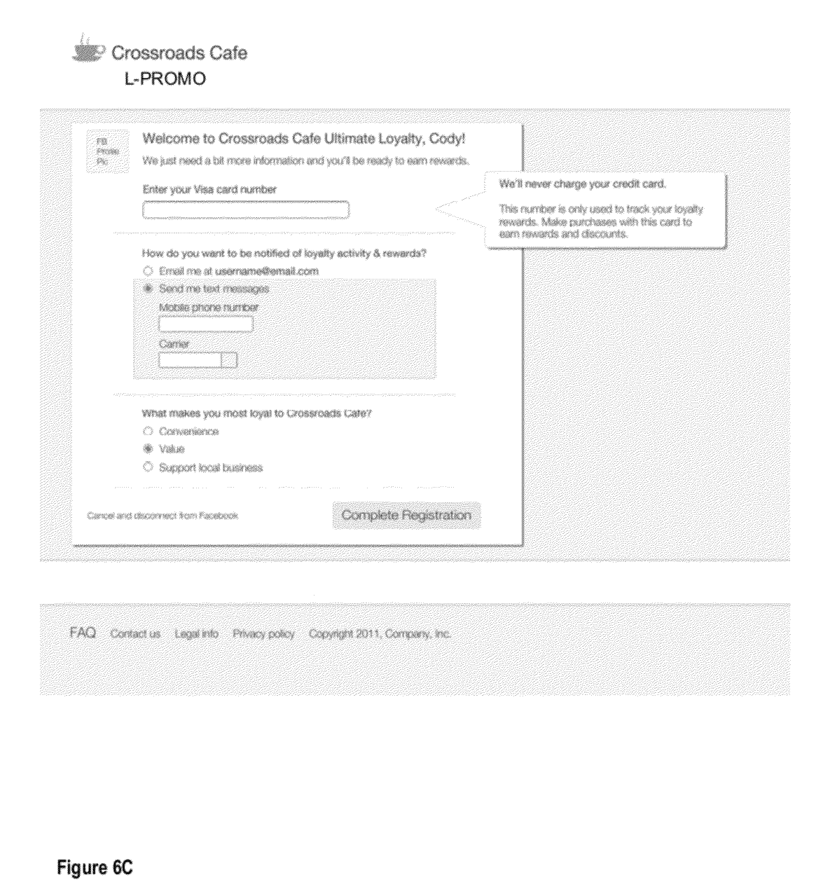

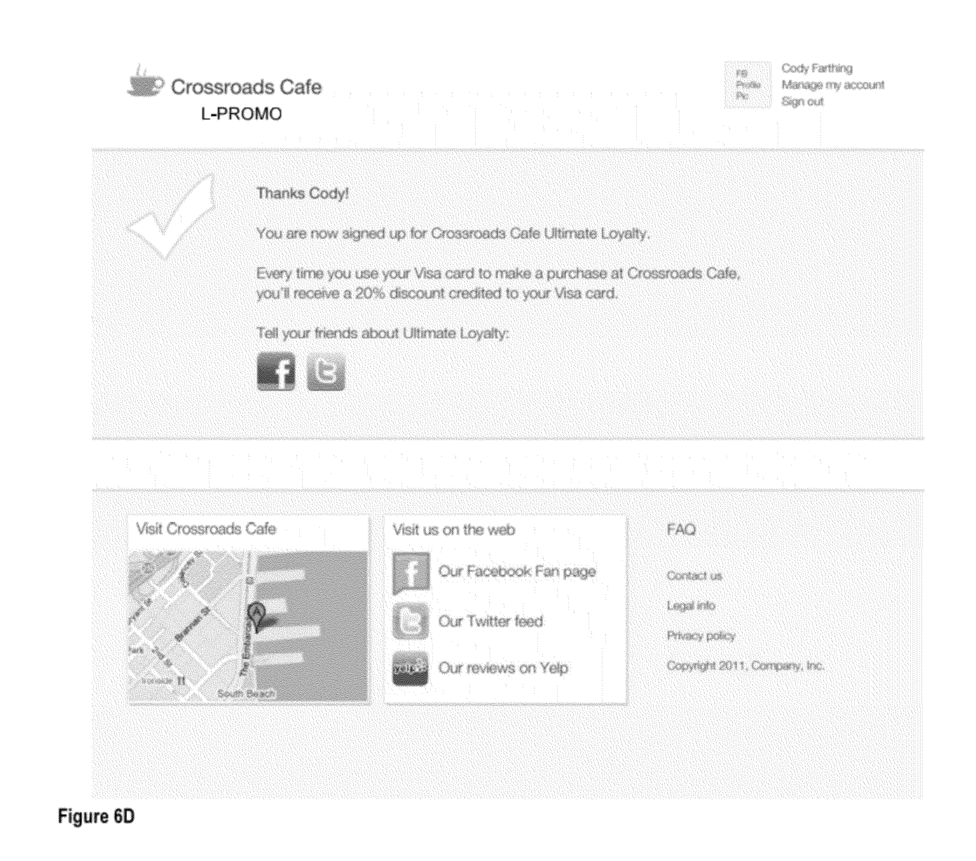

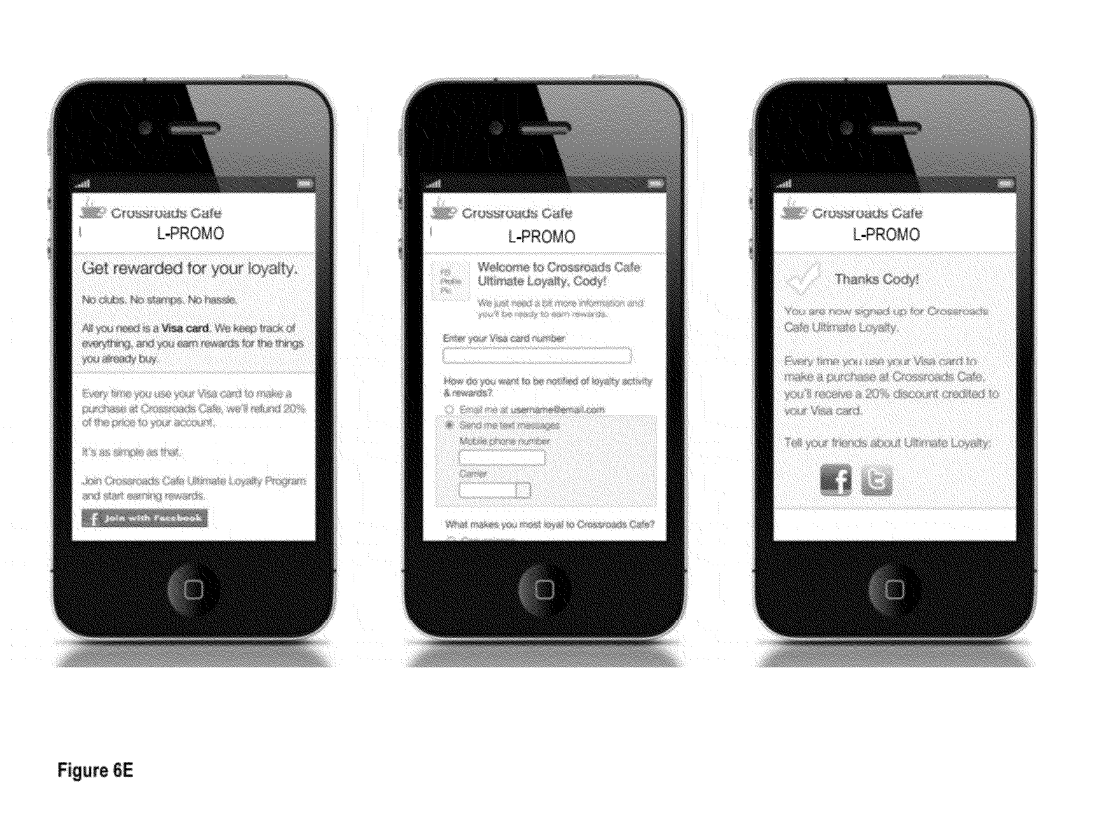

FIGS. 6A-6E provide example screen shots illustrating consumer mobile experience within embodiments of the L-PROMO. In one implementation, the L-PROMO may provide mobile applications to consumers, such as in-store mobile onboard application, social and web/email based application, and/or the like. In one implementation, a consumer may retrieve offers by scanning offer barcode and messaging at point of purchase.

For example, in FIG. 6A, a consumer may land on splash page to retrieve an offer, e.g., “Crossroads Café” loyalty offers. Upon selecting an offer, the consumer may view an authorization message popped via Facebook connection to allow access of L-PROMO to the consumer's Facebook profile, e.g., FIG. 6B. The consumers may be requested to provide card information and reassured that their card information will not be used to charge the card, as shown in FIG. 6C. In one implementation, consumers may connect through other social networks and benefit from linking to other deals, e.g., Twitter, Yelp, Groupon, Foursquare, etc., upon completion registering with “Crossroads Café” on L-PROMO, e.g., FIG. 6D.

In a further implementation, a consumer may download a smartphone application for L-PROMO and engage L-PROMO consumer application on the smartphone (e.g., an Apple iPhone, etc.). FIG. 6E provide example user interfaces of a L-PROMO iPhone application within embodiments of the L-PROMO.

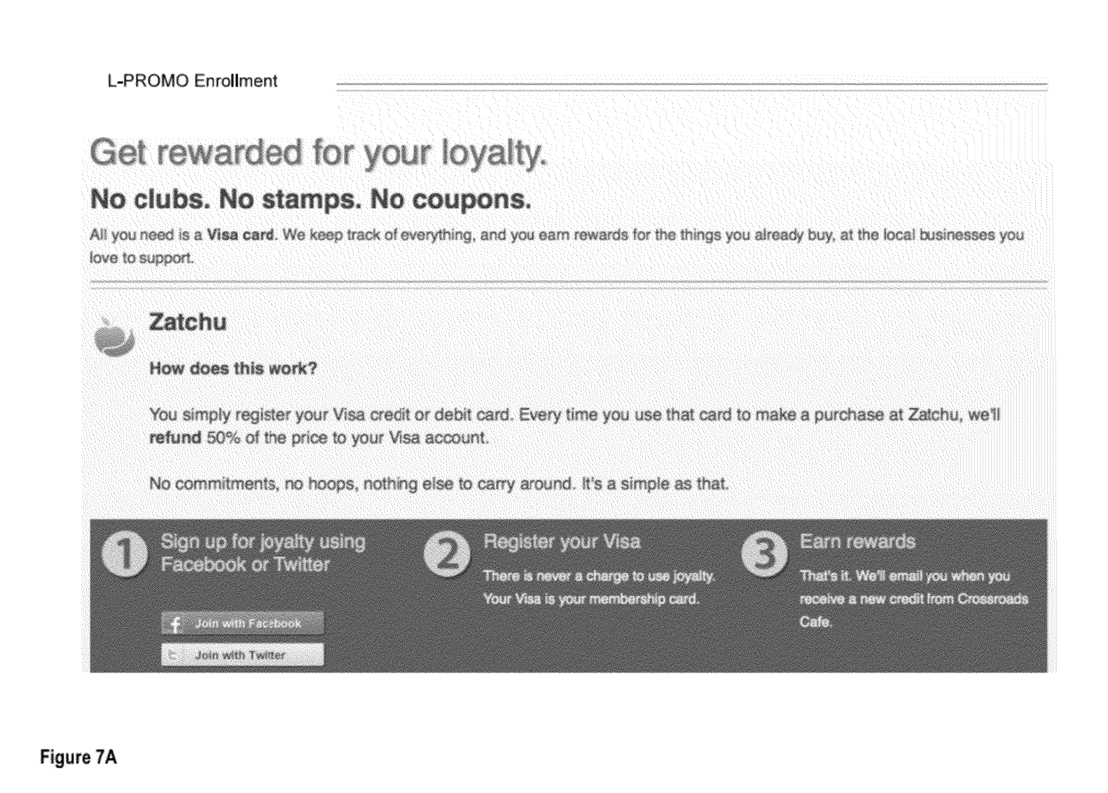

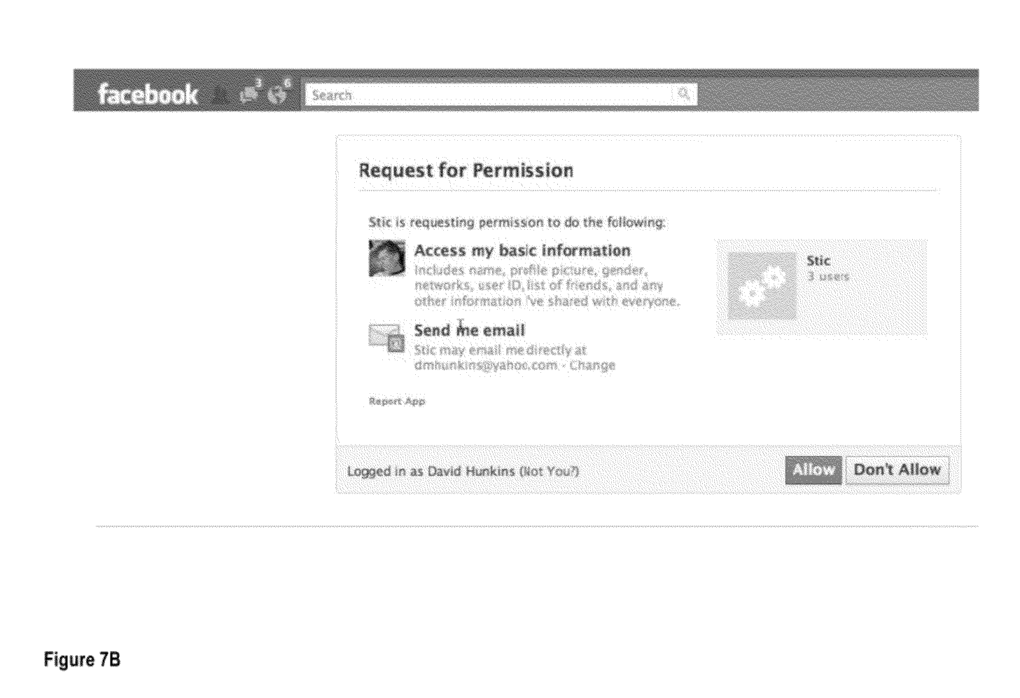

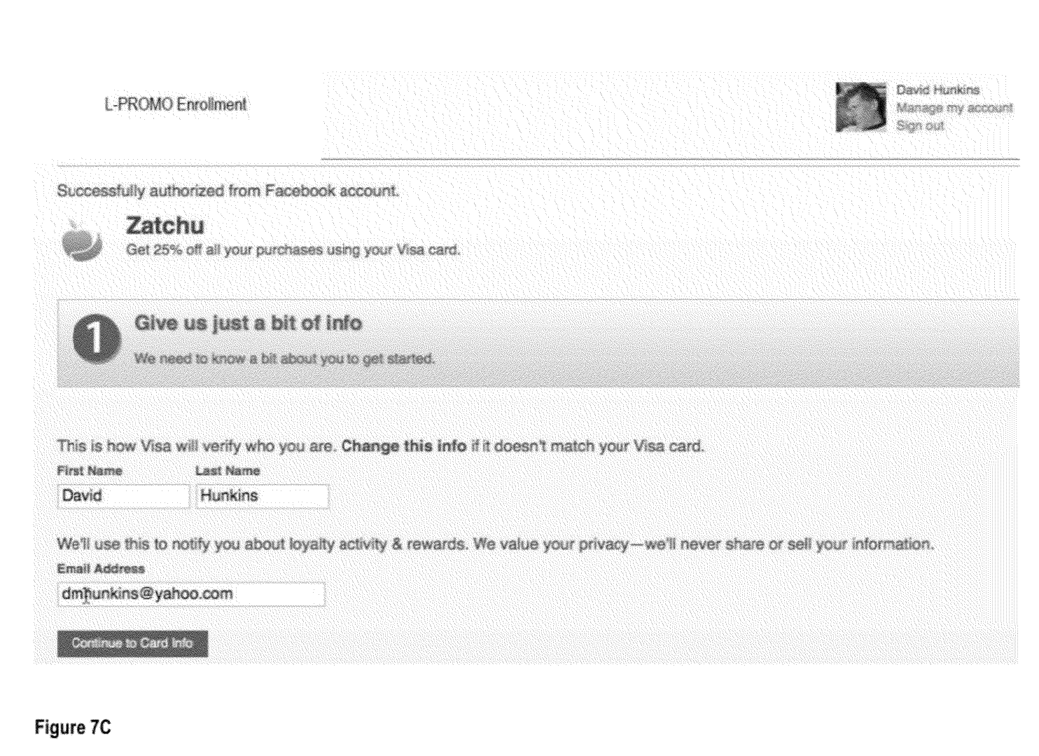

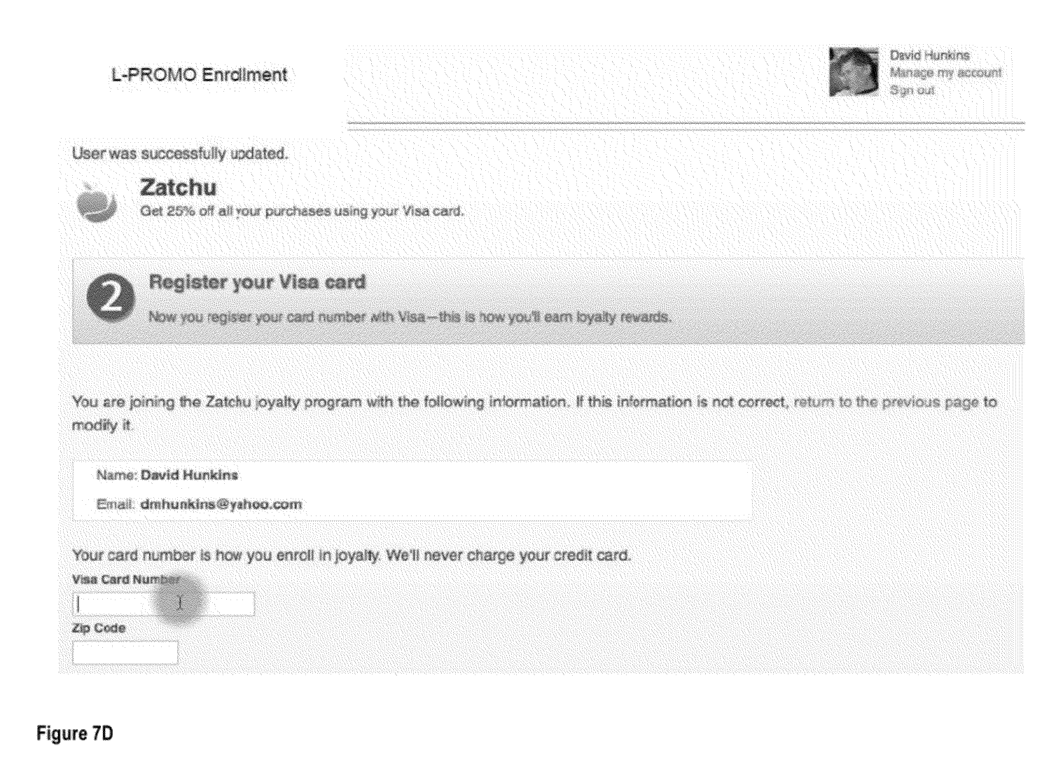

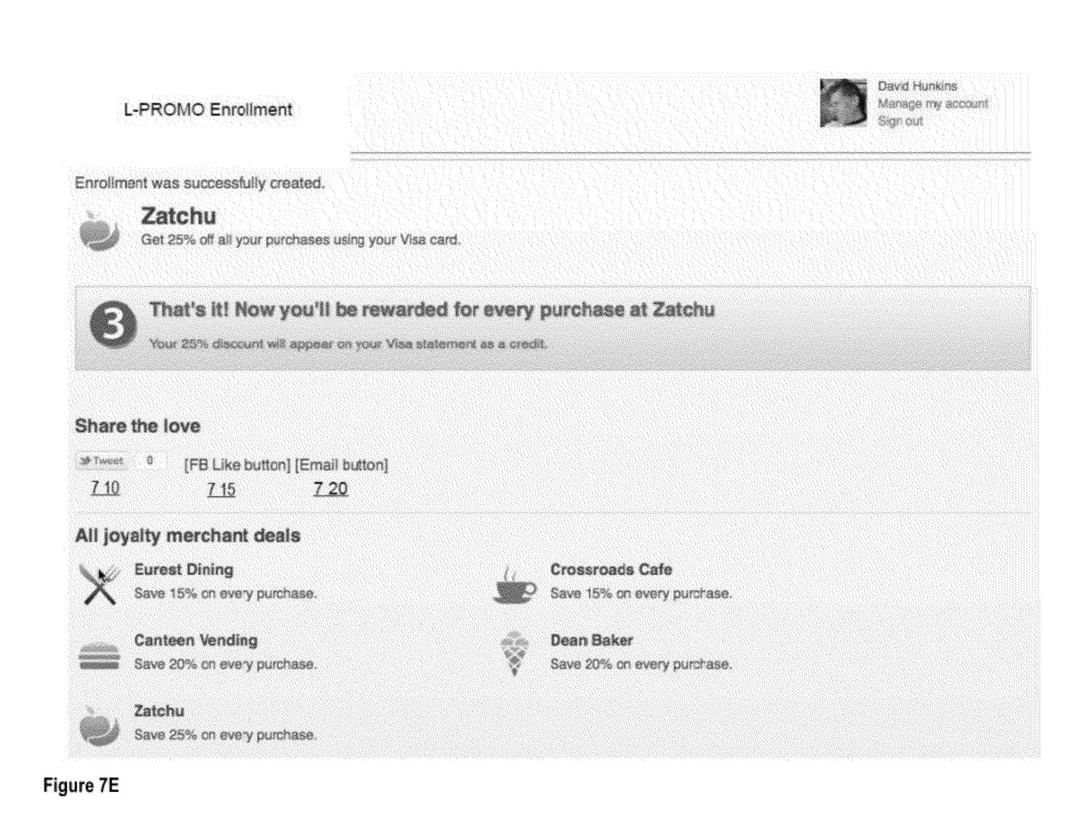

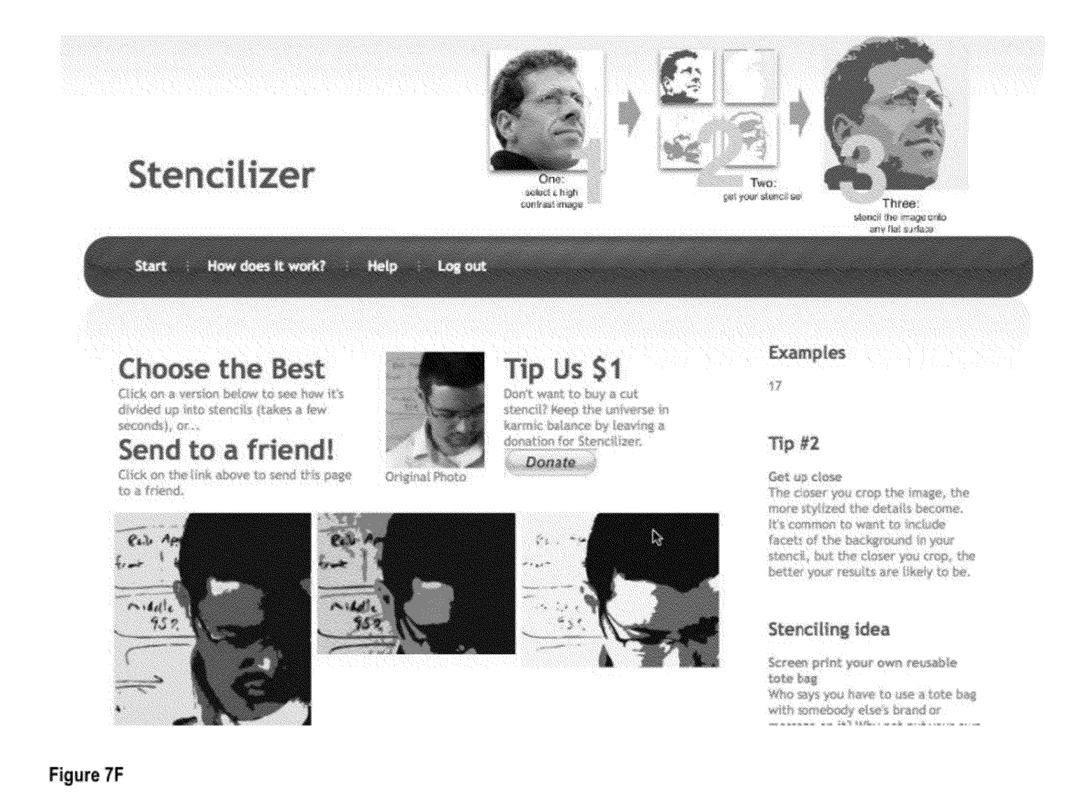

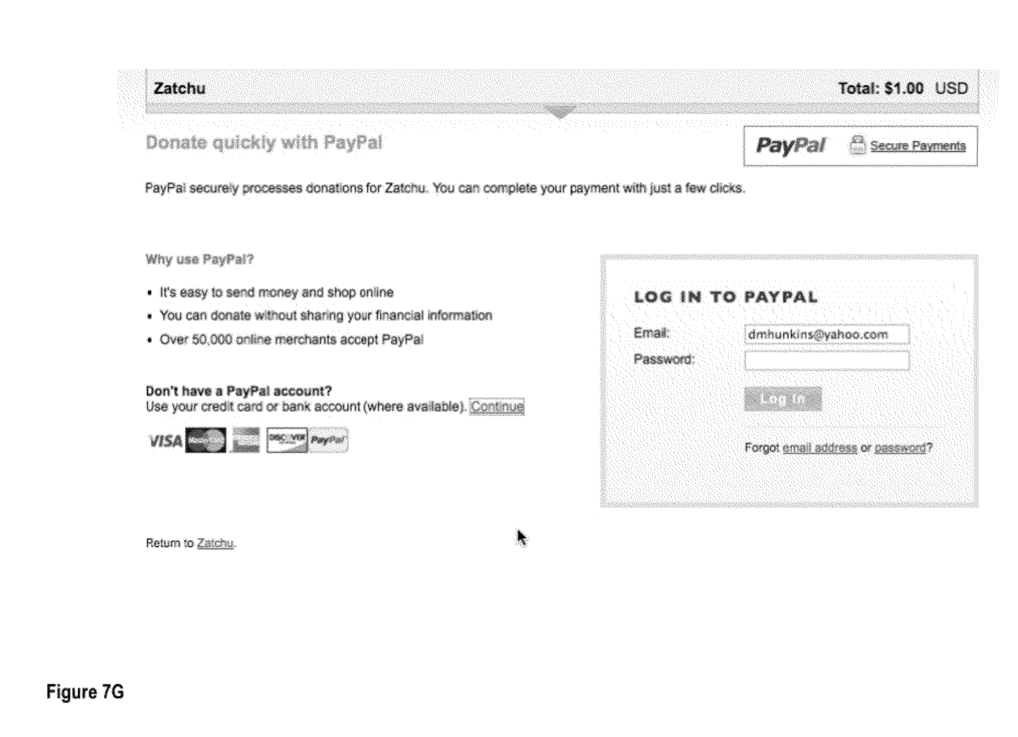

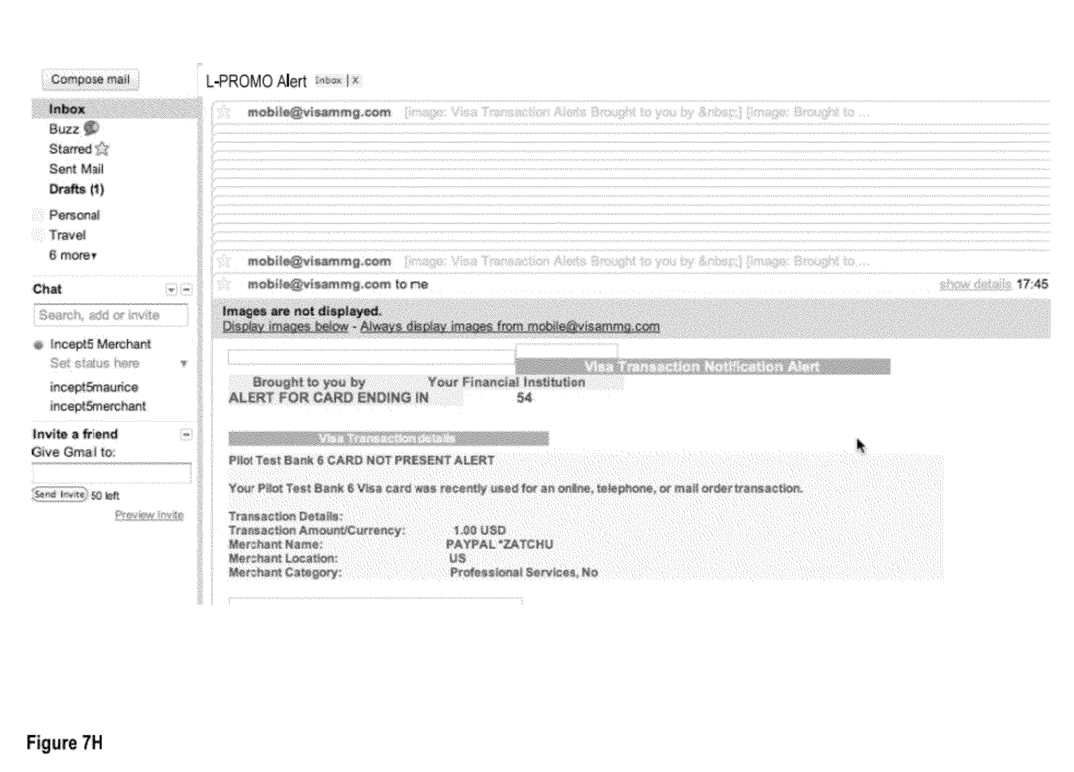

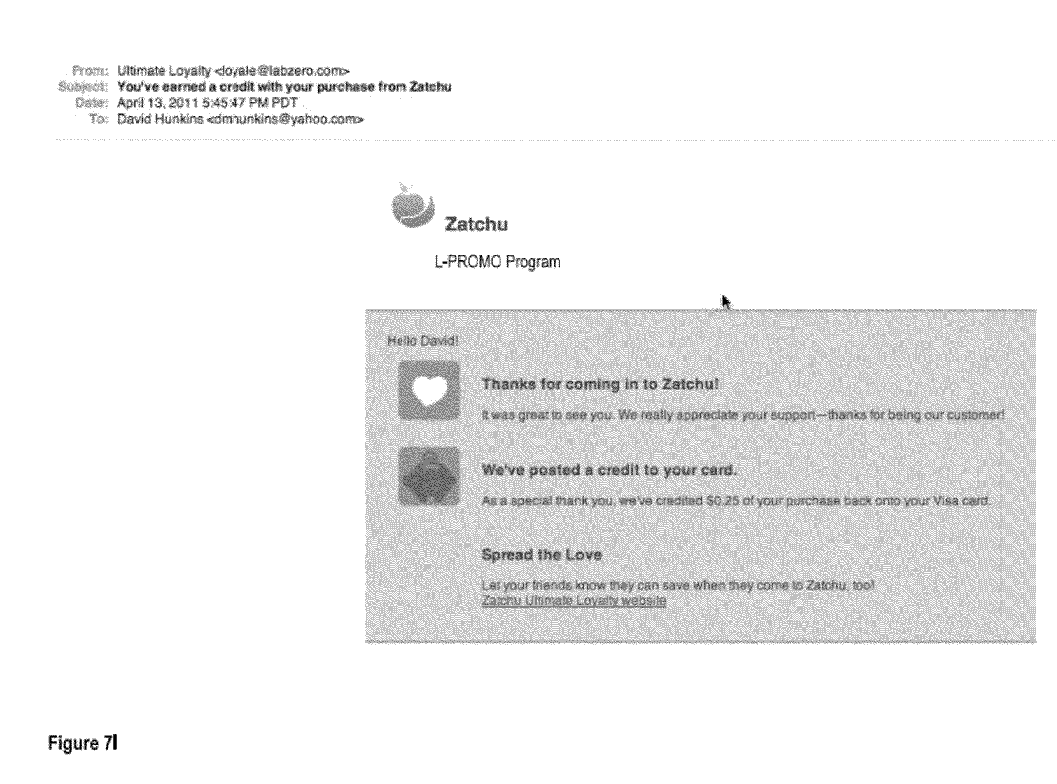

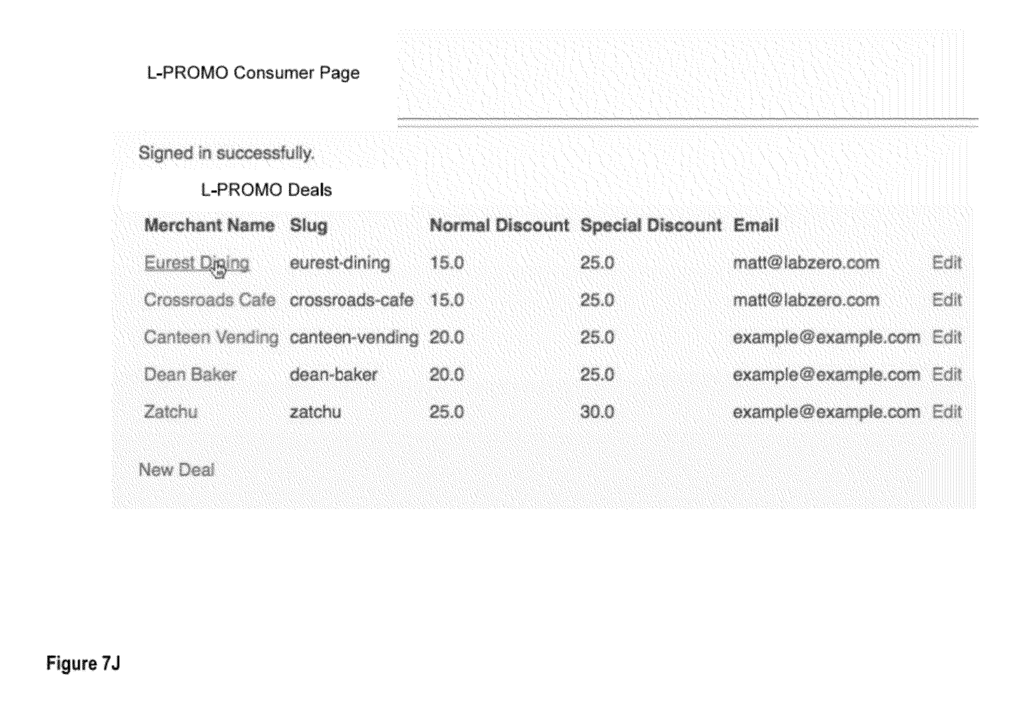

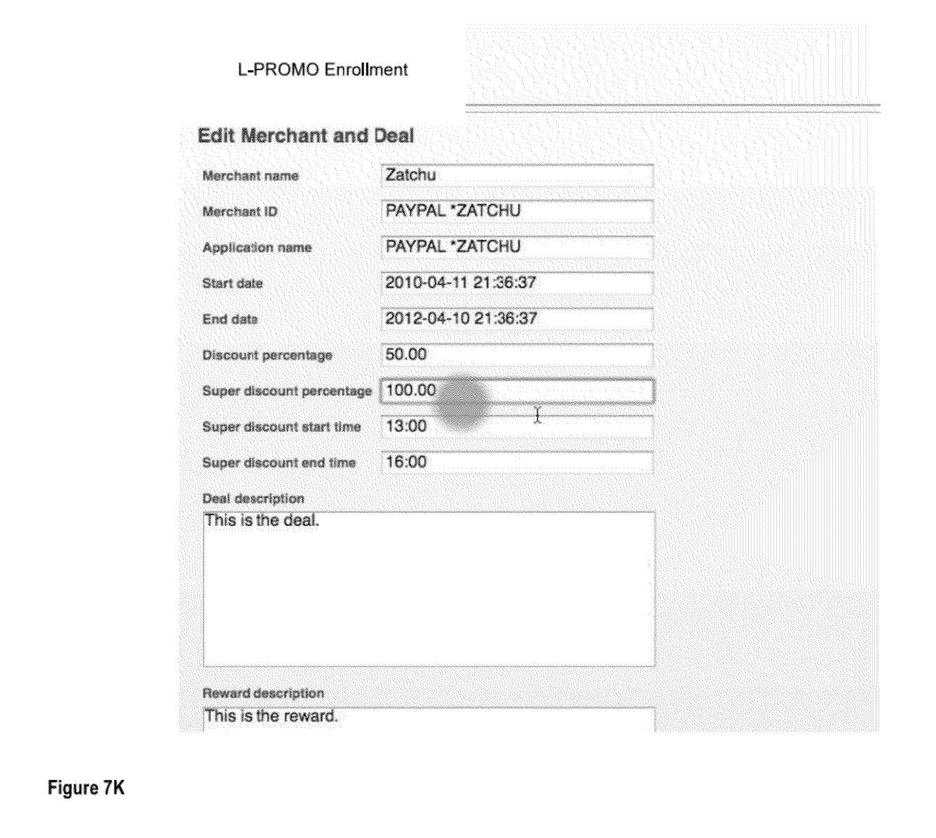

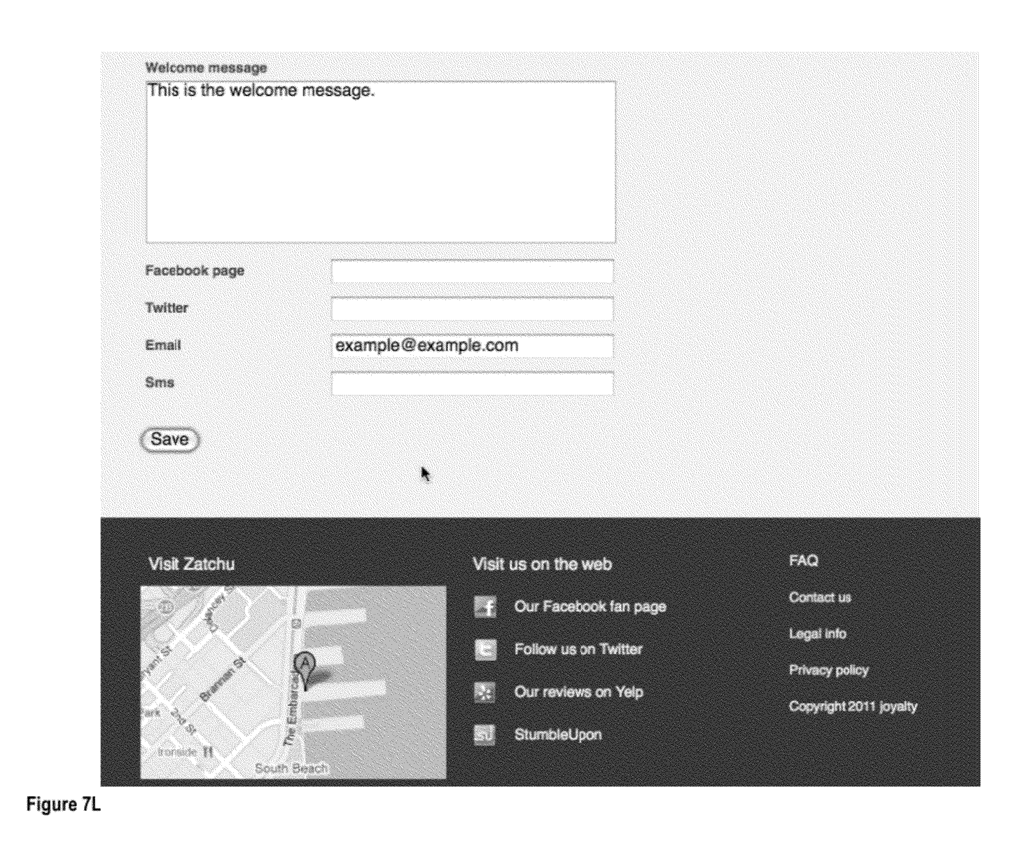

FIGS. 7A-7L provide example screen shots illustrating alternative embodiments of L-PROMO consumer user interfaces and merchant service user interfaces within embodiments of the L-PROMO. In one implementation, a consumer may access a L-PROMO enrolling website, and view a welcome page for registration, as shown in FIG. 7A. In one implementation, the consumer may link his Facebook account to the L-PROMO account, and may log into his Facebook account to allow access of L-PROMO to his Facebook page, e.g., as shown in FIG. 7B.

In one implementation, the consumer may provide consumer identifying information, such as consumer name, email addresses, and/or the like to the L-PROMO for registration, as shown in FIG. 7C. The consumer may further link his bank account to the L-PROMO account. For example, the consumer may register his Visa credit card by providing card number and zip code to the L-PROMO, as shown in FIG. 7D.

Upon completion of enrollment with L-PROMO, the consumer may view a list of recommended offers, participating merchants on his L-PROMO profile page, e.g., as shown in FIG. 7E. The consumer may also share the L-PROMO offers by click on the “Tweet” 710, “Facebook Like” 715 and/or “Email” 720, to share the L-PROMO offers to his social media contacts.

FIGS. 7F-7I provide example screens illustrating an offer redemption within embodiments of the L-PROMO. In FIG. 7F, a consumer may access a L-PROMO participating merchant website “Stencilizer,” and click on “Donate” to donate $1.00. To complete the transaction, the merchant website may launch a L-PROMO plug-in for payment processing, e.g., the consumer may sign in his PayPal account to pay, as shown in FIG. 7G. Upon payment with PayPal, the L-PROMO may send a confirmation to the consumer, e.g., an email receipt summarizing the transaction details, as shown in FIG. 7H. In one implementation, the L-PROMO may process an offer associated with the donation, and the consumer may receive an email notifying an automatic rebate amount of $0.25, as shown in FIG. 7I. The rebate may be automatically credited to a registered bank account, e.g., a Visa credit card, etc., with the L-PROMO account.

FIG. 7J shows a list of L-PROMO offers presented to a consumer when the consumer signed in his L-PROMO account via a web application. For example, if the consumer has specified his interests are “coffee,” “restaurants,” the L-PROMO may match merchant offers with his interests and present the list of offers from “Eures Dining,” “Crossroads Café,” “Canteen Vending,” “Dean Baker,” and/or the like.

FIGS. 7K-7L provide example screen shots illustrating merchant enrollment experience within embodiments of the L-PROMO. In one embodiment, a merchant may access L-PROMO merchant service panel to edit merchant profile and deal information, as shown in FIG. 7K. For example, the merchant may enter information such as merchant name, merchant ID, application start time, end date, discount percentage, deal description, and/or the like. In one implementation, the L-PROMO may provide a map application to locate the merchant store, and link the merchant's L-PROMO account to the merchant's profile page on Facebook, Twitter, Yelp, StumbleUpon, and/or the like, as shown in FIG. 7L.

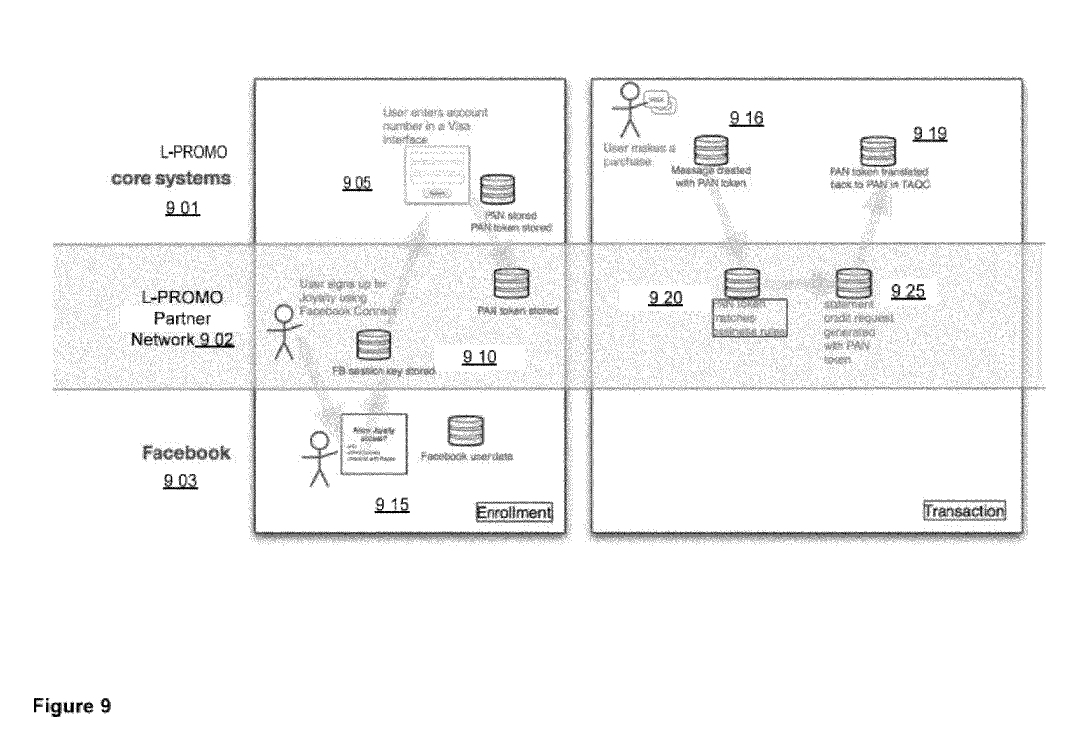

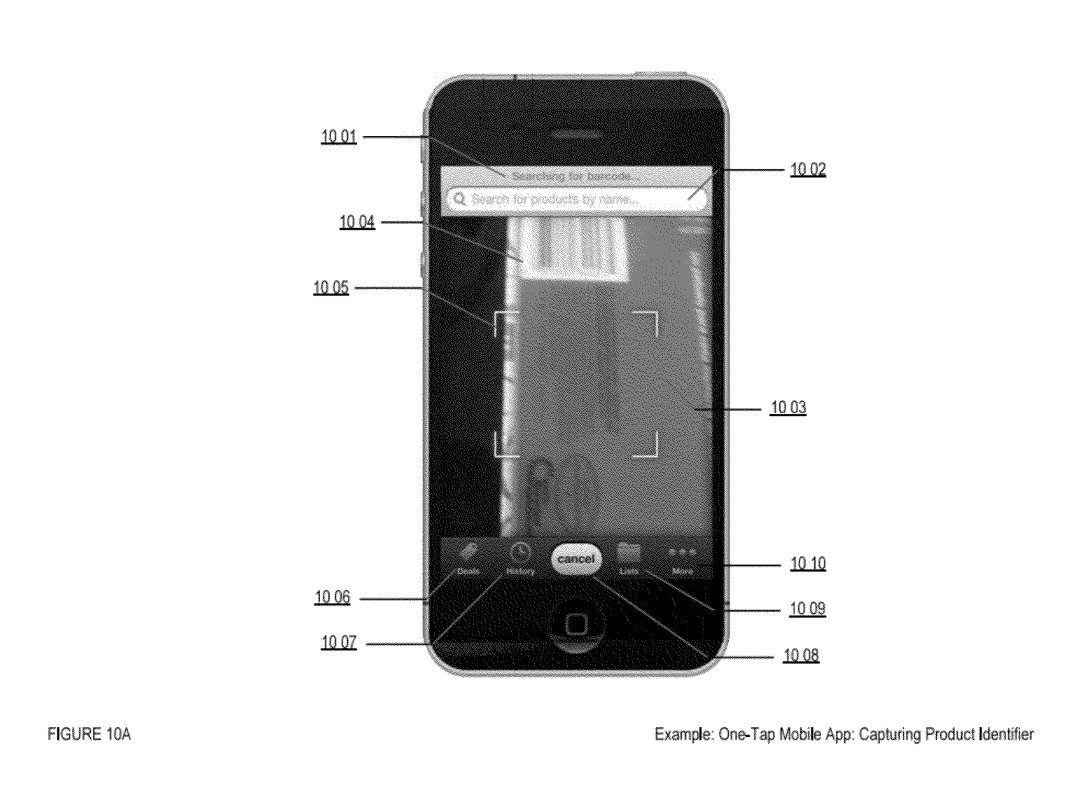

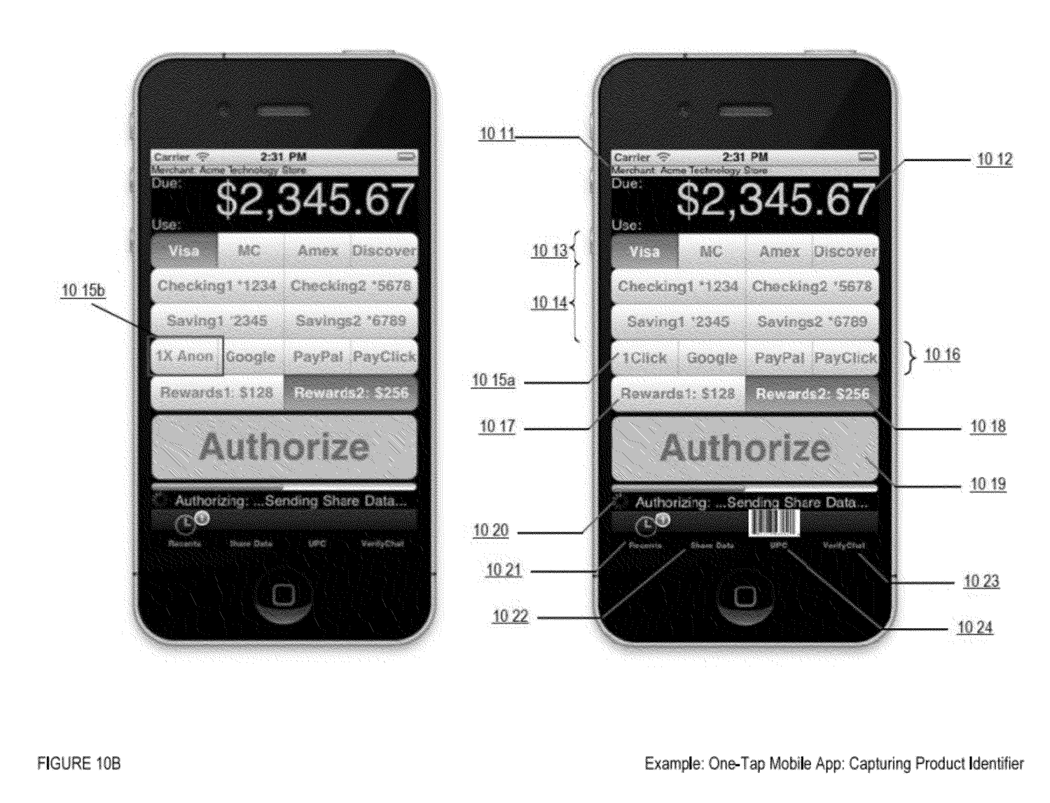

FIG. 9 provides an example architecture illustrating L-PROMO data compartmentalization within embodiments of the L-PROMO. In one implementation, L-PROMO core systems 901 may interface with L-PROMO partner networks 902 (e.g., Joyalty, etc.), and social media (e.g., Facebook 901) via encrypted data transmission based on PAN tokens. For example, in one implementation, at enrollment, consumer data may not be stored within the L-PROMO enrollment web application when a consumer enters account number into a payment webpage, but a PAN token may be stored which is de-referenced at time of statement credit 905. In another implementation, during transaction, when a user makes a purchase, the L-PROMO may create a message with PAN token 916, which may be translated back to the PAN token in transaction database 919. In one implementation, PAN may be visible to payment processor core systems instead of other UI applications to enhance security.

In one implementation, the L-PORMO partner network 902 may interface with the L-PROMO core 901 to receive a PAN token for consumer enrollment information. In another implementation, if a consumer sign up with the partner network (e.g., Joyalty, etc.) via Facebook connect, the Facebook session key may be stored 910 and send to L-PROMO core 901 for account setting. The Facebook 903 may in turn receive a request to allow access 915.

In another implementation, at transaction, the L-PROMO partner network 902 may receive a PAN token matches with business rules 920 from the L-PROMO core. For example, the L-PROMO partner network may receive and store tokens within a time frame of the transaction. The L-PROMO partner network may then generate a statement credit request (e.g., offer redemption, rebate, etc.) and send the request with the PAN token 925 back to L-PROMO core for interpretation.

In further embodiments, the L-PROMO may facilitate provision of merchant offers to consumers in a social and/or mobile setting. In one implementation, merchants may offer deals to drive acquisition and loyalty, while consumers may redeem offers by paying with their bank cards (such as VISA, MASTERCARD, AMERICAN EXPRESS, etc., branded credit, debit and/or prepaid cards). In a further implementation, the L-PROMO may leverage the facilities of payment processors such as, but not limited to VISA, MASTERCARD, etc., for automatic statement credits, and transaction data from such payment processors for robust offer targeting. In one implementation, the L-PROMO may drive traffic to the merchant sites through viral notifications of offers and qualification.

In one implementation, the L-PROMO may be targeted towards individuals, small and medium-sized merchants and/or large (enterprise) merchants. The L-PROMO may operate as a standalone service in one implementation. In another implementation, the L-PROMO may be integrated with wallet facilities. For example, the L-PROMO may track consumer usage (e.g., offer acceptance, redemption), number of transactions per participant over time. The L-PROMO may discover most productive: entry points, viral mechanisms, merchant offer structures, may facilitate better understanding of merchant services integration, analytics/intelligence across acceptance and campaign management services, optimized campaign alerts and campaign management for merchants, optimized UI and APIs for campaign setup and management.

In one implementation, consumers may take advantages of the facilities provided by the L-PROMO by enrolling with the merchant, the L-PROMO, and/or a third-party. By enrolling, each consumer may obtain a L-PROMO account. In a further implementation, consumers may link their accounts to their social networks. Such linking may be facilitated by one or more APIs. Consumers may customize their accounts by setting account preferences (e.g., . . . ) Consumers may receiver offers, may make purchases, share experiences and get discounts by participating in the L-PROMO facilities.

In one implementation, merchants may also enroll to participate in the services provided by the L-PROMO. In a further implementation, merchants may link their social network pages and/or accounts to their UL accounts. In one implementation, merchants may utilize the facilities provided by the L-PROMO to set up campaign offers, manage messaging to consumers, analyze campaign performance and watch their business grow.

The L-PROMO may provide several benefits to merchants. In one implementation, the L-PROMO ties loyalty and conversion to a receipt (not proximity or GPS). As such, the L-PROMO integrates well with existing check out technologies with seamless POS acceptance and offer fulfillment, increased acquisition and loyalty at lower cost (e.g., because of viral effect).

The L-PROMO may provide several benefits to consumers. For example, consumers may not have to print and/or carry coupons, loyalty cards, etc. If an offer is available, consumers automatically receive statement credits and real-time offer notifications. Consumers may also take advantage of the integration of L-PROMO with social networks.

The L-PROMO may provide several benefits to payment processors such as VISA. Payment processors may leverage open social platforms and card transaction history and may link online notification/interactions to offline redemption. Further social networks may take notice and take advantage of the benefits by forming relationships with payment processors.

In a further implementation, the L-PROMO may view every transaction and message information about that transaction in real time to both the loyalty service and the consumer. For merchant services, the L-PROMO may provide APIs and support services for merchants to facilitate rapid on-boarding and campaign implementation, offer redemption through existing point of sale infrastructure (i.e., existing Visa acceptance services), self-service merchant control panel for ongoing offers/loyalty campaign management, partners are open platforms (e.g., Facebook, Twitter, Foursquare and other open platforms can be leveraged to provide retailer benefits and spread the application virally). In further implementations, the L-PROMO may test the viability of concept as Wallet feature, test viability of services for merchant offers/loyalty campaign management with analytics and conversion data, and serve as a business development response to Twitter and Facebook.

### Alternative Embodiments of L-PROMO

Within embodiments, the present application provides a processing environment for a transaction conducted upon an account by a consumer with the merchant. The account is identified with a private label or co-branded portable consumer transaction payment device, such as a debit or credit card. The consumer is taking advantage, via the transaction, of a promotional offer for purchasing an item in the transaction on the account. To conduct the transaction, the item is identified. Instead of processing the transaction by financial messaging in a closed loop system, the transaction is processed in an open loop system where there is an issuer and a different acquirer that communicate financial messaging for the transaction on the private label or co-branded account through a transaction handler (e.g.; Visa Inc., MasterCard, etc.). As such, the private label or co-branded account transaction will be processed so as to realize efficiency through an open loop system.

The open loop system processing of a transaction on a private label or co-branded account should be subjected an authorization which requires approval by the issuer of the account. The present application discloses processing in a open loop system of a transaction on a private label or co-branded account for an amount requested for authorization that is different that an amount that is approved for authorization (i.e.; partial authorization), such as where a reward or promotional discount is offered to the consumer for conducting the transaction on the account. Also disclosed is processing in a open loop system of a transaction that includes a party responsible for repayment of the reward or promotional discount given to the consumer for conducting the transaction on a private label or co-branded account. The present application further discloses a process by which promotional financing can be offered to a consumer in a open loop system for a transaction on a private label or co-branded account.

Some of the disclosed implementations employ communications directly between a merchant and an issuer offering promotional financing for a promotional item being purchased from the merchant. Other disclosed implementations enable different transaction amounts in an authorization request message and its corresponding authorization response as are respectively sent and received by a merchant, where the different can be for a promotion offered to an accountholder for conducting a transaction on an account with the merchant.

Efficiency benefits can be accomplished by implementations disclosed in the present application of open loop system processing of a transaction on a private label or co-branded account that would normally be processed in a closed loop system, that is, where the issuer (i.e.; the cardholder's bank) and the merchant's bank (i.e.; the acquirer) are both the same entity. Split ticket open loop system processing of such a transaction can be also be accomplished so that the transaction can be settled at different points in the open loop system. As such, more merchants than otherwise can accept private label or co-branded cards and yet still be able to use the efficiency and the robustness of open loop processing.

The present discussion considers an improvement to the current industry practice of a consumer using a private or co-branded account, as may be represented by a credit or charge card, to obtain financing or a reward from a merchant for purchasing an item on an account issued by an issuer to the consumer that is associated with the private label or co-branded account, where the item is purchased in a transaction between the consumer and a merchant. The private label card is one that can only be used to make purchases with the merchant and none other (e.g., a card can be used only at “The Gap” retail stores or only at “Macys” department stores). In such cases, often referred to as a ‘closed loop’ transaction, the reward and the financing is dealt with as being between the consumer, the merchant, and/or the issuer.

In contrast, a co-branded card may be used at many different merchants to make purchases (e.g., a Southwest Airlines Visa Card). Such a transaction is often referred to as an

Open loop' transaction. Disclosed implementations identify for the merchant, acquirer and issuer how a transaction handler or processor (transaction handler) can support techniques to identify an item in a transaction that is subject to a promotion. Such techniques include use of product level data, level three data, Stock Keeping Units (SKU), and/or Universal Product Codes (UPC) in order to identify item promotions and merchant discounting. Disclosed implementations also identify how to employ instant rewards to the consumer at the merchant's Point of Service terminal (POS) at the time of the purchase, and how to employ rewards that are not given to the consumer until the time of posting on the account of the consumer that was used to conduct the transaction at with the merchant. Disclosed implementations support product/SKU level promotions, merchant discounting based on SKU, a promotion paid by a sponsor (e.g., wholesaler(s)/distributor(s)/manufacturer(s)) of the item through the open system via the transaction handler, and techniques for deploying instant POS discounts (e.g., for rewards or promotions, including an initial purchase discount).

Exemplary solutions are identified for the following business applications: (a) Co-brand/Private Label promotional financing; (b) Special merchant discounting based on individual product/items purchased; (c) Sponsored (e.g.; Manufacturer) Financing of Promotional Item Sales; (d) Initial Purchase Discount (at Authorization or at Posting); and (e) Real-Time POS Rewards.

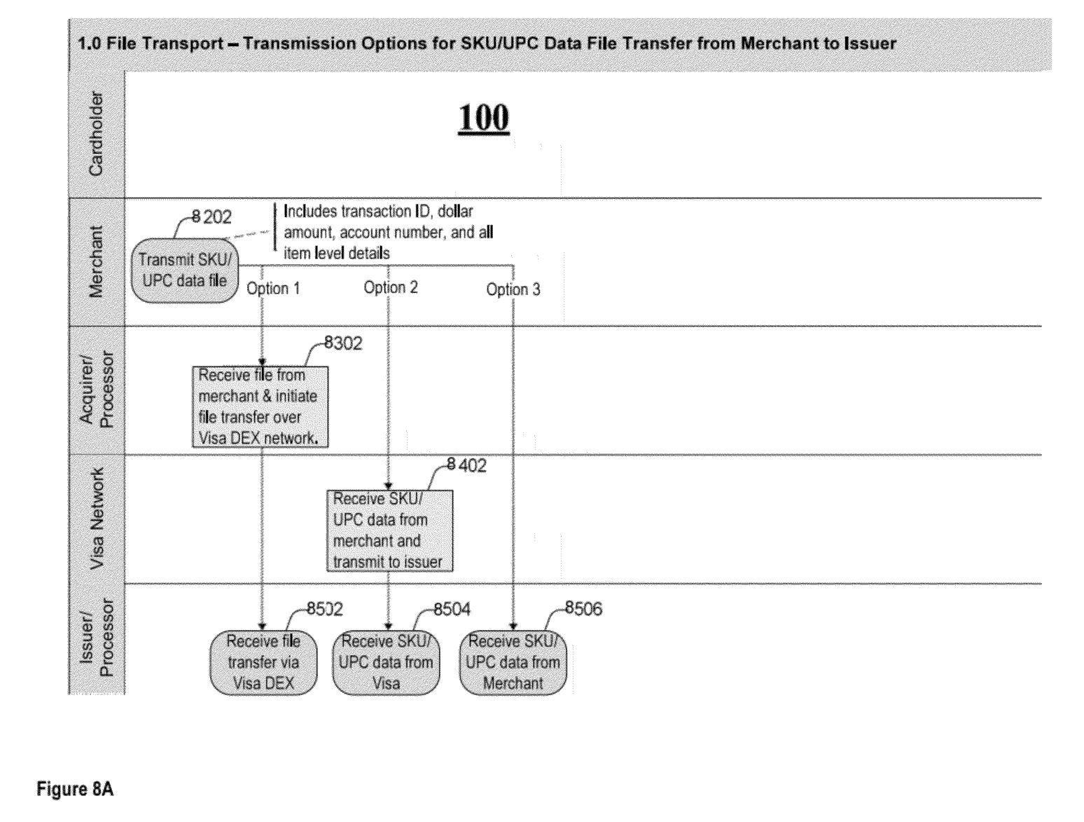

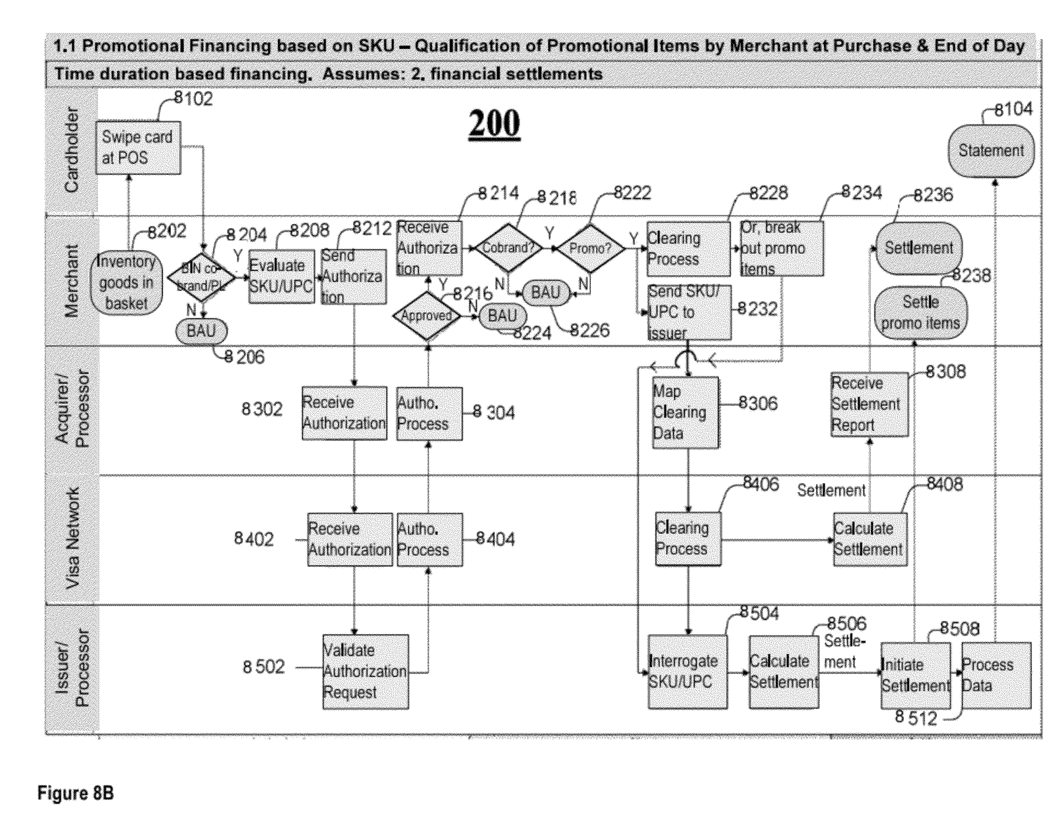

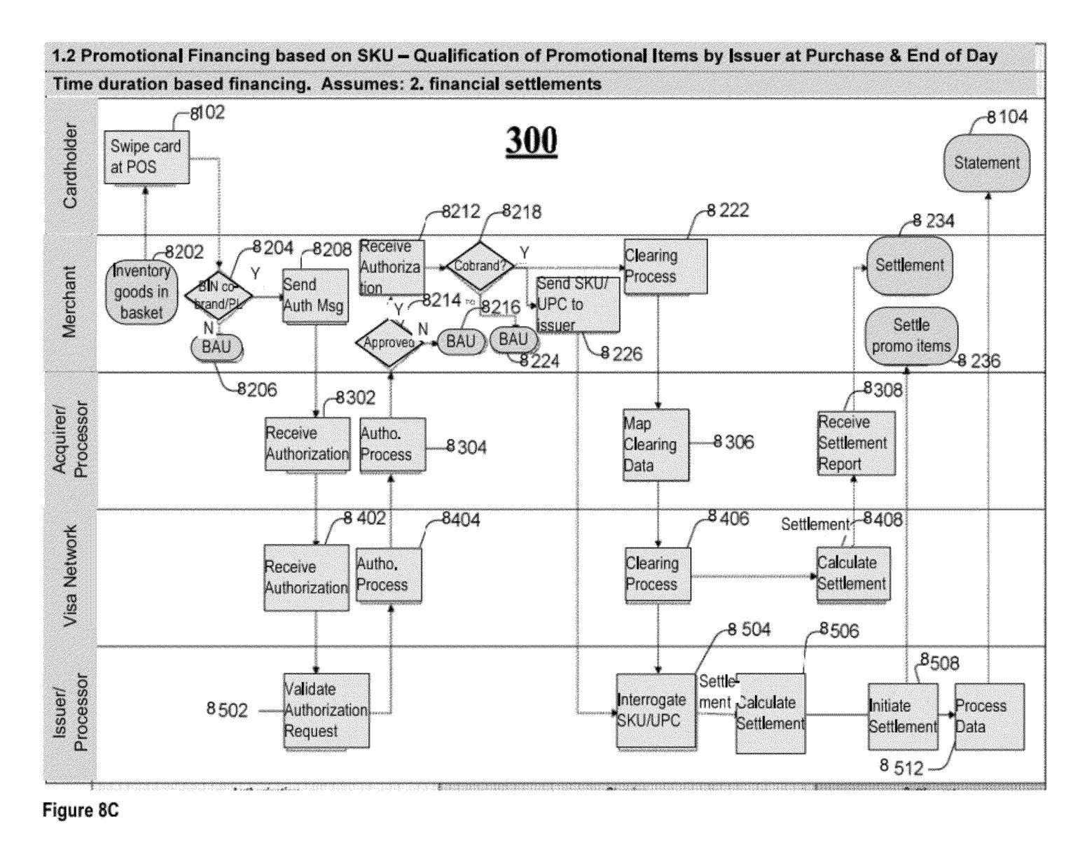

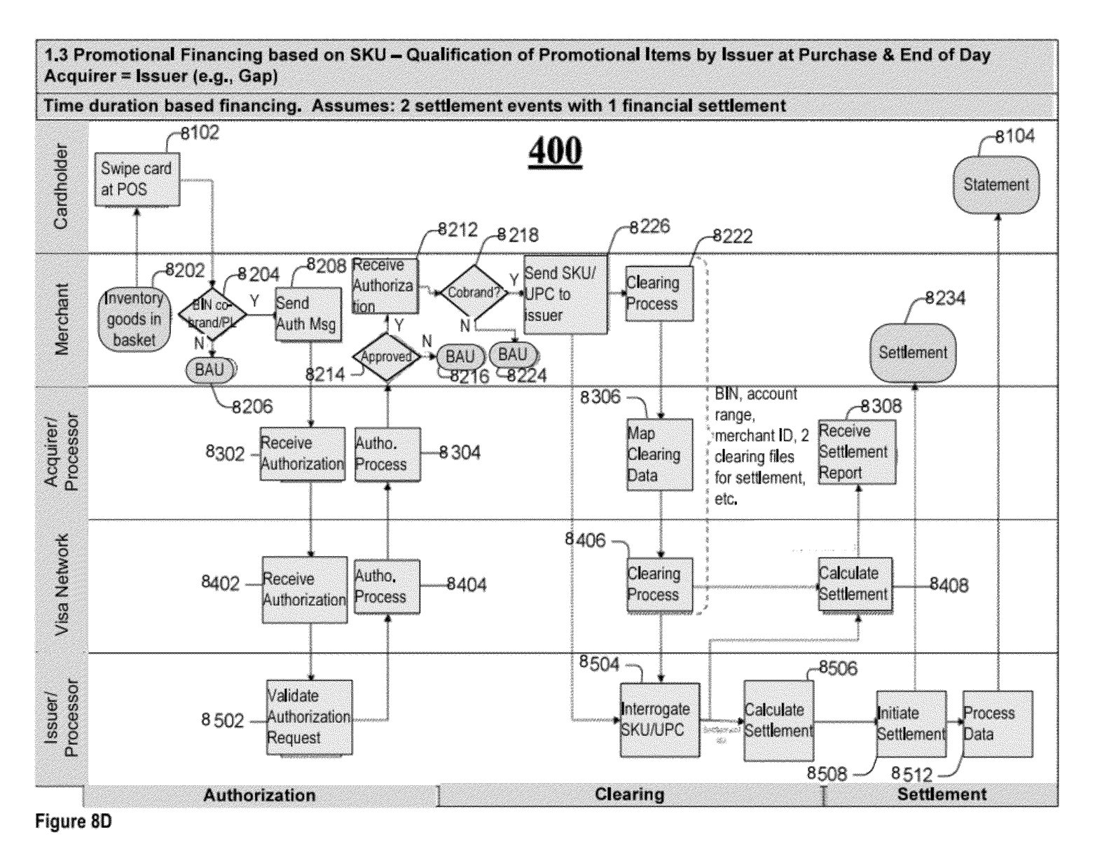

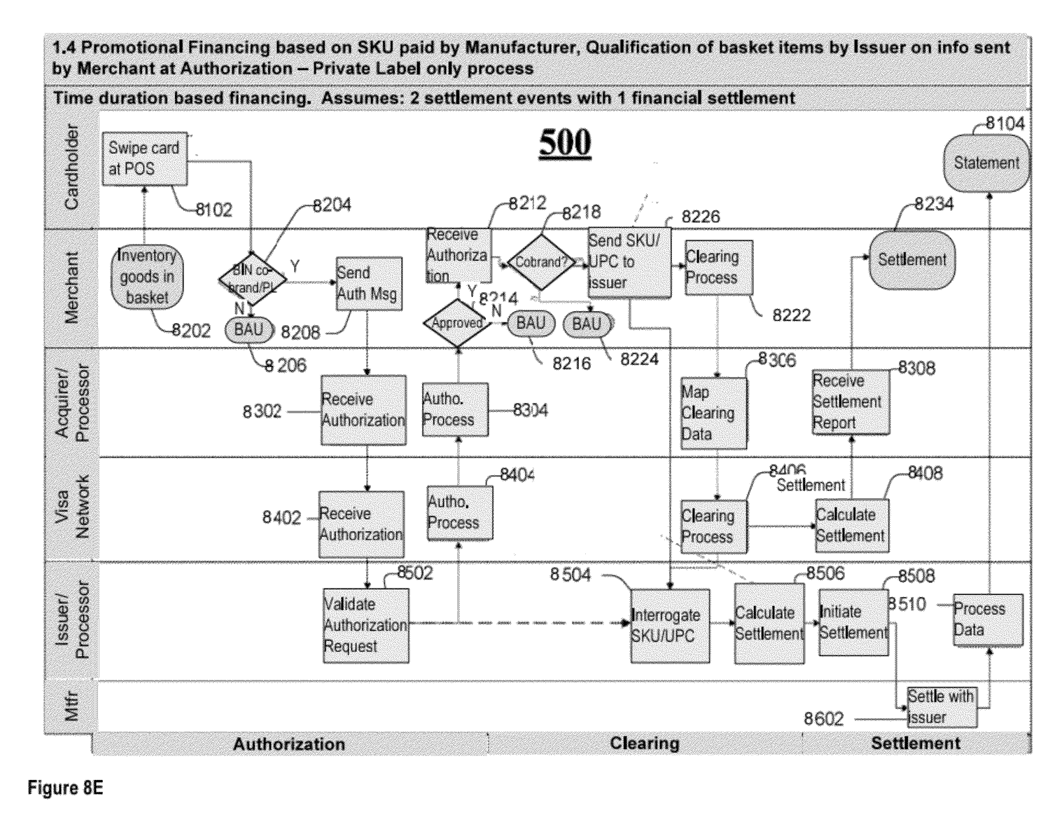

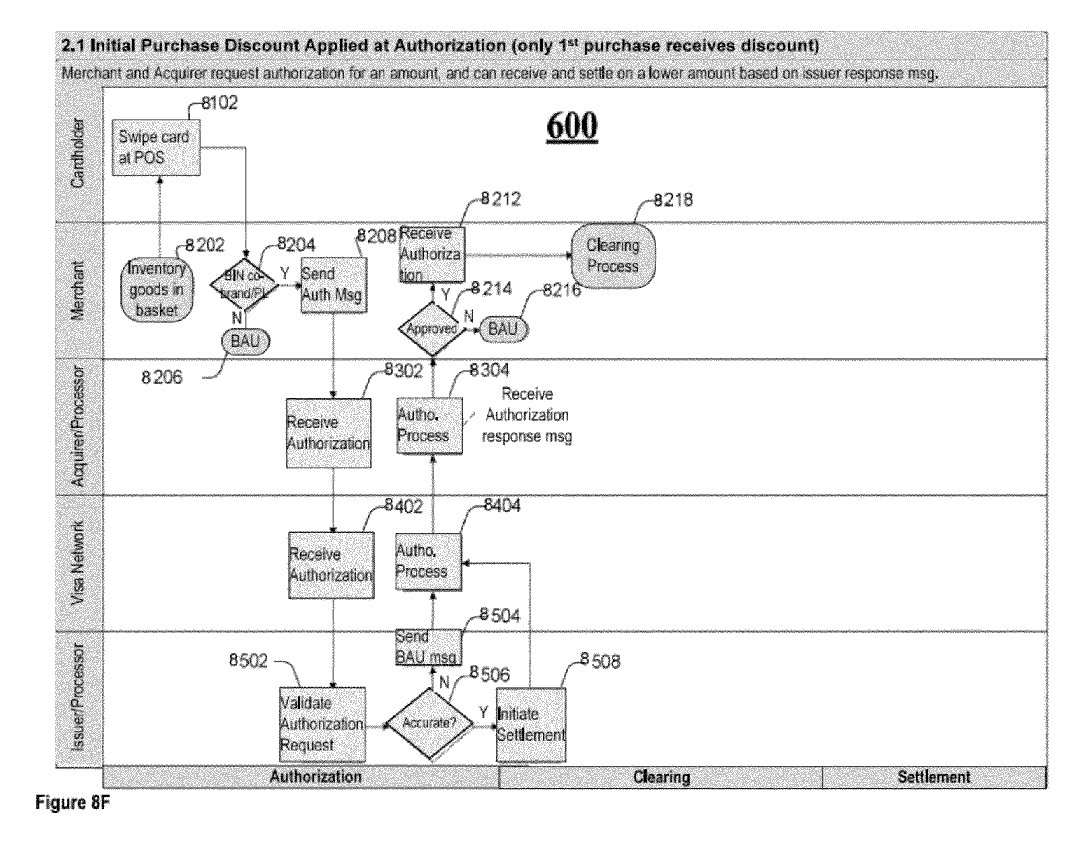

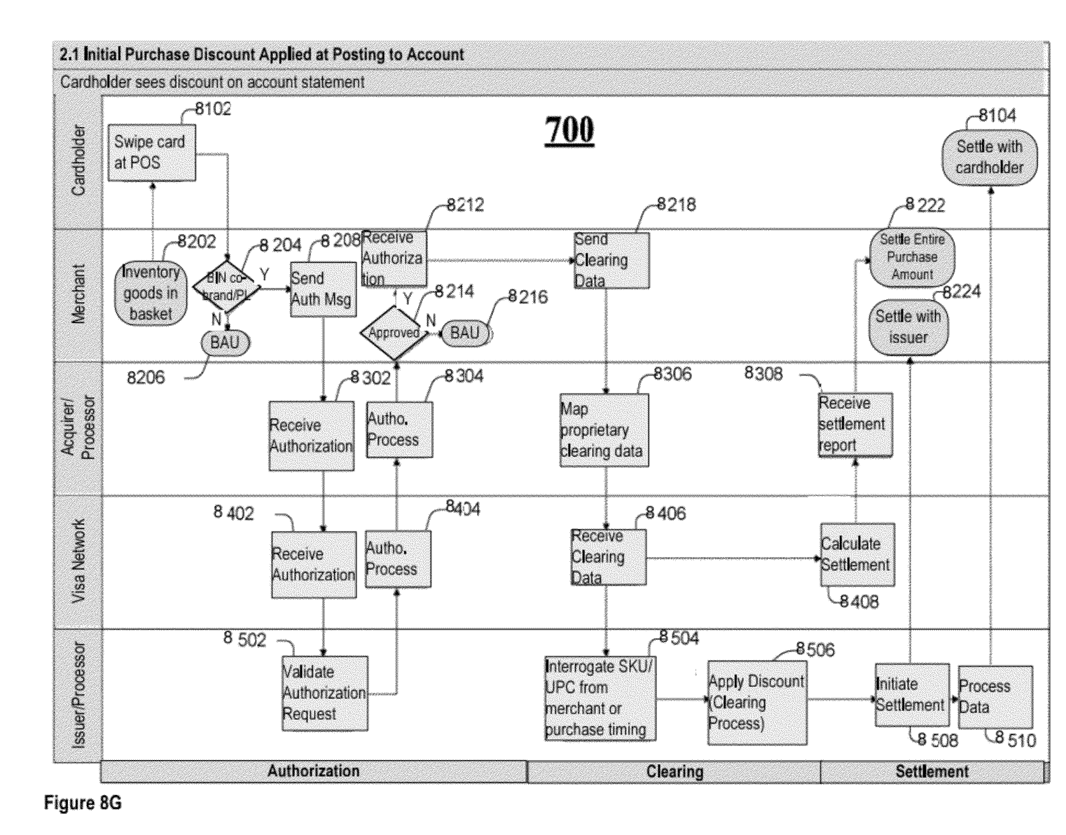

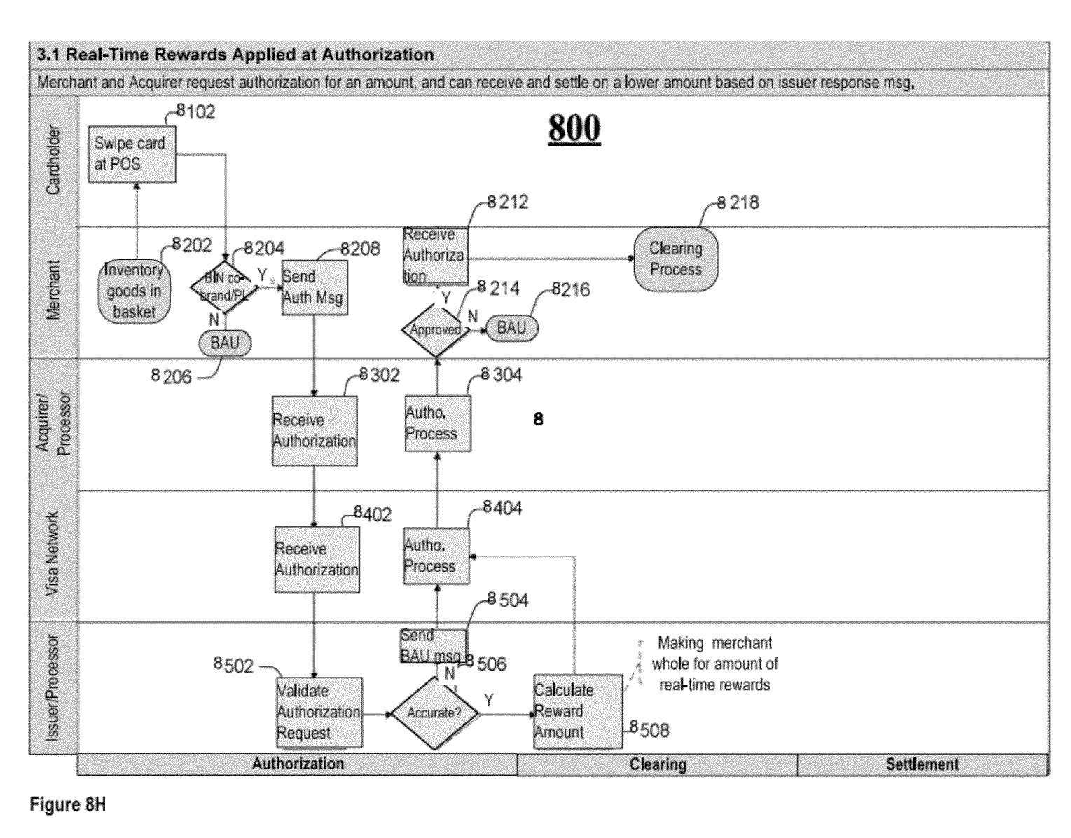

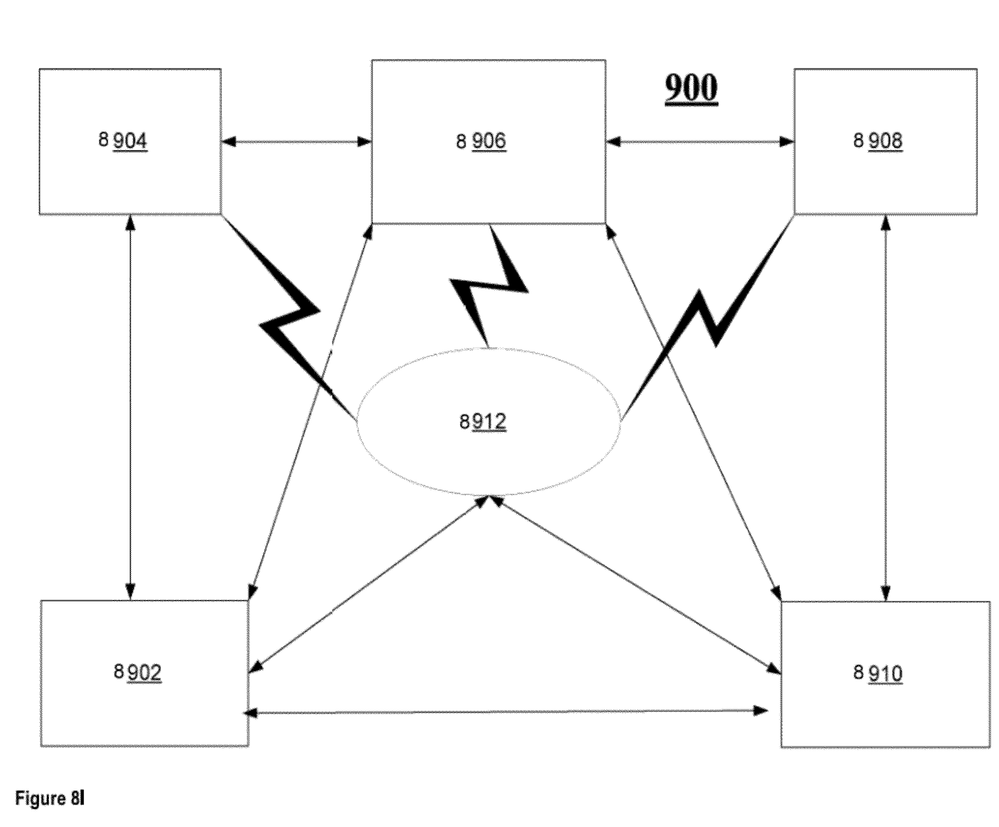

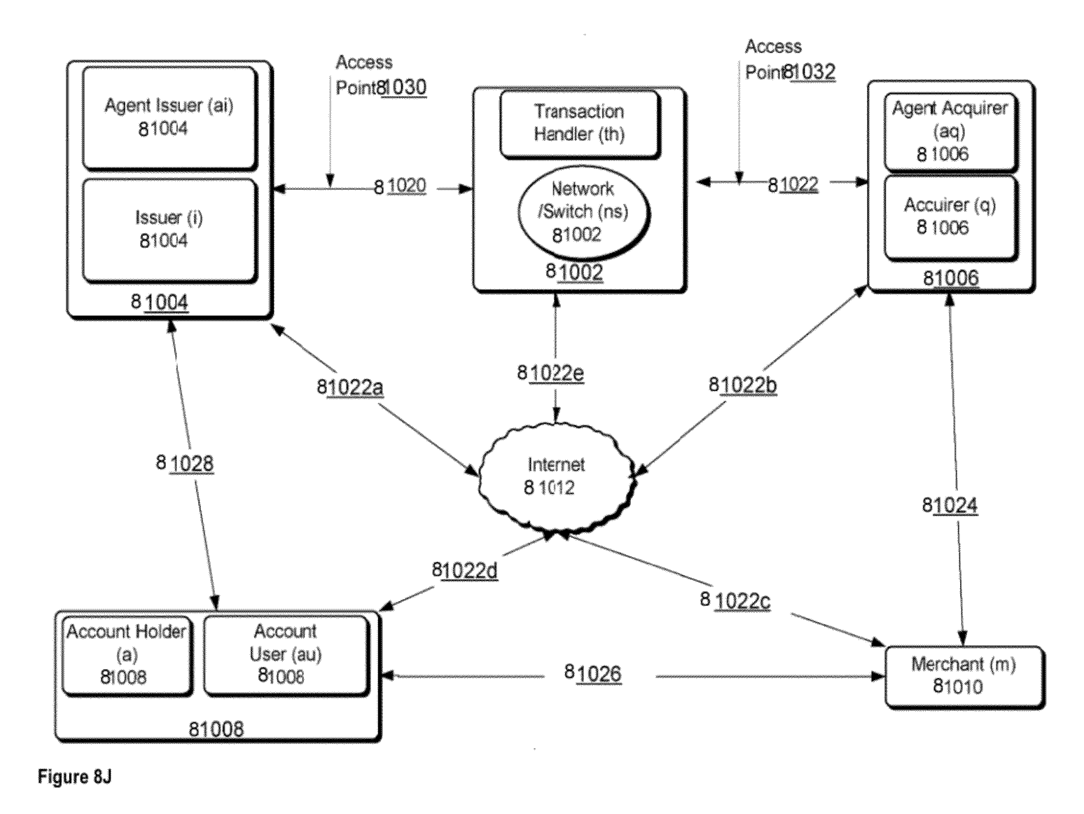

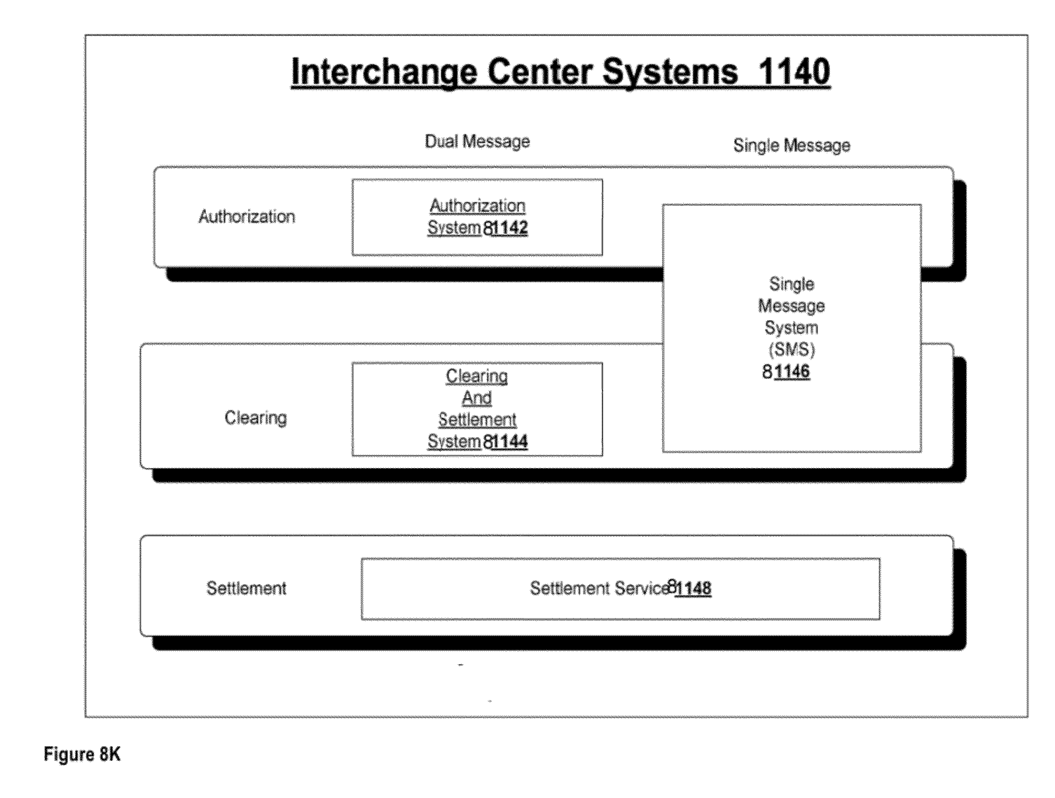

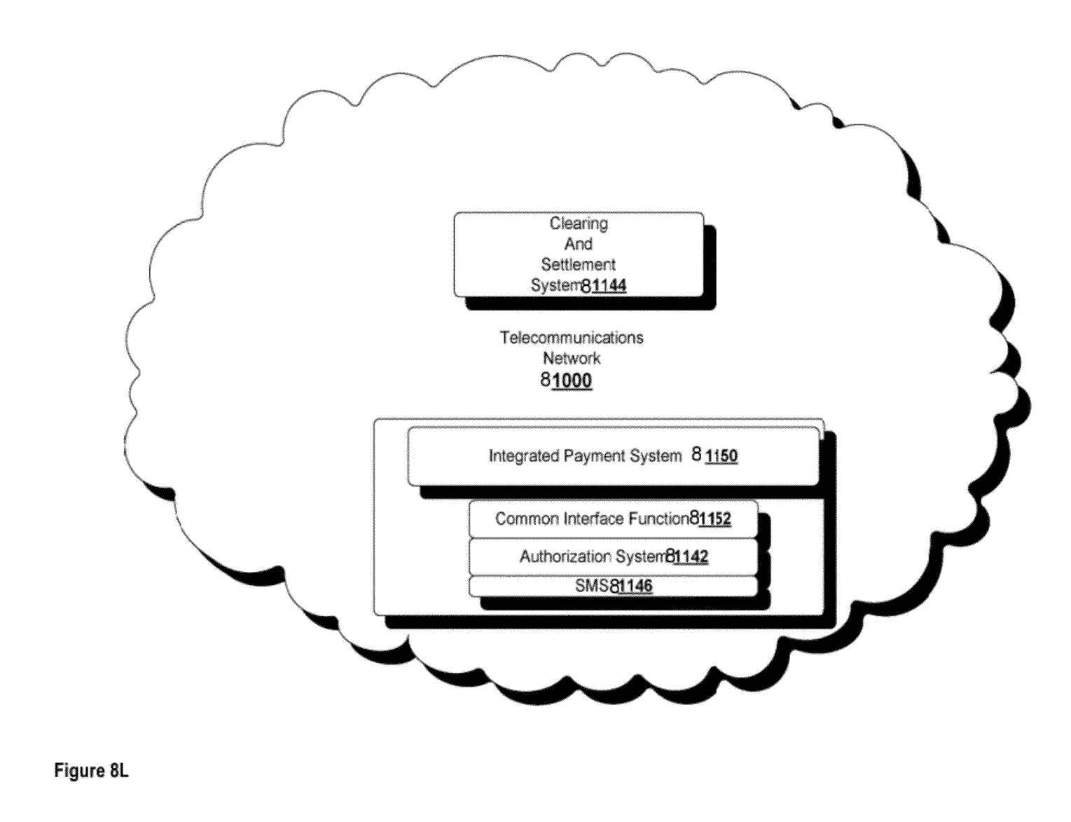

Referring now to FIG. 8A, an exemplary process 100, labeled ‘1.0 File Transport: Promotional Financing by SKU’, shows an open loop work flow depicted by ‘swim lanes’, where each swim lane reflects processes conducted by an entity, namely the cardholder, the merchant, the Acquirer/Processor; the Transaction Handler (e.g.; Visa Network); and the Issuer/Processor).

In FIG. 8A, a SKU/UPC data is optionally transmitted from the merchant to other swim lanes. For instance, the Issuer gets information about an item being purchased in a transaction that is to be awarded promotional financing (i.e., ‘2-10, net 30’; special promotion financing terms such as ‘90 Days same as cash’ or ‘No interest until the end of the year’, etc). FIG. 8A shows how such a transaction, which may have otherwise been conducted in an issuer or merchant based closed loop, can be conducted in an open loop network. Note that more loyalty can be built up with each of additional parties in the open loop system, whereas the acquirer and issuer are the same in a closed loop.

In FIG. 8A, there is depicted a flowchart illustrating an exemplary process 100 depicting three (3) different options for transaction data transmission for transmitting a Stock Keeping Unit (SKU) or Universal Product Code (UPC): data file transfers from a Merchant to an Issuer.

The Merchant Step in FIG. 8A is: 8202: Transmit the Stock Keeping Unit (SKU) or Universal Product Code (UPC) data file (Includes Transaction ID, Dollar Amount, Account Number, and all Item Level Details).

The Acquirer/Processor Steps in FIG. 8A are 8302: Option 1: Receive file from Merchant and initiate file transfer over Visa Network Switch Direct Exchange (Visa DEX) protocols via the Visa Network.

The Transaction Handler (i.e. Visa Network) Step in FIG. 8A is: 8402: Option 2: Receive SKU/UPC data from Merchant and transmit to Issuer.

The Issuer/Processor Steps in FIG. 8A are: 8502: Option 1: Receive file transfer via Visa DEX network; and 504: Option 2: Receive SKU/UPC data from Visa; 506: Option 3: Receive SKU/UPC data from Merchant.

Implementations With Communications Directly Between Merchant and Issuer Offering Promotional Financing.

In one implementation, a method can be performed by hardware executing software. The method is conducted at a merchant who receives information for a transaction for a purchase of a promotion item and a non-promotional item. The information includes an identifier for: (i) an account issued by an issuer to the accountholder for the transaction which is being conducted on the account between the merchant and the accountholder; and (ii) the promotional item. The account is limited to be used for transactions with the merchant and no other. The merchant sends an authorization request for the transaction for delivery to the issuer through a communication path through an acquirer and a transaction handler before the delivery to the issuer. The merchant receives back an authorization response to the authorization request from the acquirer. The merchant also sends, in a transmission directly from the merchant to the issuer, a promotional item settlement request that includes: (i) the identifier for the promotional item; (ii) the identifier for the account; and (iii) an identifier for the transaction. After receiving the authorization request and sending the promotional item settlement request, the merchant sends a transaction clearing request for the transaction for delivery to the issuer through a communication path through the acquirer and the transaction handler before the delivery to the issuer. The merchant the received a promotional item clearing response to the promotional item settlement request. The promotional item clearing response includes settlement information corresponding to promotional financing from the issuer to the accountholder that is derived from the identifier for the promotional item. The merchant also receives from the acquirer a transaction clearing response to the transaction settlement request.

In one alternative, the issuer can be acquirer. In another alternative, the authorization response can include an indicator that the transaction is the first such transaction conducted on the account. If so, then the authorization request and the authorization response can include different amounts for the transaction, where the difference between the respective amounts in the authorization request and the authorization response can be based upon either or both of the transaction being the first such transaction conducted on the account and the identifier for the promotional item. In yet another alternative, the transaction can be processing for authorization, clearing and settlement in an open loop system. As such the transaction handler can respectively receive and send a plurality of other such authorization requests and other such authorization responses, where each are for other such transactions conducted on respective other such account, and where each of the other accounts can be used to conduct transactions with more than such one merchant, but with different merchants.

In general, FIGS. 2-6 are exemplary of the above implementation in which there are communications directly between a merchant and an issuer offering promotional financing. FIG. 2 depicts at 1.1 a flowchart illustrating an exemplary process 200 for determining promotional financing (time duration based financing) based upon the SKU of an item in a transaction, where the qualification of the promotional item is performed by the merchant within the transaction and at the end of the day, where process 200 assumes two (2) financial settlements. FIG. 2 can apply to Co-brand or Private Label promotional financing of purchases and also to special merchant discounting based on individual product/items purchased.

The merchant can perform the qualification of the financing promotion by communicating the promotional financing information using a special field in a message for the transaction called a ‘Multiple Clearing Sequence Number’ (MCSN) field. A merchant or acquirer can, based on the private label or co-brand issuer Bank Identification Number (BIN), interrogate the contents of a shopping basket to determine if there are any items present that qualify for a promotion. If so, the merchant would indicate that determination in a transmitted message that the transaction contains a promotional item in the shopping basket. To do so, the merchant populates a special value (“promotional code”) in specified fields of the Visa authorization, and/or clearing and settlement records. Additionally (or alternatively), the merchant/acquirer can create a clearing record for the promotional item, separate from the rest of the items purchased, to allow for special issuer handling of the qualified promotional item, associating both clearing items together using the MCSN field.

Alternatively, if not using the MCSN field, the issuer can match the incoming transactions from the Transaction Handler (i.e., Visa Network) with the shopping basket line

item detail sent separately from the merchant. The issuer interrogates product/SKU level data and calculates the merchant discount. The Issuer processes the appropriate promotional terms to the cardholder's purchase.

FIG. 8B shows the option of the merchant qualifying with separate clearing messages or by separately identifying the items where the merchant has knowledge of those items that have promotional financing. As such FIG. 8B depicts at 1.1 a flowchart illustrating an exemplary process 200 for determining promotional financing (time duration based financing) based upon the SKU of an item in a transaction, where the qualification of the promotional item is performed by the merchant within the transaction and at the end of the day, and where process 200 assumes two (2) financial settlements.

The Cardholder Step in FIG. 8B is: 102: Swipe card at POS (Authorization Process); 8104: Statement to cardholder (Settlement Process).

The Merchant Steps in FIG. 8B are: 8202: Inventory goods in basket (Authorization Process); 8204: Is Bank Identification Number (BIN) co-brand or Private Label (PL)? (Authorization Process); 8206: No—Business As Usual (‘BAU’), meaning the ordinary transaction processing procedures are followed (Authorization Process); 8208: Yes—Evaluate SKU/UPC against promo database (Authorization Process); 8212: Send Authorization request message for purchase total; 8216: Is authorization approved?; 8214: Yes—Receive authorization response message & complete purchase; 8218: Is BIN Co-brand or PL? (Clearing Process); 8224: No—BAU (Authorization Process); 8222: Is item promotional? (Clearing Process); 8226: No—BAU (Clearing Process); 8228: Yes—Denote promo items and send clearing data to Acquirer (Clearing Process); 8234: (Or—Break out promo items separately and send clearing data to Acquirer) (Clearing Process); 8232: Send SKU/UPC to Issuer (include transaction ID and card #) (Clearing Process); 8236: Settle entire purchase amount with Acquirer (Settlement Process); and 8238: Settle promo items with Issuer (Settlement Process).

The Acquirer/Processor Steps in FIG. 8B are: 8302: Receive authorization request message & send to Visa (Authorization Process); 8304: Receive authorization response message and send to merchant (Authorization Process); 8306: Map proprietary clearing data into Visa clearing item(s) and send to Visa (Clearing Process); and 8308: Receive settlement report, calculate discounts and send to Merchant (Settlement Process).

The Transaction Handler (i.e., Visa Network) Steps in FIG. 8B are: 8402: Receive authorization request message and send to Issuer (Authorization Process); 8404: Receive authorization response message and send to Acquirer (Authorization Process); and 8406: Receive clearing data and send to Issuer (Clearing Process); 8408: Calculate settlement between Acquirer and Issuer; provide reporting; send wire (This is the first settlement).

The Issuer/Processor Steps in FIG. 8B are: 8502: Validate authorization request message and send authorization response message (Authorization Process); 8504: Interrogate contents of SKU/UPC file or individual clearing items (Clearing Process); 8506: Calculate settlement for promo items (Clearing Process); 8508: Initiate settlement for promo items (Settlement Process); and 8512: Process data for Cardholder statement (This is the second settlement) (Settlement Process).

FIG. 8C depicts at 1.2 a flowchart illustrating an exemplary process 300 for determining promotional financing (time duration based financing) based upon the SKU of an item in a transaction, where the qualification of the promotional item is performed by the Issuer of the account upon which the transaction is conducted and is determined at the end of the day, and where process 300 assumes two (2) financial settlements.

The Cardholder Step in FIG. 8C is: 8102: Swipe card at POS; 8104: Statement to cardholder (Settlement Process).

The Merchant Steps in FIG. 8C are: 8202: Inventory goods in basket (Authorization Process); 8204: Is BIN co-brand or PL? (Authorization Process); 8208: Yes—Send Authorization request message for purchase total (Authorization Process); 8206: No—BAU (Authorization Process); 8214: Is authorization approved? (Authorization Process); 8212: Yes—Receive authorization response message and complete purchase (Authorization Process); 8216: No—BAU (Authorization Process); 8218: Is BIN Co-brand or PL? (Clearing Process); 8226: Yes—Send SKU/UPC to issuer (include transaction ID and card #) (Clearing Process); 8224: No—BAU; 8222: Send clearing data to Acquirer (Clearing Process); 8234: Settle entire purchase amount with Acquirer (Settlement Process); and 8236: Settle promo items with Issuer (Settlement Process). The Acquirer/Processor Steps in FIG. 8C are: 8302: Receive authorization request message and send to Visa (Authorization Process); 8304: Receive authorization response message to send to Merchant (Authorization Process); 8306: Map proprietary clearing data from Merchant into Visa Clearing item(s) and send to Visa (Clearing Process); and 8308: Receive settlement report, calculate discounts and send to Merchant (Settlement Process). The Transaction Handler (i.e., Visa Network) Steps in FIG. 8C are: 8402: Receive authorization request message & send to issuer (Authorization Process); 8404: Receive authorization response message and send to Acquirer (Authorization Process); 8406: Receive clearing data and send to Issuer (Clearing Process); 8408: Calculate settlement bet Acquirer and Issuer; provide reporting; send wire (This is the first settlement) (Settlement Process).

The Issuer/Processor Steps in FIG. 8C are: 8502: Validate authorization request message and send authorization response message (Authorization Process); 8504: Interrogate contents of SKU/UPC from Merchant, qualify items by SKU and perform any (Clearing Process); Special merchant settlement; 8506: Calculate settlement for promo items (This is the second settlement) (Clearing Process); 8508: Initiate settlement for promo items (Settlement Process); and 8512: Process data for Cardholder statement (Settlement Process).

FIG. 8D depicts at 1.3 a flowchart illustrating an exemplary process 400 for determining promotional financing (time duration based financing) based upon the SKU of an item in a transaction, where the qualification of the promotional item is performed by the Issuer of the account upon which the transaction is conducted and is determined at the end of the day, and where process 400 assumes two (2) settlement events only one (1) of which is a financial settlement, and where the acquirer and the issuer are the same entity, such as a private label merchant (e.g., The Gap clothing store).

In FIG. 8D, at step 222, labeled “Send 1 or 2 clearing files to Acquirer”, is a reference to the merchant's and acquirer's complexity for data handling to use existing relations (non-in-store with just 1 file, or 2 different files), where the use of 1 file is traditional for an open system transaction, whereas the other separate files are an in-store transaction for which there can be multiple and different acquirers for each of these 2 different and separate files. Note also that the

Merchant transmits, at step 8226, to the issuer all information about the transaction in one (1) of the work flows.

The Cardholder Steps in FIG. 8D are: 8102: Swipe card at POS (Authorization Process); and 104: Statement to cardholder (Settlement Process).

The Merchant Steps in FIG. 8D are: 8202: Inventory goods in basket (Authorization Process); 8204: Is BIN Co-brand or PL? (Authorization Process); 8208: Yes—Send Authorization request message for purchase total (Authorization Process); 206: No—BAU (Authorization Process); 8214: Is authorization approved? (Authorization Process); 8212: Yes—Receive authorization response message and complete purchase (Authorization Process); 8216: No—BAU (Authorization Process); 8218: Is BIN Co-Brand or PL? (Clearing Process); 226: Yes—Send SKU/UPC to issuer (include transaction ID and card #), or if 1 SKU/UPC, Then can send in clearing (Clearing Process); 8224: No—BAU (Clearing Process); 222: Send 1 or 2 clearing files to Acquirer (Clearing Process); and 8234: Settle promo items with Issuer (Settlement Process). The Acquirer/Processor Steps in FIG. 8D are: 8302: Receive Authorization request message and send to Visa (Authorization Process); 8304: Receive Authorization response message and send to Merchant (Authorization Process); 8306: Map proprietary clearing data from

Merchant into Visa clearing item(s) and send to Visa; (Note: Steps 8222, 8206 and 8406 are based on BIN, Account Range, or Merchant ID, 2 clearing files for settlement purposes are created at one of these 3 processes: 1) Acquirer & Issuer; 2) BAU)); and 8308: Receive settlement report (Settlement Process). The Transaction Handler (i.e., Visa Network) Steps in FIG. 8D are: 8402: Receive authorization request message & send to Issuer (Authorization Process); 8404: Receive authorization response message and send to Acquirer (Authorization Process); 8406: Receive clearing data and send to Issuer; 8408: Calculate settlement between Acquirer & Issuer; provide reporting; send wire (This is the first settlement Nets to zero (e.g. GE/Gap flow)) (Settlement Process).

The Issuer/Processor Steps in FIG. 8D are: 8502: Validate authorization request message and send authorization response message (Authorization Process); 8504: Interrogate contents of SKU/UPC from Merchant, qualify items by SKU and perform any Special merchant settlement (This is the second settlement); 8506: Calculate settlement for promo items; 8508: Initiate settlement for promo items (Settlement Process); and 8512: Process data for cardholder statement (Settlement Process).

FIG. 8E depicts at 1.4 a flowchart illustrating an exemplary process 500 for determining promotional financing (time duration based financing) based upon the SKU of an item in a transaction, where the promotional financing is sponsored by the manufacturer of the item being financed, where the qualification of the item for the promotional financing is performed by the Issuer of the account upon which the transaction is conducted, where the qualification is based upon information sent by the Merchant to the Issuer at the time of the Authorization Process, and where process 500 assumes two (2) settlements.

Process 500 is predicted on the Merchant having a way for the Cardholder to apply for a line of credit with the Manufacturer's Issuer (the Issuer who issues an account to the Manufacturer of the item being purchased in a transaction by the Cardholder with the Merchant, where the transaction is conduced on that issued account). Once the account is assigned by the Manufacturer's Issuer, then the purchase can occur. Usually, there is only one (i) item being purchased by the Cardholder in the transaction, namely the item made by the Manufacturer. The Merchant is ‘made whole’ for the full value of the purchase, and the Issuer collects the “Merchant Discount” from the Manufacturer.

In Process 500, the Merchant/Acquirer initiates authorization with an UPC/SKU in an authorization message that is switched through the Transaction Handler (i.e., Visa Net) to the Issuer who validates a line of credit used only for the manufacturer's good. The merchant/acquirer has the ability to submit the UPC/SKU in a clearing message. Settlement takes place in a Business As Usual (BAU) process through the Transaction Handler (i.e., Visa Net). The issuer settles outside of the Transaction Handler (i.e., Visa Net) with manufacturer.

Rather than opening a private label account with a line of credit at the POS such that an open system credit or debit account would not be needed, process 500 can be a pre-paid credit line where the consumer offers a payment device to a merchant who knows that the consumer is buying an item that can have promotional financing. The card holder experience is to pay at the POS with any account or even cash. The consumer conducts a transaction with the merchant to buy an item. The transaction is conducted on the account issued to the consumer. If only one of two items being purchased has promotional financing (i.e., a washing machine has promotional financing but a candy bar doesn't), then there can be two (2) different transactions that are conducted: The interrogation identifies the item with the promotional financing where the data is with the issuer-processor who sees the SKU/UPC. The manufacturer of the promotional item might only be contacted at settlement in order to get the manufacturer to pay back the merchant so as to make the merchant whole for the discounting done by the merchant. The ‘participating’ merchants should have a relationship with an acquirer.

The Cardholder Steps in FIG. 8E are: 8102: Enter account number at POS (could have application process but no card Issued at POS) (Authorization Process); and 8104: Statement to cardholder (Settlement Process). The Merchant Steps in FIG. 8E are: 8202: Inventory goods in basket (Authorization Process); 8204: Is BIN PL? (Authorization Process); 8208: Yes—Send authorization request message and SKU/UPC in the message (Authorization Process); 8206: No—BAU (Authorization Process); 214: Is authorization approved? 8212: Yes—Receive authorization response message and complete purchase; 8224: No—BAU (Clearing Process); 8218: Is BIN PL? (Clearing Process); 8222: Yes—Send SKU/UPC to Issuer (include transaction ID and an identifier for the account—e.g.; card #number). One (1) or two (2) clearing files can be sent to the Acquirer. If one (1) clearing file is sent to the Acquirer, then the SKU/UPC can be sent in the clearing file data (i.e.; the UPC can be sent: (i) in either the promo description area of the clearing item since there's likely few specific UPCs; or (ii) the merchant can send a separate file) (Clearing Process); 8226: No—BAU (Clearing Process); 8232: Send clearing data to Acquirer (Clearing Process); and 8234: Settlement of the entire purchase amount with Acquirer (Settlement Process).

The Acquirer/Processor Steps in FIG. 8E are: 8302: Receive authorization request message and send to Visa with SKU/UPC in field 8104 of Visa Message (Authorization Process); 8304: Receive Authorization response message and send to Merchant (Authorization Process); 8306: Map proprietary clearing data from Merchant into Visa clearing item(s) and send to the Transaction Handler (i.e., Visa (Clearing Process)); and 8308: Receive settlement report, calculate discounts and send to Merchant (Settlement Process). The Transaction Handler (i.e., Visa Network) Steps in FIG. 8E are: 8402: Receive Authorization request message and send to Issuer (Authorization Process); 8404: Receive

Authorization response message to send to Acquirer (Authorization Process); 8406: Receive clearing data and send to issuer (Clearing Process); and 8408: Calculate settlement between Acquirer and issuer; provide reporting; send wire. (Settlement Process). The Issuer/Processor Steps in FIG. 8E are: 8502: Validate Authorization request message, validate and record SKU, then send authorization response message (This will usually require that the SKU/UPC t be included within the authorization message as a line of credit that is only good for the manufacturer's product (e.g. specific DVD, TV over $500, etc.)) (Authorization Process); 504: Interrogate contents of SKU/UPC from Merchant, qualify items by SKU to perform any Special manufacturer settlement (Clearing Process); 8506: Calculate fee to charge manufacturer (Clearing Process); 8508: Initiate Settlement to manufacturer for fees (This is the second settlement Process); and 8510: Process data for Cardholder statement (Settlement Process).

The Manufacturer (Promotion Sponsor) Step in FIG. 8E is 8602: Settle with Issuer for manufacturer paid discounts (Settlement Process). FIG. 8F at 2.1 labeled “Initial Purchase Discount at Authorization” depicts a flowchart illustrating an exemplary process 600 for determining a promotional discount that applies at the time that an item is purchased in a transaction, where the discount is applied in the Authorization Process, where the discount is only applied to a qualifying event (for instance, for only the first (1st) purchase using an account), and where the Merchant and the Acquirer request authorization for the purchase amount of the item and can receive and settlement a lower amount based upon a response given by the Issuer in the Authorization Process.2.1. Here, upon identification of the qualifying event, the issuer gives an instant discount where a merchant and an acquirer initiate an authorization request for the full purchase amount, indicating that the POS has the capability to settle an amount less than the amount in the authorization request. The issuer receives the authorization request message and interrogates its system to determine there has been no previous purchase on the account. If there is no previous purchase, using a unique response code, the issuer replies with an authorization response message containing an amount less than the requested amount, discounted as needed (10% off, 20% off, etc). The POS recognizes this unique response code, creates an appropriate receipt, and creates a settlement record for the approved amount.

The Cardholder Step in FIG. 8F is 8102: Swipe card at POS (Authorization Process). The Merchant Steps in FIG. 8F are 8202: Inventory goods in basket (Authorization Process); 8204: Is BIN Co-brand or PL? (Authorization Process); 8208: Yes—Send authorization request message for purchase total (Authorization Process); 8206: No—BAU (Authorization Process); 8214: Is authorization approved? (Authorization Process); 8212: Yes—Receive authorization response message and complete purchase (Authorization Process); 8216: No—BAU (Authorization Process); and 8218: BAU: send clearing data to acquirer (Clearing Process). The Acquirer/Processor Steps in FIG. 8F are 8302: Receive authorization request message and send to the Transaction Handler (i.e., Visa Network) (Authorization Process); and 8304: Receive authorization response message and send to Merchant (Response code 10=partial authorization).

The Transaction Handler (i.e., Visa Network) Steps in FIG. 8F are: 8402: Receive authorization request message and send to Issuer (Authorization Process); and 8404: Receive authorization response message and send to acquirer (Authorization Process). The Issuer/Processor Steps in FIG. 8F are: 8502: Validate authorization request (Authorization Process); 8506: Is this the first time that a purchase is being made with this card account? (Authorization Process); 8508: Yes—Calculate initial purchase discount, respond with adjusted amount (Authorization Process); and 8504: No—Send BAU authorization response message (Authorization Process).

Note that all of the Steps 8102 through 8508 are within the Authorization Process except for step 8218 which is within the Clearing Process. Implementations With Different Transaction Amounts in the Authorization Request and Response.

In one implementation, a method can be performed by hardware executing software. The method is conducted at a transaction hander who receives an authorization request for a transaction from a merchant's acquirer. The transaction is conducted between the merchant and an accountholder on an account issued by an issuer to the accountholder. The account is a private label account that can only be used to conduct transactions with the merchant. The authorization request includes an amount for the transaction. The transaction handler sends the authorization request for delivery to the issuer and received back an authorization response that includes an amount different than the amount for the transaction. The transaction handler then send the authorization response to the merchant's acquirer. In this implementation, the issuer can be the acquirer.

After the authorization response is sent to the acquirer, the transaction handler can facilitated clearing and settlement of the transaction on the account between the issuer and the merchant's acquirer for the amount in the authorization response.

In one alternative, The authorization response for the transaction that is received and sent by the transaction handler can include an indicator from the issuer that the transaction is the first such transaction that is conducted on the account. If so, then the difference between the amounts in the authorization request and the authorization response can be based upon a promotion as determined from the indicator from the issuer that the transaction is the first said transaction conducted on the account. As such, the promotion is given to the accountholder as an incentive to begin using the account with the merchant.

In another alternative, the authorization request for the transaction received and sent by the transaction handler can include an identifier for a item being purchased by the accountholder from the merchant. If so, then the difference between the amounts in the authorization request and the authorization response can be based upon a promotion for the item as determined from the identifier for the item being purchased by the accountholder from the merchant. As such, a price difference is given to the accountholder because of their purchase of the item.

The transaction can be processed for authorization, clearing and settlement in an open loop system. As such, in addition to handling transactions on private label accounts, the transaction handler can also receive and send a plurality of other such authorization requests; and other such authorization responses each of which can be for other such transactions. Each other such transaction can be conducted on a respective other such account, and each such account can be used at any of a number of different merchants—not just one merchant as in the case of a private label account.

In general, FIGS. 8G-8H are exemplary of the above implementation where there are different transaction amounts in the authorization request and the authorization response.

FIG. 8G at 2.2 labeled “Initial Purchase Discount at Posting” depicts a flowchart illustrating an exemplary process 700 for determining a promotional discount for an item purchased by a Cardholder in a transaction with a Merchant, where the discount is not applied at the time of purchase but is applied as a statement credit to the account of the account holder (cardholder) whose account was used to conduct the transaction with the Merchant.

Process 700 reflects that there is no impact to the authorization process, or to the clearing and settlement process. The issuer, when posting to the account, recognizes a qualifying event (e.g., the first purchase) and makes the necessary adjustments for the initial purchase discount. This does not involve the transaction Handler (i.e., Visa Network), where the activities at posting is BAU.

The Cardholder Steps in FIG. 8G are: 8102: Swipe card at POS (Authorization Process); and 8104: Statement to cardholder (Settlement Process).

The Merchant Steps in FIG. 8G are: 8202: Inventory goods in basket (Authorization Process); 8204: Is BIN Co-brand or PL? (Authorization Process); 8208: Yes—Send authorization request message for purchase total (Authorization Process); 8206: No—BAU (Authorization Process); 8214: Is authorization approved? (Authorization Process); 8212: Yes—receive authorization response message and complete purchase (Authorization Process); 8216: No—BAU (Authorization Process); 8218: Send Clearing data to acquirer (Clearing Process); 8222: Settle entire purchase amount with acquirer (Settlement Process); and 8224: Settle with issuer (Settlement Process).

The Acquirer/Processor Steps in FIG. 8G are: 8302: Receive authorization request message and send to Transaction Handler (i.e., Visa); 8304: Receive authorization response message and send to Merchant; 8306: Map proprietary clearing data from Merchant into Visa clearing item(s) and send to Visa (Clearing Process); and 8308: Receive settlement report, calculate discounts & send to merchant (Settlement Process.

The Transaction Handler (i.e., Visa Network) Steps in FIG. 8G are 8402: Receive authorization request message and send to issuer; 8404: Receive authorization response message and send to acquirer; 8406: Receive clearing data and send to issuer (Clearing Process); and 8408: Calculate settlement between Acquirer and Issuer: provide reporting; send wire (this is the first settlement) (Settlement Process).

The Issuer/Processor Steps in FIG. 8G are: 8502: Validate authorization request message and send authorization response message; 8504: Interrogate contents of SKU/UPC from merchant or purchase timing characteristic. Qualify and perform any special merchant settlement (this is the second settlement) (Clearing Process); 8506: If this is a promotion and/or the first time that the account is used in a purchase, then apply discount (Clearing Process); 8508: Initiate settlement (Settlement Process); and 8540: Process data for cardholder statement (Settlement Process). FIG. 8H at 3.1, labeled “Real Time Rewards at Authorization”, depicts a flowchart illustrating an exemplary process 80o for determining a promotional reward to a Cardholder who purchases an item in a transaction with a Merchant upon the account of the Cardholder, where the reward is received by the Cardholder at the time of the transaction, and where the Merchant and the Acquirer request authorization for an amount for the purchase of the item and can receive and settle for a lower amount based upon a response that is received from the Issuer during the Authorization Process. Note that all of the Steps 8102 through 8508 are within the Authorization Process except for step 218 which is within the Clearing Process.

Process 800 is an implementation of an open loop transaction in which part of the transaction is conducted with multiple parties. The merchant rings up the total basket, the transaction goes through the system and then the issuer identifies in the transaction authorization response message information about the promotion having been applied. There are two (2) options: (1st Option) an information item is printed on the consumer's receipt, such as “You got $10 off” where the issuer pays for the discount but tells the cardholder about the discount; or (2nd Option) the issuer modifies the transaction amount itself by the percentage and the issuer returns a value that the merchant will settle that reflects the discount, so the difference is who is paying for the discount.

A merchant and an acquirer initiate an authorization request for the full purchase amount, indicating POS capability to settle an amount less than the amount in the authorization request. (The merchant and acquirer could also include a value to indicate a particular reward; or could also include the SKU.) The issuer receives the authorization request message and determines if the transaction qualifies for an instant POS reward. If the transaction qualifies, the issuer replies with an adjusted amount in the authorization response message and includes a specialized response code to indicate an approval for less than the requested amount. The POS recognizes the reduced approval amount and creates a clearing item for the approved amount.

Compensating the merchant for the instant POS reward is determined by the merchant and the issuer. The reward happens at authorization in Process 800, where the SKU is captured at the POS by the merchant and is included in a message to the issuer-processor (real time and/or authorization). Process 800 looks at what was purchased to apply an additional modification in the form of a discount by an item (level III, product level data, SKU, UPC). The Cardholder Step in FIG. 8H is 8102: Swipe card at POS. The Merchant Steps in FIG. 8H are 8202: Inventory goods in basket; 8204: Is Bank Identification Number (BIN) a Co-branded number or a Private Label (PL) number?; 8208: Yes—send authorization request message for purchase total; 8206: No—BAU; 8214: Is authorization approved?; 8212: Yes—receive authorization and complete purchase; and 8216: No—BAU; 8218: BAU: send clearing data to acquirer (Clearing Process). The Acquirer/Processor Steps in FIG. 8H are 8302: Receive authorization request message and send to the Transaction Handler (i.e., Visa Network); and 8304: Receive authorization response message to send to merchant (Need to consider if there needs to be a specialized approval response code to convey that approved amount is different than requested amount). The Transaction Hander (i.e., Visa Network) Steps in FIG. 8H are 8402: Receive authorization request message and send to Issuer; and 404: Receive authorization response message and send to Acquirer.

The Issuer/Processor Steps in FIG. 8H are 8502: Validate authorization request; 8506: Does account qualify for real-time reward? (Assumes: issuer runs and maintains real-time rewards engine); 8508: Yes—Calculate reward discount, respond with adjusted amount (making merchant whole for amount of real-time reward (instant discount) as between merchant and issuer); and 8504: No—Send authorization response message.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings.

Exemplary Payment Processing System. FIG. 8I illustrates an exemplary payment processing system, depicting the general environment for conducting a transaction on an account. In general, a transaction includes participation from different entities that are a component of a payment processing system 900, including an account holder 8908 (e.g.; the consumer associated with the account), a transaction handler 8902, such as a credit card company, an acquirer 8106, a merchant 8910, and an issuer 8904. Acquirer 8906 and issuer 8904 can communicate through transaction handler 8902. Merchant 8910 may be a person or entity that sells goods or services. Merchant 8910 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder 8908 may be a second merchant making a purchase from another merchant 8910. Merchant 8910 may utilize at least one point-of-sale terminal (POS) that can communicate with acquirer 8906, transaction handler 8902, or issuer 8904. Thus, the POS terminal is in operative communication with the payment processing system 900.

Typically, a transaction begins with account holder 8908 presenting a portable consumer device to merchant 8910 to initiate an exchange for a good or service. The portable consumer

device may be associated with account information stored in an account database 8912, accessible by issuer 8904, transaction handler 8902, and/or acquirer 8906. The portable consumer device may include a payment card, a gift card, a smartcard, a smart media, a payroll card, a healthcare card, a wrist band, a machine readable medium containing account information, a keychain device, such as a SPEEDPAS S® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder's name. Merchant 8910 may use the POS terminal to obtain account information, such as an account number, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 8904 of the portable consumer device. Alternatively, or in combination, the portable consumer device may communicate with issuer 8904, transaction handler 8902, or acquirer 8906.

Issuer 8904 may authorize the transaction using transaction handler 8902. Transaction handler 8902 may also clear the transaction. Authorization includes issuer 8904, or transaction handler 8902 on behalf of issuer 8904, authorizing the transaction in connection with issuer 8904's instructions such as through the use of business rules. The business rules could include instructions or guidelines from transaction handler 8902, account holder 8908, merchant 8910, acquirer 8906, issuer 8904, a financial institution, or combinations thereof. Transaction handler 8902 may maintain a log or history of authorized transactions. Once approved, merchant 8910 will record the authorization, allowing account holder 8908 to receive the good or service.

Merchant 8910 may, at discrete periods, such as the end of the day, submit a list of authorized transactions to acquirer 8906 or other components of the payment processing system 900. Transaction handler 8902 may compare the submitted authorized transaction list with its own log of authorized transactions. If a match is found, transaction handler 8902 may route authorization transaction amount requests from the corresponding acquirer 8906 to the corresponding issuer 8904 involved in each transaction. Once acquirer 8906 receives the payment of the authorized transaction amount from issuer 8904, it can forward the payment to merchant 8910 less any transaction costs, such as fees. If the transaction involves a debit or pre-paid card, acquirer 8906 may choose not to wait for the initial payment prior to paying merchant 8910.

There may be intermittent steps in the foregoing process, some of which may occur simultaneously. For example, acquirer 8906 can initiate the clearing and settling process, which can result in payment to acquirer 8906 for the amount of the transaction. Acquirer 8906 may request from transaction handler 8902 that the transaction be cleared and settled. Clearing includes the exchange of financial information between the issuer 8904 and the acquirer 8906 and settlement includes the exchange of funds. Transaction handler 8902 can provide services in connection with settlement of the transaction. The settlement of a transaction includes depositing an amount of the transaction settlement from a settlement house, such as a settlement bank, which transaction handler 8902 typically chooses, into a clearinghouse, such as a clearing bank, that acquirer 8906 typically chooses. Issuer 8904 deposits the same from a clearinghouse, such as a clearing bank, which issuer 8904 typically chooses, into the settlement house. Thus, a typical transaction involves various entities to request, authorize, and fulfill processing the transaction.

Referring to FIG. 8J, a transaction processing system 1000 is seen. The general environment of FIG. 8J include that of a merchant (m) 81010, such as the merchant, who can conduct a transaction for goods and/or services with an account user (au) (e.g., consumer) on an account issued to an account holder (a) 81008 by an issuer (i) 81004, where the processes of paying and being paid for the transaction are coordinated by at least one transaction handler (th) 81002 (e.g., the transaction handler) (collectively “users”). The transaction includes participation from different entities that are each a component of the transaction processing system 81000.

The transaction processing system 81000 may have at least one of a plurality of transaction handlers (th) 81002 that includes transaction handler (1) 81002 through transaction handler (TH) 81002, where TH can be up to and greater than an eight digit integer.

The transaction processing system 1000o has a plurality of merchants (m) 81010 that includes merchant (1) 81010 through merchant (M) 81010, where M can be up to and greater than an eight digit integer. Merchant (m) 81010 may be a person or entity that sells goods and/or services. Merchant (m) 81010 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 81008 may be a second merchant (m) 81010 making a purchase from another merchant (m) 81010.

Transaction processing system 1000 includes account user (1) 81008 through account user (AU) 81008, where AU can be as large as a ten digit integer or larger. Each account user (au) conducts a transaction with merchant (m) 81010 for goods and/or services using the account that

has been issued by an issuer (i) 81004 to a corresponding account holder (a) 81008. Data from the transaction on the account is collected by the merchant (m) 81010 and forwarded to a corresponding acquirer (a) 81006. Acquirer (a) 81006 forwards the data to transaction handler (th) 81002 who facilitates payment for the transaction from the account issued by the issuer (i) 81004 to account holder (a) 81008.

Transaction processing system 1000 has a plurality of acquirers (q) 81006. Each acquirer (q) 81006 may be assisted in processing one or more transactions by a corresponding agent acquirer (aq) 81006, where ‘q’ can be an integer from 1 to Q, where aq can be an integer from 1 to AQ, and where Q and AQ can be as large as a eight digit integer or larger. Each acquirer (q) 81006 may be assisted in processing one or more transactions by a corresponding agent acquirer (aq) 81006, where ‘q’ can be an integer from 1 to Q, where aq can be an integer from 1 to AQ, and where Q and AQ can be as large as a eight digit integer or larger.

The transaction handler (th) 81002 may process a plurality of transactions within the transaction processing system 1000. The transaction handler (th) 81002 can include one or a plurality or networks and switches (ns) 81002. Each network/switch (ns) 81002 can be a mainframe computer in a geographic location different than each other network/switch (ns) 81002, where ‘ns’ is an integer from one to NS, and where NS can be as large as a four digit integer or larger.

Dedicated communication systems 81020, 81022 (e.g., private communication network(s)) facilitate communication between the transaction handler (th) 81002 and each issuer (i) 81004 and each acquirer (a) 81006. A Network 81012, via e-mail, the World Wide Web, cellular telephony, and/or other optionally public and private communications systems, can facilitate communications 81022a-81022e among and between each issuer (i) 81004, each acquirer (a) 81006, each merchant (m) 81010, each account holder (a) 81008, and the transaction handler (th) 81002. Alternatively and optionally, one or more dedicated communication systems 81024, 81026, and 81028 can facilitate respective communications between each acquirer (a) 81006 and each merchant (m) 81010, each merchant (m) and each account holder (a) 81008, and each account holder (a) 81008 and each issuer (i) 81004, respectively.

The Network 81012 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 81012 may contain either or both wired and wireless connections for the transmission of signals including electrical, magnetic, and a combination thereof. Examples of such connections

are known in the art and include: radio frequency connections, optical connections, etc. To illustrate, the connection for the transmission of signals may be a telephone link, a Digital Subscriber Line, or cable link. Moreover, network 81012 may utilize any of a variety of communication protocols, such as Transmission Control Protocol/Internet Protocol (TCP/IP), for example. There may be multiple nodes within the network 81012, each of which may conduct some level of processing on the data transmitted within the transaction processing system 1000.

Users of the transaction processing system 1000 may interact with one another or receive data about one another within the transaction processing system 1000 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 1000 by the account holder (a) 1008 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDP ASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a nonvolatile, a read only, or a programmable memory that stores data, such as an account identifier, a consumer identifier, and/or an expiration date. The computer readable medium may including executable instructions that, when executed by a computer, the computer will perform a method.

For example, the computer readable memory may include information such as the account number or an account holder (a) 81008's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 81010 may utilize at least one POI terminal (e.g., Point of Service or browser enabled consumer cellular telephone); that can communicate with the account user (au) 81008, the acquirer (a) 81006, the transaction handler (th) 81002, or the issuer (i) 81004. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 81010 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 1000.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 81010. These data can include an account identifier of a healthcare account. In another example, the POI may be the PCD of the consumer, such as the cellular telephone of the consumer, where the merchant (m) 81010, or an agent thereof, receives the account identifier of the consumer via a webpage of an interactive website rendered by a browser executing on a World Wide Web (Web) enabled PCD.

Typically, a transaction begins with account user (au) 81008 presenting the portable consumer device to the merchant (m) 81010 to initiate an exchange for resources (e.g., a good or service). The portable consumer device may be associated with an account (e.g., a credit account) of account holder (a) 81008 that was issued to the account holder (a) 81008 by issuer (i) 81004.

Merchant (m) 81010 may use the POI terminal to obtain account information, such as a number of the account of the account holder (a) 81008, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 81004 of the account associated with the PCD. Alternatively, or in combination, the PCD may communicate with issuer (i) 81004, transaction handler (th) 81002, or acquirer (a) 81006.

Issuer (i) 81004 may authorize the transaction and forward same to the transaction handler (th) 81002. Transaction handler (th) 81002 may also clear the transaction. Authorization includes issuer (i) 81004, or transaction handler (th) 81002 on behalf of issuer (i) 81004, authorizing the transaction in connection with issuer (i) 81004's instructions such as through the use of business rules. The business rules could include instructions or guidelines from the transaction handler (th) 81002, the account holder (a) 81008, the merchant (m) 81010, the acquirer (a) 81006, the issuer (i) 81004, a related financial institution, or combinations thereof. The transaction handler (th) 81002 may, but need not, maintain a log or history of authorized transactions. Once approved, the merchant (m) 81010 may record the authorization, allowing the account user (au) 81008 to receive the good or service from merchant (m) or an agent thereof.

The merchant (m) 81010 may, at discrete periods, such as the end of the day, submit a list of authorized transactions to the acquirer (a) 81006 or other transaction related data for processing through the transaction processing system 1000. The transaction handler (th) 81002 may optionally compare the submitted authorized transaction list with its own log of authorized transactions. The transaction handler (th) 81002 may route authorization transaction amount requests from the corresponding the acquirer (a) 81006 to the corresponding issuer (i) 81004 involved in each transaction. Once the acquirer (a) 81006 receives the payment of the authorized transaction from the issuer (i) 81004, the acquirer (a) 81006 can forward the payment to the merchant (m) 81010 less any transaction costs, such as fees for the processing of the transaction. If the transaction involves a debit or pre-paid card, the acquirer (a) 81006 may choose not to wait for the issuer (i) 81004 to forward the payment prior to paying merchant (m) 81010.

There may be intermittent steps in the foregoing process, some of which may occur simultaneously. For example, the acquirer (a) 81006 can initiate the clearing and settling process, which can result in payment to the acquirer (a) 81006 for the amount of the transaction. The acquirer (a) 81006 may request from the transaction handler (th) 81002 that the transaction be cleared and settled. Clearing includes the exchange of financial information between the issuer (i) 81004 and the acquirer (a) 81006 and settlement includes the exchange of funds. The transaction handler (th) 81002 can provide services in connection with settlement of the transaction. The settlement of a transaction includes depositing an amount of the transaction settlement from a settlement house, such as a settlement bank, which transaction handler (th) 81002 typically chooses, into a clearinghouse bank, such as a clearing bank, that acquirer (a) 81006 typically chooses. The issuer (i) 81004 deposits the same from a clearinghouse bank, such as a clearing bank, which the issuer (i) 81004 typically chooses, into the settlement house. Thus, a typical transaction involves various entities to request, authorize, and fulfill processing the transaction. The transaction processing system 1000 will preferably have network components suitable for scaling the number and data payload size of transactions that can be authorized, cleared and settled in both real time and batch processing. These include hardware, software, data elements, and storage network devices for the same. Examples of transaction processing system 1000 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 81002 can include one or more data centers for processing transactions, where each transaction can include up to 100 kilobytes of data or more. The data corresponding to the transaction can include information about the types and quantities of goods and services in the transaction, information about the account holder (a) 81008, the account user (au) 81008, the merchant (m) 81010, tax and incentive treatment(s) of the goods and services, coupons, rebates, rewards, loyalty, discounts, returns, exchanges, cash-back transactions, etc.

By way of example, network/switch (ns) 81002 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 81004 (or agent issuer (ai) 81004 thereof) and each acquirer (a) 81006 (or agent acquirer (aq) 81006 thereof) can use or more router/switch (e.g., Cisco™ routers/switches) to communicate with each network/switch (ns) 81002 via dedicated communication systems.

FIG. 8J includes one or more transaction handlers transaction handler (th) 81002 and access points 81030, 81032. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handlers 202, 1406) to remote entities use dedicated high-bandwidth telephone circuits or satellite connections based on the IBM SNA-LUO communication protocol. Messages are sent over these lines using any suitable implementation of the ISO 8583 standard.

Access points 81030, 81032 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 81006 and its access point, and between the access point and issuer (i) 81004 are typically local links within a center and use a proprietary message format as preferred by the center. A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

Transaction handler (th) 81002 can store information about transactions processed through transaction processing system 81000 in data warehouses such as may be incorporated as part of the plurality of networks/switches 81002. This information can be data mined. The data mining

transaction research and modeling can be used for advertising, account holder and merchant loyalty incentives and rewards, fraud detection and prediction, and to develop tools to demonstrate savings and efficiencies made possible by use of the transaction processing system 1000 over paying and being paid by cash, or other traditional payment mechanisms. FIG. 8L illustrates systems 81140 housed within an interchange center to provide on-line and off-line transaction processing. For dual message transaction, authorization system 81142 provides authorization. System 81142 supports on-line and off-line functions, and its file includes internal systems tables, a customer database and a merchant central file. The on-line functions of system 81142 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 81142 to system 81146 makes it possible for members using system 81142 to communicate with members using system 81146 and access the SMS gateways to outside networks.

Clearing and settlement system 81144 clears and settles previously authorized dual message transactions. Operating six days a week on a global basis, system 81144 collects financial and non-financial information and distributes reports between members It also calculates fees, charges and settlement totals and produces reports to help with reconciliation. A bridge forms an interchange between system 81144 processing centers and system 846 processing centers.

Single message system 81146 processes full financial transactions. System 81146 can also process dual message authorization and clearing transactions, and communicates with system 81142 using a bridge and accesses outside networks as required. System 81146 processes Visa, Plus Interlink and other card transactions. The SMS files comprise internal system tables that control system access and processing, and the cardholder database, which contains files of cardholder data used for PIN verification and stand-in processing authorization. System 81146 online functions perform real-time cardholder transaction processing and exception processing for authorization as well as full financial transactions. System 81146 also accumulates reconciliation and settlement totals. System 81146 off-line functions process settlement and funds transfer requests and provide settlement and activities reporting. Settlement service 81148 consolidates the settlement functions of system 81144 and 81146, including Interlink, into a single service for all products and services. Clearing continues to be performed separately by system 81144 and system 81146.

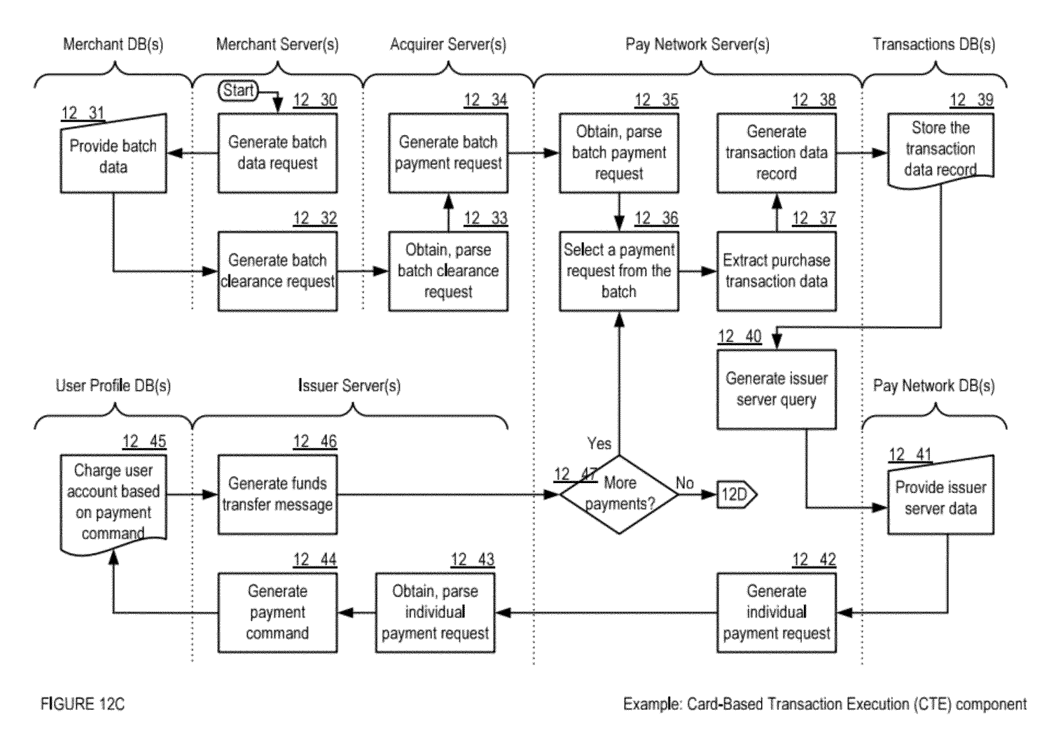

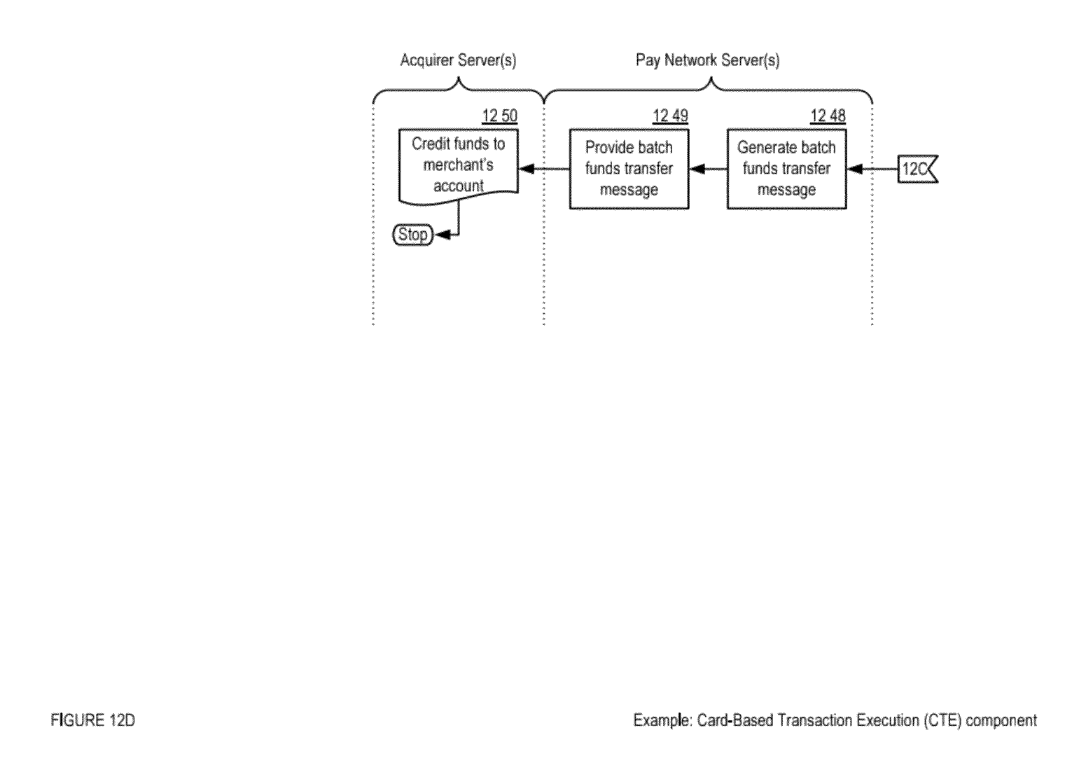

FIG. 12 illustrates another view of components of FIG. 8J as a telecommunications network 1000. Integrated payment system 81150 is the primary system for processing all on-line authorization and financial request transactions. System 81150 reports both dual message and single message processing. In both cases, settlement occurs separately. The three main software components are the common interface function 81152, authorization system 81142 and single message system 81146.

Common interface function 81152 determines the processing required for each message received at an interchange center. It chooses the appropriate routing, based on the source of the message (system 81142, 81144 or 81146), the type of processing request and the processing network. This component performs initial message editing, and, when necessary, parses the message and ensures that the content complies with basic message construction rules. Common interface function 81152 routes messages to their system 81142 or system 81146 destinations.

The VisaNet® system is an example component of the transaction handler (th) 81002 in the transaction processing system 1000. Presently, the VisaNet® system is operated in part by Visa Inc. As of 2006, the VisaNet® system Inc, was processing around 300 million transaction daily, on over 1 billion accounts used in over 170 countries. Financial instructions numbering over 16,000 connected through the VisaNet® system to around 30 million merchants (m) 610. In 2007, around 71 billion transactions for about 4 trillion U.S. dollars were cleared and settled through the VisaNet® system, some of which involved a communication length of around 24,000 miles in around two (2) seconds and during which a plurality of stops are made for processing data in the transaction.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

FIGS. 10A-D show application user interface diagrams illustrating example features of a mobile app in some embodiments of the L-PROMO. In some implementations, the app may be configured to recognize product identifiers (e.g., barcodes, QR codes, etc.). In some implementations, the user may be required to sign in to the app to enable its features. Once enabled, the camera may provide in-person one tap purchasing features for the user. For example, the client device may have a camera via which the app may acquire images, video data, streaming live video, and/or the like, e.g., 1003. The app may be configured to analyze the incoming data, and search, e.g., 1001, for a product identifier, e.g., 1004. In some implementations, the app may overlay cross-hairs, target box, and/or like alignment reference markers, e.g., 1005, so that a user may align the product identifier using the reference markers so facilitate product identifier recognition and interpretation. In some implementations, the app may include interface elements to allow the user to switch back and forth between the product identification mode and the product offer interface display screens (see, e.g., 1006), so that a user may accurately study the deals available to the user before capturing a product identifier. In some implementations, the app may provide the user with the ability to view prior product identifier captures (see, e.g., 1007) so that the user may be able to better decide which product identifier the user desires to capture. In some implementations, the user may desire to cancel product purchasing; the app may provide the user with a user interface element (e.g., 1008) to cancel the product identifier recognition procedure and return to the prior interface screen the user was utilizing. In some implementations, the user may be provided with information about products, user settings, merchants, offers, etc, in list form (see, e.g., 1009) so that the user may better understand the user's purchasing options. Various other features may be provided for in the app (see, e.g., 1010).

In some implementations, the app executing on the client device of the user may include an app interface providing various features for the user. In some implementations, the app may include an indication of the location (e.g., name of the merchant store, geographical location, information about the aisle within the merchant store, etc.) of the user, e.g., loll. The app may provide an indication of a pay amount due for the purchase of the product, e.g., 1012. In some implementations, the app may provide various options for the user to pay the amount for purchasing the product(s). For example, the app may utilize the GPS coordinates to determine the merchant store within the user is present, and direct the user to a website of the merchant. In some implementations, the L-PROMO may provide an API for participating merchants directly to facilitate transaction processing. In some implementations, a merchant-branded L-PROMO application is developed with the L-PROMO functionality, which may directly connect the user into the merchant's transaction processing system. For example, the user may choose from a number of cards (e.g., credit cards, debit cards, prepaid cards, etc.) from various card providers, e.g., 1013. In some implementations, the app may provide the user the option to pay the purchase amount using funds included in a bank account of the user, e.g., a checking, savings, money market, current account, etc., e.g., 1014. In some implementations, the user may have set default options for which card, bank account, etc, to use for the purchase transactions via the app. In some implementations, such setting of default options may allow the user to initiate the purchase transaction via a single click, tap, swipe, and/or other remedial user input action, e.g., 1015. In some implementations, when the user utilizes such an option, the app may utilize the default settings of the user to initiate the purchase transaction. In some implementations, the app may allow the user to utilize other accounts (e.g., Google™ Checkout, Paypal™ account, etc.) to pay for the purchase transaction, e.g., 1016. In some implementations, the app may allow the user to utilize rewards points, airline miles, hotel points, electronic coupons, printed coupons (e.g., by capturing the printed coupons similar to the product identifier) etc., to pay for the purchase transaction, e.g., 1017-1018. In some implementations, the app may provide an option to provide express authorization before initiating the purchase transaction, e.g., 1019. In some implementations, the app may provide progress indicator provide indication on the progress of the transaction after the user has selected an option to initiate the purchase transaction, e.g., 1020. In some implementations, the app may provide the user with historical information on the user's prior purchases via the app, e.g., 1021. In some implementations, the app may provide the user with an option to share information about the purchase (e.g., via email, SMS, wall posting on Facebook®, tweet on Twitter™, etc.) with other users, e.g., 1022. In some implementations the app may provide the user an option to display the product identification information captured by the client device (e.g., in order to show a customer service representative at the exit of a store the product information), e.g., 1024. In some implementations, the user, app, client device and or L-PROMO may encounter an error in the processing. In such scenarios, the user may be able to chat with a customer service representative (e.g., VerifyChat 1023) to resolve the difficulties in the purchase transaction procedure.

For example, in some implementations, the “VerifyChat” feature may be utilized for fraud prevention. For example, the L-PROMO may detect an unusual and/or suspicious transaction. The L-PROMO may utilize the VerifyChat feature to communicate with the user, and verify the authenticity of the originator of the purchase transaction. In various implementations, the L-PROMO may send electronic mail message, text (SMS) messages, Facebook® messages, Twitter™ tweets, text chat, voice chat, video chat (e.g., Apple FaceTime), and/or the like to communicate with the user. For example, the L-PROMO may initiate a video challenge for the user, e.g., 1025. For example, the user may need to present him/her-self via a video chat, e.g., 1026. In some implementations, a customer service representative, e.g., agent 1028b, may manually determine the authenticity of the user using the video of the user. In some implementations, the L-PROMO may utilize face, biometric and/or like recognition (e.g., using pattern classification techniques) to determine the identity of the user, e.g., 1028a. In some implementations, the app may provide reference marker (e.g., cross-hairs, target box, etc.), e.g., 1027, so that the user may the video to facilitate the L-PROMO's automated recognition of the user. In some implementations, the user may not have initiated the transaction, e.g., the transaction is fraudulent. In such implementations, the user may cancel, e.g., 1029, the challenge. The L-PROMO may then cancel the transaction, and/or initiate fraud investigation procedures on behalf of the user.

In some implementations, the user may select to conduct the transaction using a one-time anonymized credit card number, e.g., 1015b. In such implementations, the app may automatically set the user profile settings such that the any personal identifying information of the user will not be provided to the merchant and/or other entities. In one embodiment, the user may be required to enter a user name and password to enable the one-time anonymization feature.

In some implementations, the L-PROMO may utilize a text challenge procedure to verify the authenticity of the user, e.g., 1030. For example, the L-PROMO may communicate with the user via text chat, SMS messages, electronic mail, Facebook® messages, Twitter® tweets, and/or the like. The L-PROMO may pose a challenge question, e.g., 1032, for the user. The app may provide a user input interface element(s) (e.g., virtual keyboard 1033) to answer the challenge question posed by the L-PROMO. In some implementations, the challenge question may randomly selected by the L-PROMO automatically; in some implementations, a customer service representative may manually communicate with the user. In some implementations, the user may not have initiated the transaction, e.g., the transaction is fraudulent. In such implementations, the user may cancel, e.g., 1031, the text challenge. The L-PROMO may then cancel the transaction, and/or initiate fraud investigation procedures on behalf of the user.

In some implementations, the user may be able to view and/or modify the user profile and/or settings of the user, e.g., by activating user interface element 1009 (see FIG. 10A). For example, the user may be able to view/modify a user name (e.g., 1035a-b), account number (e.g., 1036a-b), user security access code (e.g., 1037a-b), user pin (e.g., 1038a-b), user address (e.g., 1039a-b), social security number associated with the user (e.g., 1040a-b), current device GPS location (e.g., 1041a-b), user account of the merchant in whose store the user currently is (e.g., 1042a-b), the user's rewards accounts (e.g., 1043a-b), and/or the like. In some implementations, the user may be able to select which of the data fields and their associated values should be transmitted to facilitate the purchase transaction. For example, in the example illustration in FIG. 10D, the user has selected the name 1035a, account number 1036a, security code 1037a, merchant account ID 1042a and rewards account ID 1043a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the L-PROMO with the GPS location of the user. Based on the GPS location of the user, the L-PROMO may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

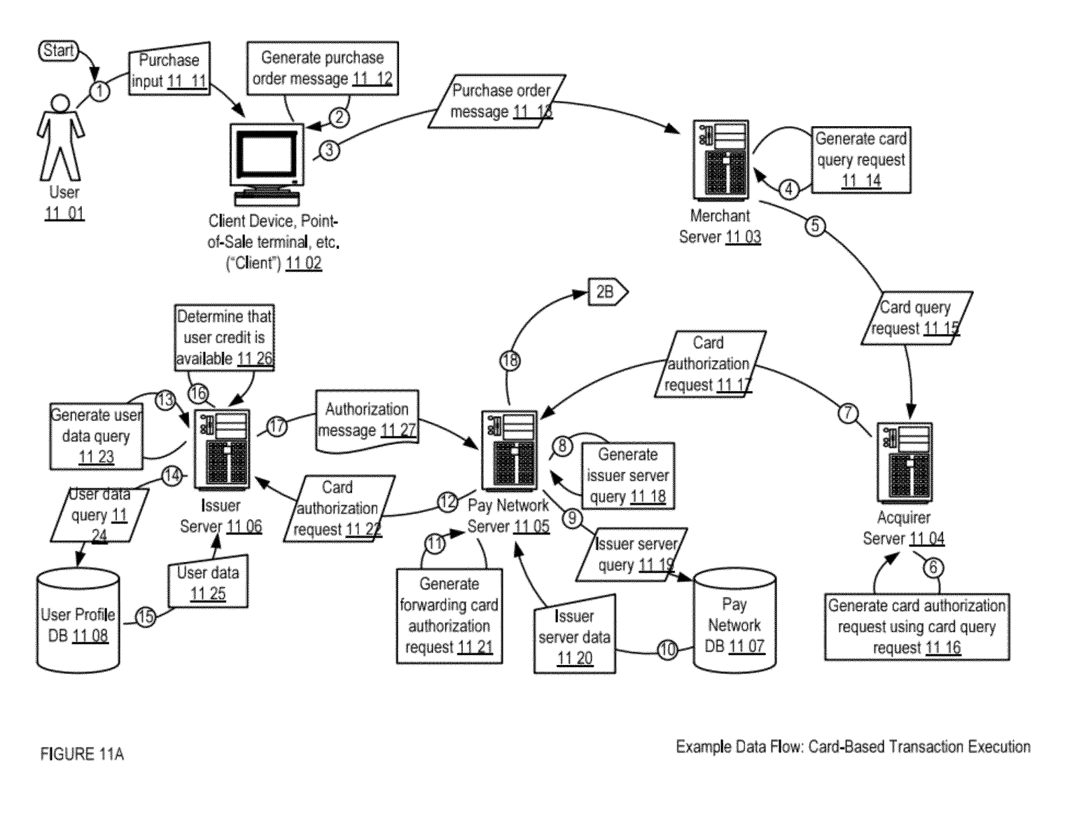

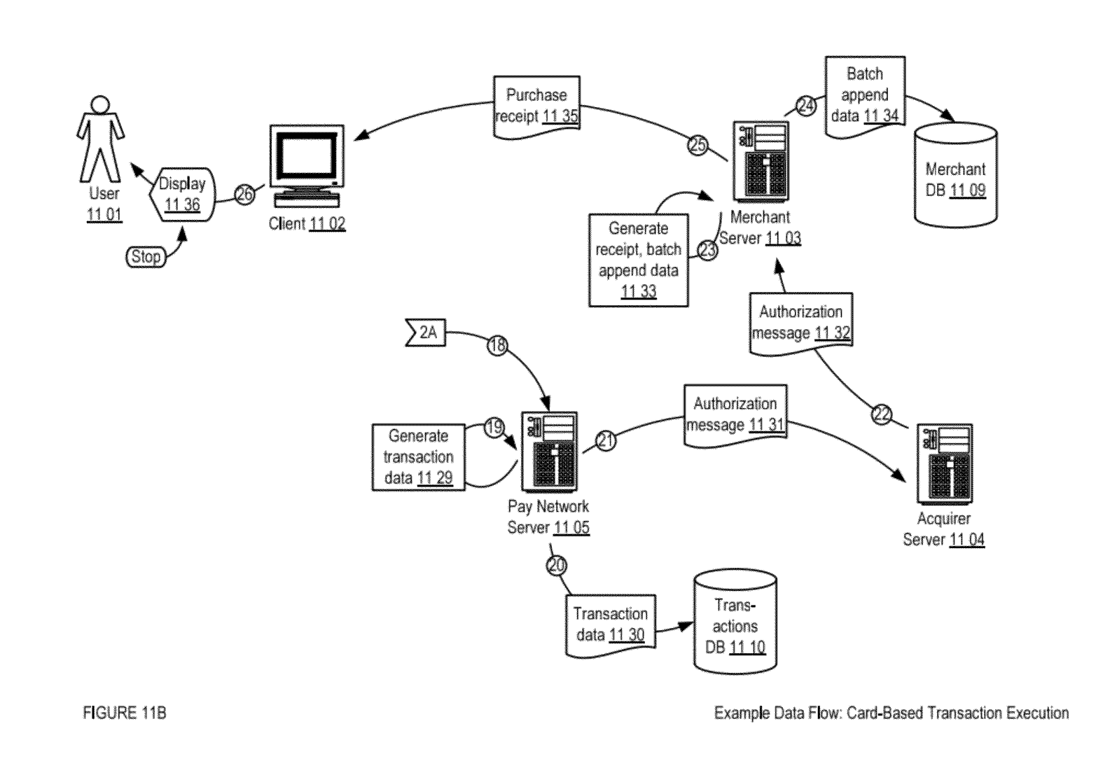

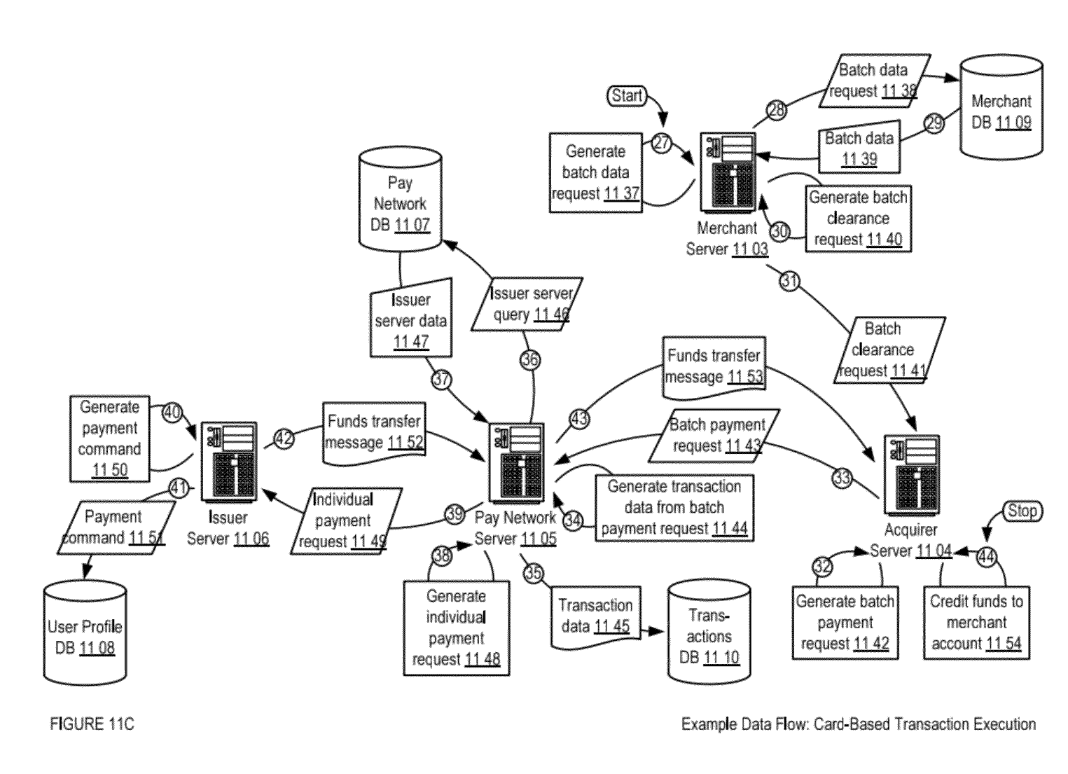

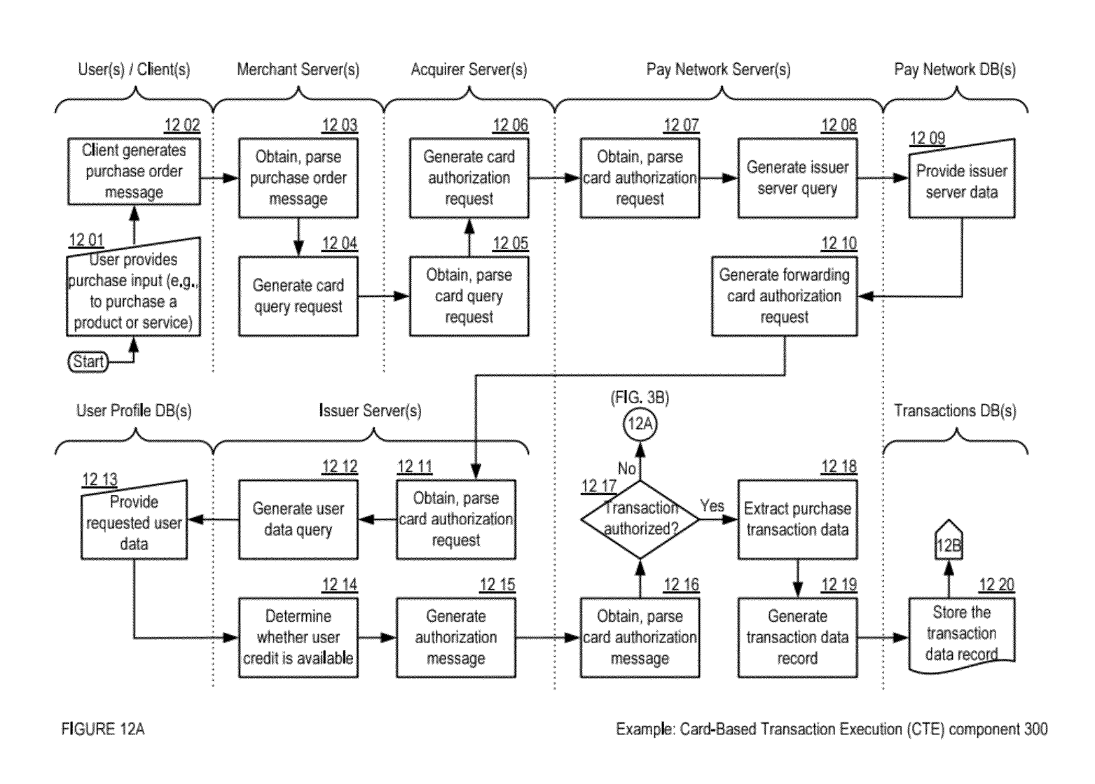

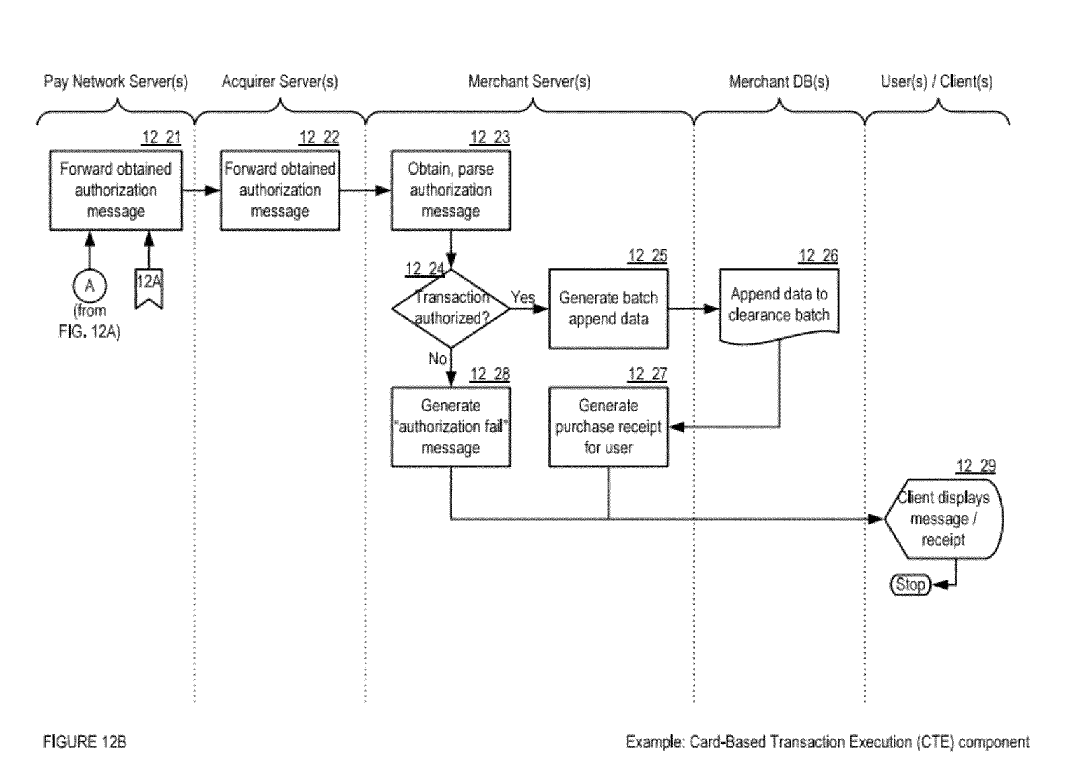

FIGS. 11A-C show data flow diagrams illustrating an example procedure to execute a card-based transaction resulting in raw card-based transaction data in some embodiments of the EISA. In some implementations, a user, e.g., 1101, may desire to purchase a product, service, offering, and/or the like (“product”), from a merchant. The user may communicate with a merchant server, e.g., 1103, via a client such as, but not limited to: a personal computer, mobile device, television, point-of-sale terminal, and/or the like (e.g., 1102). For example, the user may provide user input, e.g., purchase input 1111, into the client indicating the user's desire to purchase the product. In various implementations, the user input may include, but not be limited to: keyboard entry, mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website.

In some implementations, the client may generate a purchase order message, e.g., 1112, and provide, e.g., 1113, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

```
GET /purchase.php HTTP/1.1
Host: www.merchant.com
Content-Type: Application/XML
Content-Length: 1306
<?XML version = “1.0” encoding = “UTF-8”?>
<purchase_order>
    <order_ID>4NFU4RG94</order_ID>
    <timestamp>2011-02-22 15:22:43</timestamp>
    <user_ID>john.q.public@gmail.com</user_ID>
    <client_details>
        <client_IP>192.168.23.126</client_IP>
        <client_type>smartphone</client_type>
        <client_model>HTC Hero</client_model>
        <OS>Android 11.2</OS>
        <app_installed_flag>true</app_installed_flag>
    </client_details>
    <purchase_details>
        <num_products>1</num_products>
        <product>
            <product_type>book</product_type>
            <product_params>
                <product_title>XML for dummies</product_title>
                <ISBN>938-2-14-168710-0</ISBN>
                <edition>2nd ed.</edition>
                <cover>hardbound</cover>
                <seller>bestbuybooks</seller>
            </product_params>
            <quantity>1</quantity>
        </product>
    </purchase_details>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
        <confirm_type>email</confirm_type>
        <contact_info>john.q.public@gmail.com</contact_info>
    </account_params>
    <shipping_info>
        <shipping_adress>same as billing</shipping_address>
        <ship_type>expedited</ship_type>
        <ship_carrier>FedEx</ship_carrier>
        <ship_account>123-45-678</ship_account>
        <tracking_flag>true</tracking_flag>
        <sign_flag>false</sign_flag>
    </shipping_info>
</purchase_order>
```

In some implementations, the merchant server may obtain the purchase order message from the client, and may parse the purchase order message to extract details of the purchase order from the user. The merchant server may generate a card query request, e.g., 1114 to determine whether the transaction can be processed. For example, the merchant server may attempt to determine whether the user has sufficient funds to pay for the purchase in a card account provided with the purchase order. The merchant server may provide the generated card query request, e.g., 1115, to an acquirer server, e.g., 1104. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

```
POST /cardquery.php HTTP/1.1
Host: www.acquirer.com
Content-Type: Application/XML
Content-Length: 624
<?XML version = “1.0” encoding = “UTF-8”?>
<card_query_request>
    <query_ID>VNEI39FK</query_ID>
    <timestamp>2011-02-22 15:22:44</timestamp>
    <purchase_summary>
        <num_products>1</num_products>
        <product>
            <product_summary>Book - XML for
            dummies</product_summary>
              <product_quantity>1</product_quantity?
        </product>
    </purchase_summary>
    <transaction_cost>$34.78</transaction_cost>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
    </account_params>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
</card_query_request>
```

In some implementations, the acquirer server may generate a card authorization request, e.g., 1116, using the obtained card query request, and provide the card authorization request, e.g., 1117, to a pay network server, e.g., 1105. For example, the acquirer server may redirect the HTTP(S) POST message in the example above from the merchant server to the pay network server.

In some implementations, the pay network server may obtain the card authorization request from the acquirer server, and may parse the card authorization request to extract details of the request. Using the extracted fields and field values, the pay network server may generate a query, e.g., 1118, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 1106, of the issuer may maintain details of the user's card account. In some implementations, a database, e.g., pay network database 1107, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address auth_key port_num security_settings_list FROM
IssuerTable WHERE account_num LIKE ‘%’ $accountnum”;
$result = mysql_query($query); // perform the search query
mysql_close(“ISSUERS.SQL”); // close database access
?>

In response to obtaining the issuer server query, e.g., 1119, the pay network database may provide, e.g., 1120, the requested issuer server data to the pay network server. In some implementations, the pay network server may utilize the issuer server data to generate a forwarding card authorization request, e.g., 1121, to redirect the card authorization request from the acquirer server to the issuer server. The pay network server may provide the card authorization request, e.g., 1122, to the issuer server. In some implementations, the issuer server, e.g., 1106, may parse the card authorization request, and based on the request details may query a database, e.g., user profile database 1108, for data of the user's card account. For example, the issuer server may issue PHP/SQL commands similar to the example provided below:

<?PHP
header(‘Content-Type: text/plain’);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable WHERE account_num LIKE ‘%’ $accountnum”;
$result = mysql_query($query); // perform the search query
mysql_close(“USERS.SQL”); // close database access
?>

In some implementations, on obtaining the user data, e.g., 1125, the issuer server may determine whether the user can pay for the transaction using funds available in the account, e.g., 1126. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 1127, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record, e.g., 1129, from the card authorization request it received, and store, e.g., 1130, the details of the transaction and authorization relating to the transaction in a database, e.g., transactions database 1110. In one implementation, the generation of the transaction data record (e.g., 1129, 1130) may comprise application and/or entry of an authorized transaction value of the original price (e.g., 274 in FIG. 2B), and application and/or entry of statement credit value of a rebate amount after an offer redemption (e.g., 285 in FIG. 2B; FIG. 2C). For example, the pay network server may issue PHP/SQL commands similar to the example listing below to store the transaction data in a database:

<?PHP
header(‘Content-Type: text/plain’);
mysql_connect(″254.92.185.103”,$DBserver,$password); // access
database server
mysql_select(″TRANSACTIONS.SQL″); // select database to append
mysql_query(“INSERT INTO PurchasesTable (timestamp,
purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key)
VALUES (time( ), $purchase_summary_list, $num_products,
$product_summary, $product_quantity, $transaction_cost,
$account_params_list, $account_name, $account_type, $account_num,
$billing_addres, $zipcode, $phone, $sign, $merchant_params_list,
$merchant_id, $merchant_name, $merchant_auth_key)”); //
add data to table in database
mysql_close(″TRANSACTIONS.SQL″); // close connection to database
?>

In some implementations, the pay network server may forward the authorization message, e.g., 1131, to the acquirer server, which may in turn forward the authorization message, e.g., 1132, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1133, and store the XML data file, e.g., 1134, in a database, e.g., merchant database 1109. For example, a batch XML data file may be structured similar to the example XML data structure template provided below:

```
<?XML version = “1.0” encoding = “UTF-8”?>
<merchant_data>
    <merchant_id>3FBCR4INC</merchant_id>
    <merchant_name>Books & Things, Inc.</merchant_name>
    <merchant_auth_key>1NNF484MCP59CHB27365
    </merchant_auth_key>
    <account_number>123456789</account_number>
</merchant_data>
<transaction_data>
    <transaction 1>
        ...
    </transaction 1>
    <transaction 2>
        ...
    </transaction 2>
        .
        .
        .
    <transaction n>
        ...
    </transaction n>
</transaction_data>
```

In some implementations, the server may also generate a purchase receipt, e.g., 1133, and provide the purchase receipt to the client. The client may render and display, e.g., 1136, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 11C, in some implementations, the merchant server may initiate clearance of a batch of authorized transactions. For example, the merchant server may generate a batch data request, e.g., 1137, and provide the request, e.g., 1138, to a database, e.g., merchant database 1109. For example, the merchant server may utilize PHP/SQL commands similar to the examples provided above to query a relational database. In response to the batch data request, the database may provide the requested batch data, e.g., 1139. The server may generate a batch clearance request, e.g., 1140, using the batch data obtained from the database, and provide, e.g., 1141, the batch clearance request to an acquirer server, e.g., 1104. For example, the merchant server may provide a HTTP(S) POST message including XML-formatted batch data in the message body for the acquirer server. The acquirer server may generate, e.g., 1142, a batch payment request using the obtained batch clearance request, and provide the batch payment request to the pay network server, e.g., 1143. The pay network server may parse the batch payment request, and extract the transaction data for each transaction stored in the batch payment request, e.g., 1144. In one implementation, the generation of the transaction data record (e.g., 1144) may comprise application and/or entry of an authorized transaction value of the original price (e.g., 74 in FIG. 2B), and application and/or entry of statement credit value of a rebate amount after an offer redemption (e.g., 285 in FIG. 2B; FIG. 2C). The pay network server may store the transaction data, e.g., 1145, for each transaction in a database, e.g., transactions database 1110. For each extracted transaction, the pay network server may query, e.g., 1146, a database, e.g., pay network database 1107, for an address of an issuer server. For example, the pay network server may utilize PHP/SQL commands similar to the examples provided above. The pay network server may generate an individual payment request, e.g., 1148, for each transaction for which it has extracted transaction data, and provide the individual payment request, e.g., 1149, to the issuer server, e.g., 1106. For example, the pay network server may provide a HTTP(S) POST request similar to the example below:

```
POST /requestpay.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$34.78</pay_amount>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
    </account_params>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
    <purchase_summary>
        <num_products>1</num_products>
        <product>
            <product_summary>Book - XML for
            dummies</product_summary>
              <product_quantity>1</product_quantity?
        </product>
    </purchase_summary>
</pay_request>
```

In some implementations, the issuer server may generate a payment command, e.g., 1150. For example, the issuer server may issue a command to deduct funds from the user's account (or add a charge to the user's credit card account). The issuer server may issue a payment command, e.g., 1151, to a database storing the user's account information, e.g., user profile database 1108. The issuer server may provide a funds transfer message, e.g., 1152, to the pay network server, which may forward, e.g., 1153, the funds transfer message to the acquirer server. An example HTTP(S) POST funds transfer message is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
    <request_ID>CNI4ICNW2</request_ID>
    <clear_flag>true</clear_flag>
    <timestamp>2011-02-22 17:00:02</timestamp>
    <deposit_amount>$34.78</deposit_amount>
</deposit_ack>
```

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 1154.

FIGS. 12A-D show logic flow diagrams illustrating example aspects of executing a card-based transaction resulting in generation of raw card-based transaction data in some embodiments of the EISA, e.g., a Card-Based Transaction Execution (“CTE”) component 1200. In some implementations, a user may provide user input, e.g., 1201, into a client indicating the user's desire to purchase a product from a merchant. The client may generate a purchase order message, e.g., 1202, and provide the generated purchase order message to the merchant server. In some implementations, the merchant server may obtain, e.g., 1203, the purchase order message from the client, and may parse the purchase order message to extract details of the purchase order from the user. Example parsers that the merchant client may utilize are discussed further below with reference to FIG. 21. The merchant server may generate a card query request, e.g., 1204, to determine whether the transaction can be processed. For example, the merchant server may process the transaction only if the user has sufficient funds to pay for the purchase in a card account provided with the purchase order. The merchant server may provide the generated card query request to an acquirer server. The acquirer server may generate a card authorization request, e.g., 1206, using the obtained card query request, and provide the card authorization request to a pay network server. In some implementations, the pay network server may obtain the card authorization request from the acquirer server, and may parse the card authorization request to extract details of the request. Using the extracted fields and field values, the pay network server may generate a query, e.g., 1208, for an issuer server corresponding to the user's card account. In response to obtaining the issuer server query the pay network database may provide, e.g., 1209, the requested issuer server data to the pay network server. In some implementations, the pay network server may utilize the issuer server data to generate a forwarding card authorization request, e.g., 1210, to redirect the card authorization request from the acquirer server to the issuer server. The pay network server may provide the card authorization request to the issuer server. In some implementations, the issuer server may parse, e.g., 1211, the card authorization request, and based on the request details may query a database, e.g., 1212, for data of the user's card account. In response, the database may provide the requested user data. On obtaining the user data, the issuer server may determine whether the user can pay for the transaction using funds available in the account, e.g., 1214. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 1215, to the pay network server.

In some implementations, the pay network server may obtain the authorization message, and parse the message to extract authorization details. Upon determining that the user possesses sufficient funds for the transaction (e.g., 1217, option “Yes”), the pay network server may extract the transaction card from the authorization message and/or card authorization request, e.g., 1218, and generate a transaction data record, e.g., 1219, using the card transaction details. In one implementation, In one implementation, the generation of the transaction data record (e.g., 1219) may comprise application and/or entry of an authorized transaction value of the original price (e.g., 274 in FIG. 2B), and application and/or entry of statement credit value of a rebate amount after an offer redemption (e.g., 285 in FIG. 2B; FIG. 2C). The pay network server may provide the transaction data record for storage, e.g., 1220, to a database. In some implementations, the pay network server may forward the authorization message, e.g., 1221, to the acquirer server, which may in turn forward the authorization message, e.g., 1222, to the merchant server. The merchant may obtain the authorization message, and parse the authorization message o extract its contents, e.g., 1223. The merchant server may determine whether the user possesses sufficient funds in the card account to conduct the transaction. If the merchant server determines that the user possess sufficient funds, e.g., 1224, option “Yes,” the merchant server may add the record of the transaction for the user to a batch of transaction data relating to authorized transactions, e.g., 1225. The merchant server may also generate a purchase receipt, e.g., 1227, for the user. In one implementation, In one implementation, the generation of the purchase receipt (e.g., 1227) may comprise application and/or entry of an authorized transaction value of the original price (e.g., 274 in FIG. 2B), and application and/or entry of statement credit value of a rebate amount after an offer redemption (e.g., 285 in FIG. 2B; FIG. 2C). If the merchant server determines that the user does not possess sufficient funds, e.g., 1224, option “No,” the merchant server may generate an “authorization fail” message, e.g., 1228. The merchant server may provide the purchase receipt or the “authorization fail” message to the client. The client may render and display, e.g., 1229, the purchase receipt for the user.

In some implementations, the merchant server may initiate clearance of a batch of authorized transactions by generating a batch data request, e.g., 1230, and providing the request to a database. In response to the batch data request, the database may provide the requested batch data, e.g., 1231, to the merchant server. The server may generate a batch clearance request, e.g., 1232, using the batch data obtained from the database, and provide the batch clearance request to an acquirer server. The acquirer server may generate, e.g., 1234, a batch payment request using the obtained batch clearance request, and provide the batch payment request to a pay network server. The pay network server may parse, e.g., 1235, the batch payment request, select a transaction stored within the batch data, e.g., 1236, and extract the transaction data for the transaction stored in the batch payment request, e.g., 1237. The pay network server may generate a transaction data record, e.g., 1238, and store the transaction data, e.g., 1239, the transaction in a database. In one implementation, the generation of the transaction data record (e.g., 1238) may comprise application and/or entry of an authorized transaction value of the original price (e.g., 74 in FIG. 2B), and application and/or entry of statement credit value of a rebate amount after an offer redemption (e.g., 285 in FIG. 2B; FIG. 2C). For the extracted transaction, the pay network server may generate an issuer server query, e.g., 1240, for an address of an issuer server maintaining the account of the user requesting the transaction. The pay network server may provide the query to a database. In response, the database may provide the issuer server data requested by the pay network server, e.g., 1241. The pay network server may generate an individual payment request, e.g., 1242, for the transaction for which it has extracted transaction data, and provide the individual payment request to the issuer server using the issuer server data from the database.

In some implementations, the issuer server may obtain the individual payment request, and parse, e.g., 1243, the individual payment request to extract details of the request. Based on the extracted data, the issuer server may generate a payment command, e.g., 1244. For example, the issuer server may issue a command to deduct funds from the user's account (or add a charge to the user's credit card account). The issuer server may issue a payment command, e.g., 1245, to a database storing the user's account information. In response, the database may update a data record corresponding to the user's account to reflect the debit/charge made to the user's account. The issuer server may provide a funds transfer message, e.g., 1246, to the pay network server after the payment command has been executed by the database.

In some implementations, the pay network server may check whether there are additional transactions in the batch that need to be cleared and funded. If there are additional transactions, e.g., 1247, option “Yes,” the pay network server may process each transaction according to the procedure described above. The pay network server may generate, e.g., 1248, an aggregated funds transfer message reflecting transfer of all transactions in the batch, and provide, e.g., 1249, the funds transfer message to the acquirer server. The acquirer server may, in response, transfer the funds specified in the funds transfer message to an account of the merchant, e.g., 1250.

FIG. 13A shows a logic flow diagram illustrating exemplary aspects of transforming value equivalent exchange in some embodiments of the L-PROMO. In some implementations, a universal value exchange controller may obtain one or more cross-ecosystem currency exchange instructions, e.g., 1301. For example, such instructions may specify currency source details and currency destination details such as those discussed above. The universal value exchange controller may parse the obtained instructions, and determine the identities of the ecosystems acting as sources and destinations of the currencies, e.g., 1302. The universal value exchange controller may utilize the identities of the source sand destination ecosystems to determine the currency types associated with each of the source and destination currency ecosystems, e.g., 1303. Using the currency types, the universal value exchange controller may determine an exchange rate of each of the source and destination currencies relative to a standard currency, e.g., 1304. For example, the universal value exchange controller may look up the currency exchange rates of the currency types of the currency sources in a relational database using a hypertext preprocessor (PHP) script utilizing Structured Query Language (SQL) commands. In some implementations, the universal value exchange controller may similarly determine the currency exchange rates of the currency types of the currency destinations, e.g., 1305. In some implementations, the universal value exchange controller may parse the cross-ecosystem currency exchange instructions, and obtain account information (e.g., account name, account number, routing number, password, security codes, CVV number, etc.) for the source currencies, e.g., 1306. For example, the universal value exchange controller may utilize such information to obtain access to the purchasing power retained in the currency sources. In some implementations, the universal value exchange controller may parse the cross-ecosystem currency exchange instructions, and obtain account information for the destination currencies, e.g., 1307. For example, the universal value exchange controller may utilize such information to obtain access to the currency destinations for depositing purchasing power into the currency destinations.

In some implementations, the universal value exchange controller may also determine whether there are any restrictions and/or conditions at each of the sources of the currencies, as well as the destinations of the currencies. For example, the universal value exchange controller may query a database to obtain the restrictions and/or conditions for the sources and/or destinations. In some implementations, the universal value exchange controller may generate, e.g., 1309, a currency exchange flow path based on the restrictions and/or conditions at the currency sources and/or destinations. Upon generating the currency exchange flow path, the universal value exchange controller may initiate currency exchange along the generated currency exchange flow path, for example, by providing request messages to the components in the currency exchange flow path to provide and/or accept currency value, based on the generated currency exchange flow path. The universal value exchange controller may monitor the currency exchange flow among the components in the currency exchange flow path until the currency exchange is complete, e.g., 1311-312. Upon completing the currency withdrawal and/or deposits into each of the currency accounts involved in the cross-ecosystem currency exchange, the universal value exchange controller may provide notifications, e.g., 1313, for the users of the universal value exchange controller notifying them of completion of the requested cross-ecosystem currency transaction. In some implementations, the universal value exchange controller may determine whether there are more cross-ecosystem currency exchange instructions remaining to be processed (e.g., 1314, option “Yes”), and perform the cross-ecosystem currency exchanges until all the cross-ecosystem currency exchange instructions have been processed (e.g., 214, option “No”).

FIG. 13B provides example screen shots illustrating consumer value exchange matching within embodiments of the L-PROMO. In one implementation, a consumer may browse a merchant website to shop for a “XYZ Plasma TV” at a price of “$788.99,” which is also available for “UA Mileage 800” and “Amazon Credits 745.” The consumer may also initiate a search 1342 to see whether there are other options to shop for the product with other types of virtual currency. In one implementation, if the consumer selects “Buy with UA Mileage 800” (e.g., the consumer has insufficient Amazon Credits required to complete the purchase, etc.), the L-PROMO may provide an indication 1345 for the consumer, notifying purchasing with UA mileage requires a non-conventional conversion and providing an Amazon Credit offer at “0.88/point” to buy Amazon credits.

FIG. 13C provides example screen shots illustrating alternative implementations of consumer value exchange matching within embodiments of the L-PROMO. In one implementation, a Java applet running on the consumer application (e.g., the browser, etc.) may send an indication of the consumer's opt-in activities, such as browsing merchant information for certain products, and/or the like. The L-PROMO may form a query for plasma TV related merchant offers. In another implementation, the consumer may press “search” 1342 to launch a search to match merchant offers related to “plasma TV.” In one implementation, the L-PROMO may send a message (e.g., email, text message, and/or the like) to the consumer for a merchant offer related to plasma TV. As shown in FIG. 13C, the offer may comprise 1343 a value exchange to encourage the consumer to purchase plasma TV using Amazon credits for a 10% off discount.

### L-PROMO Controller

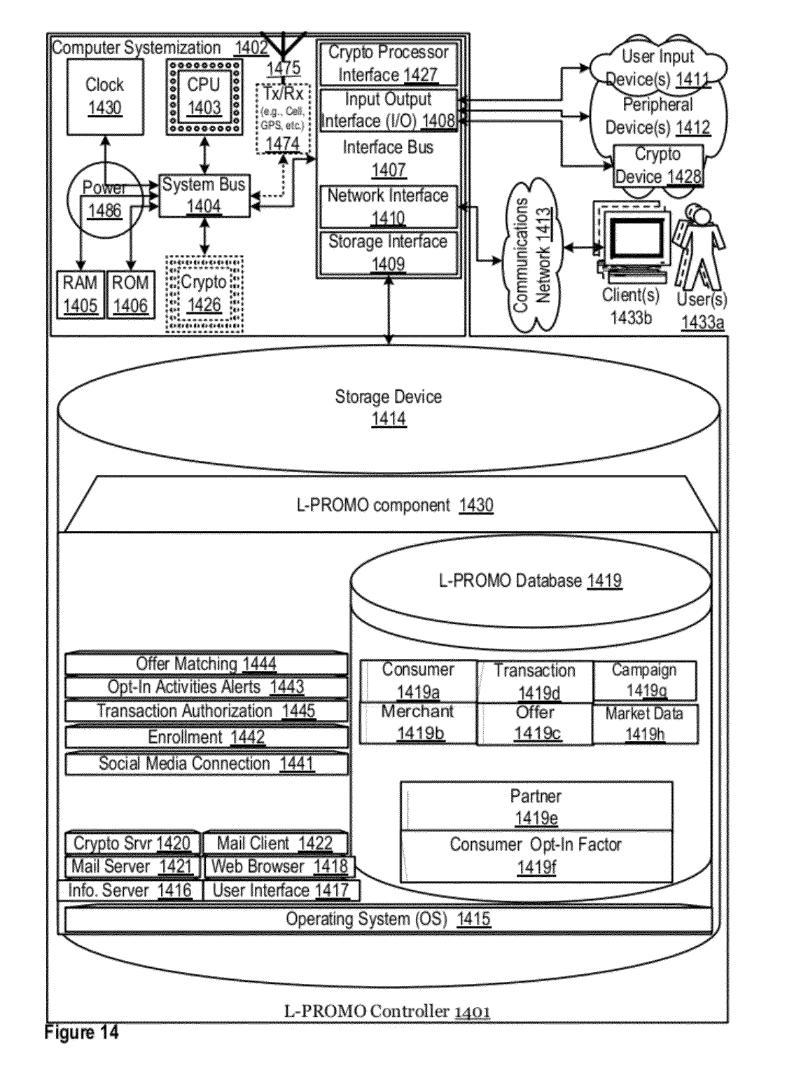

FIG. 14 shows a block diagram illustrating embodiments of a L-PROMO controller. In this embodiment, the L-PROMO controller 1401 may serve to aggregate, process, store, search, serve, identify, instruct, generate, match, and/or facilitate interactions with a computer through encrypt data transmission technologies, and/or other related data.

Typically, users, which may be people and/or other systems, may engage information technology systems (e.g., computers) to facilitate information processing. In turn, computers employ processors to process information; such processors 1403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the L-PROMO controller 1401 may be connected to and/or communicate with entities such as, but not limited to: one or more users from user input devices 1411; peripheral devices 1412; an optional cryptographic processor device 1428; and/or a communications network 1413.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The L-PROMO controller 1401 may be based on computer systems that may comprise, but are not limited to, components such as: a computer systemization 1402 connected to memory 1429.

### Computer Systemization

A computer systemization 1402 may comprise a clock 1430, central processing unit (“CPU(s)” and/or “processor(s)” (these terms are used interchangeable throughout the disclosure unless noted to the contrary)) 1403, a memory 1429 (e.g., a read only memory (ROM) 1406, a random access memory (RAM) 1405, etc.), and/or an interface bus 1407, and most frequently, although not necessarily, are all interconnected and/or communicating through a system bus 1404 on one or more (mother)board(s) 1402 having conductive and/or otherwise transportive circuit pathways through which instructions (e.g., binary encoded signals) may travel to effectuate communications, operations, storage, etc. The computer systemization may be connected to a power source 1486; e.g., optionally the power source may be internal. Optionally, a cryptographic processor 1426 and/or transceivers (e.g., ICs) 1474 may be connected to the system bus. In another embodiment, the cryptographic processor and/or transceivers may be connected as either internal and/or external peripheral devices 1412 via the interface bus I/O. In turn, the transceivers may be connected to antenna(s) 1475, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing L-PROMO controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1429 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the L-PROMO controller and beyond through various interfaces. Should processing requirements dictate a greater amount speed and/or capacity, distributed processors (e.g., Distributed L-PROMO), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the L-PROMO may be achieved by implementing a microcontroller such as CAST's R8051XC2 microcontroller; Intel's MCS 51 (i.e., 8051 microcontroller); and/or the like. Also, to implement certain features of the L-PROMO, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the L-PROMO component collection (distributed or otherwise) and/or features may be implemented via the microprocessor and/or via embedded components; e.g., via ASIC, coprocessor, DSP, FPGA, and/or the like. Alternately, some implementations of the L-PROMO may be implemented with embedded components that are configured and used to achieve a variety of features or signal processing.

Depending on the particular implementation, the embedded components may include software solutions, hardware solutions, and/or some combination of both hardware/software solutions. For example, L-PROMO features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the L-PROMO features. A hierarchy of programmable interconnects allow logic blocks to be interconnected as needed by the L-PROMO system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the L-PROMO may be developed on regular FPGAs and then migrated into a fixed version that more resembles ASIC implementations. Alternate or coordinating implementations may migrate L-PROMO controller features to a final ASIC instead of or in addition to FPGAs. Depending on the implementation all of the aforementioned embedded components and microprocessors may be considered the “CPU” and/or “processor” for the L-PROMO.

### Power Source

The power source 1486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1486 is connected to at least one of the interconnected subsequent components of the L-PROMO thereby providing an electric current to all subsequent components. In one example, the power source 1486 is connected to the system bus component 1404. In an alternative embodiment, an outside power source 1486 is provided through a connection across the I/O 1408 interface. For example, a USB and/or IEEE 1394 connection carries both data and power across the connection and is therefore a suitable source of power.

### Interface Adapters

Interface bus(ses) 1407 may accept, connect, and/or communicate to a number of interface adapters, conventionally although not necessarily in the form of adapter cards, such as but not limited to: input output interfaces (I/O) 1408, storage interfaces 1409, network interfaces 1410, and/or the like. Optionally, cryptographic processor interfaces 1427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1409 may accept, communicate, and/or connect to a number of storage devices such as, but not limited to: storage devices 1414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1410 may accept, communicate, and/or connect to a communications network 1413. Through a communications network 1413, the L-PROMO controller is accessible through remote clients 1433b (e.g., computers with web browsers) by users 1433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed L-PROMO), architectures may similarly be employed to pool, load balance, and/or otherwise increase the communicative bandwidth required by the L-PROMO controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1410 may be used to engage with various communications network types 1413. For example, multiple network interfaces may be employed to allow for the communication over broadcast, multicast, and/or unicast networks.

Input Output interfaces (I/O) 1408 may accept, communicate, and/or connect to user input devices 1411, peripheral devices 1412, cryptographic processor devices 1428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1411 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1412 may be connected and/or communicate to I/O and/or other facilities of the like such as network interfaces, storage interfaces, directly to the interface bus, system bus, the CPU, and/or the like. Peripheral devices may be external, internal and/or part of the L-PROMO controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the L-PROMO controller may be embodied as an embedded, dedicated, and/or monitor-less (i.e., headless) device, wherein access would be provided over a network interface connection.

Cryptographic units such as, but not limited to, microcontrollers, processors 1426, interfaces 1427, and/or devices 1428 may be attached, and/or communicate with the L-PROMO controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1429. However, memory is a fungible technology and resource, thus, any number of memory embodiments may be employed in lieu of or in concert with one another. It is to be understood that the L-PROMO controller and/or a computer systemization may employ various forms of memory 1429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1429 will include ROM 1406, RAM 1405, and a storage device 1414. A storage device 1414 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1429 may contain a collection of program and/or database components and/or data such as, but not limited to: operating system component(s) 1415 (operating system); information server component(s) 1416 (information server); user interface component(s) 1417 (user interface); Web browser component(s) 1418 (Web browser); database(s) 1419; mail server component(s) 1421; mail client component(s) 1422; cryptographic server component(s) 1420 (cryptographic server); the L-PROMO component(s) 1435; and/or the like (i.e., collectively a component collection). These components may be stored and accessed from the storage devices and/or from storage devices accessible through an interface bus. Although non-conventional program components such as those in the component collection, typically, are stored in a local storage device 1414, they may also be loaded and/or stored in memory such as: peripheral devices, RAM, remote storage facilities through a communications network, ROM, various forms of memory, and/or the like.

### Operating System

The operating system component 1415 is an executable program component facilitating the operation of the L-PROMO controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the L-PROMO controller to communicate with other entities through a communications network 1413. Various communication protocols may be used by the L-PROMO controller as a subcarrier transport mechanism for interaction, such as, but not limited to: multicast, TCP/IP, UDP, unicast, and/or the like.

### Information Server

An information server component 1416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the L-PROMO controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the L-PROMO database 1419, operating systems, other program components, user interfaces, Web browsers, and/or the like.

Access to the L-PROMO database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the L-PROMO. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the L-PROMO as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc, interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components 3 through facilities such as ActiveX, AJAX, (D)HTML, FLASH, Java, JavaScript, web 4 browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the L-PROMO enabled nodes. The combined application may be nugatory on systems employing standard Web browsers.

### Mail Server

A mail server component 1421 is a stored program component that is executed by a CPU 1403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the L-PROMO.

Access to the L-PROMO mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1422 is a stored program component that is executed by a CPU 1403. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1420 is a stored program component that is executed by a CPU 1403, cryptographic processor 1426, cryptographic processor interface 1427, cryptographic processor device 1428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the L-PROMO may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the L-PROMO component to engage in secure transactions if so desired. The cryptographic component facilitates the secure accessing of resources on the L-PROMO and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The L-PROMO Database

The L-PROMO database component 1419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the L-PROMO database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the L-PROMO database is implemented as a data-structure, the use of the L-PROMO database 1419 may be integrated into another component such as the L-PROMO component 1435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1419 includes several tables 1419a-e. A consumer accounts table 1419a includes fields such as, but not limited to: a ConsumerID, ConsumerName, ConsumerPassword, ConsumerAddress, ConsumerIncome, ConsumerBankAccount, ConsumerPreference, ConsumerTransaction, ConsumerLoyalty, and/or the like. The Consumer table may support and/or track multiple entity accounts on a L-PROMO. A merchant table 1419b includes fields such as, but not limited to: MerchantID, MerchantName, MerchantBrand, MerchantTerminal, MerchantAddress, MerchantGPS, MerchantURL, MerchantEnrolledSite, MerchantTransaction, MerchantLoyaltyID, and/or the like. An Offer table 1419c includes fields such as, but not limited to: OfferID, OfferName, OfferMerchantID, OfferType, OfferStartDate, OfferEndDate, OfferSource, OfferTerms, OfferCriteria, OfferRedemptionDate, and/or the like. A transaction table 1419d includes fields such as, but not limited to: TransactionID, TransactionTime, TransactionAmount, TransactionConsumerID, TransactionMerchantID, TransactionProductID, TransactionOfferID, TransactionOfferStatus, and/or the like. A partner table 1419e includes fields such as, but not limited to: PartnerID, PartnerName, PartnerType, PartnerAddress, PartnerZipCOde, PartnerCheckIn, PartnerAccount, and/or the like. A consumer opt-in factors table 1419f includes fields such as, but not limited to: ConsumerID, ConsumerName, GovenrmentPolicy, HealthcareInfo, ConsumerSocialMedia, ConsumerInsurance, ConsumerTwitterOptlnSettings, ConsumerFacebookOptInSettings, and/or the like.

In one embodiment, the L-PROMO database may interact with other database systems. For example, employing a distributed database system, queries and data access by search L-PROMO component may treat the combination of the L-PROMO database, an integrated data security layer database as a single database entity.

In one embodiment, user programs may contain various user interface primitives, which may serve to update the L-PROMO. Also, various accounts may require custom database tables depending upon the environments and the types of clients the L-PROMO may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1419a-e. The L-PROMO may be configured to keep track of various settings, inputs, and parameters via database controllers.

The L-PROMO database may communicate to and/or with other components in a component collection, including itself, and/or facilities of the like. Most frequently, the L-PROMO database communicates with the L-PROMO component, other program components, and/or the like. The database may contain, retain, and provide information regarding other nodes and data.

### The L-PROMOs

The L-PROMO component 1435 is a stored program component that is executed by a CPU. In one embodiment, the L-PROMO component incorporates any and/or all combinations of the aspects of the L-PROMO that was discussed in the previous figures. As such, the L-PROMO affects accessing, obtaining and the provision of information, services, transactions, and/or the like across various communications networks.

The L-PROMO transforms consumer credentials, consumer opt-in activities, and, merchant campaign setup inputs via L-PROMO components social media connection 1041, enrollment module 1042, consumer opt-in activities alerts 1043, offer matching engine 1044, and/or transaction authorization 1045, into a financial transaction and offer redemption outputs.

The L-PROMO component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the L-PROMO server employs a cryptographic server to encrypt and decrypt communications. The L-PROMO component may communicate to and/or with other components in a component collection, including itself, and/or facilities of the like. Most frequently, the L-PROMO component communicates with the L-PROMO database, operating systems, other program components, and/or the like. The L-PROMO may contain, communicate, generate, obtain, and/or provide program component, system, user, and/or data communications, requests, and/or responses.

### Distributed L-PROMOs

The structure and/or operation of any of the L-PROMO node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the L-PROMO controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the L-PROMO controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
      $input = “”;
      $input = socket_read($client, 1024);
      $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

Additional embodiments of the L-PROMO may comprise the following.

1. A method comprising a plurality of steps, each being performed by hardware executing software, wherein the steps include: receiving, at a transaction handler from a merchant's acquirer, an authorization request for a transaction, wherein: the transaction is conducted between the merchant and an accountholder on an account issued by an issuer to the accountholder; any said transaction on the account can only be conducted with the merchant; and the authorization request includes an amount for the transaction; sending, from the transaction handler for delivery to the issuer, the authorization request; receiving, at the transaction handler from the issuer, an authorization response to the authorization request, wherein the authorization response includes an amount different than the amount for the transaction; and sending, from the transaction handler for delivery to the merchant's acquirer, the authorization response.

2. The method as defined in claim 1, wherein the issuer is the acquirer.

3. The method as defined in claim 1, wherein the steps further comprise facilitating, by the transaction handler, clearing and settlement of the transaction on the account between the issuer and the merchant's acquirer for the amount in the authorization response.

4. The method as defined in claim 1, the authorization response for the transaction received and sent by the transaction handler includes an indicator from the issuer that the transaction is the first said transaction conducted on the account.

5. The method as defined in claim 4, wherein the difference between the amounts in the authorization request and the authorization response is based upon a promotion as determined from the indicator from the issuer that the transaction is the first said transaction conducted on the account.

6. The method as defined in claim 1, wherein the authorization request for the transaction received and sent by the transaction handler includes an identifier for a item being purchased by the accountholder from the merchant.

7. The method as defined in claim 6, wherein the difference between the amounts in the authorization request and the authorization response is based upon a promotion for the item as determined from the identifier for the item being purchased by the accountholder from the merchant.

8. The method as defined in claim 1, wherein the transaction is processing for authorization, clearing and settlement in an open loop system.

9. The method as defined in claim 1, wherein: the steps further comprise the transaction handler respectively receiving and sending a plurality of: other said authorization requests; and other said authorization responses; each of the other said authorization requests and the other said authorization responses are for other said transactions; each of the other said transactions is conducted on a respective other said account; each of the other said accounts are issued by other said issuers to other said accountholders; and each of the other said accountholders can conduct a transaction the other said account issued thereto with a plurality of different said merchants. A computer readable medium comprising instructions which, when executed by the hardware, performs the steps of claim 1.

10. A method comprising a plurality of steps, each being performed by hardware executing software, wherein the steps include: receiving, at a transaction handler from a merchant's acquirer, an authorization request for a transaction, wherein: the transaction is conducted between the merchant and an accountholder on an account issued by an issuer to the accountholder; any said transaction on the account can only be conducted with the merchant; the issuer is the acquirer; and the authorization request includes: an amount for the transaction; and an identifier for a item being purchased by the accountholder from the merchant; sending, from the transaction handler for delivery to the issuer, the authorization request; receiving, at the transaction handler from the issuer, an authorization response to the authorization request, wherein the authorization response includes: an amount different than the amount for the transaction; and an indicator from the issuer that the transaction is the first said transaction conducted on the account; sending, from the transaction handler for delivery to the merchant's acquirer, the authorization response; facilitating, by the transaction handler, clearing and settlement of the transaction on the account between the issuer and the merchant's acquirer for the amount in the authorization response, wherein the difference between the respective said amount in the authorization request and the authorization response is based upon at least one of: the indicator from the issuer that the transaction is the first said transaction conducted on the account; and the identifier for the item being purchased by the accountholder from the merchant.

11. The method as defined in claim 10, wherein: the steps further comprise the transaction handler respectively receiving and sending a plurality of: other said authorization requests; and other said authorization responses; each of the other said authorization requests and the other said authorization responses are for other said transactions; each of the other said transactions is conducted on a respective other said account; each of the other said accounts are issued by other said issuers to other said accountholders; and each of the other said accountholders can conduct a transaction the other said account issued thereto with a plurality of different said merchants.

12. A computer readable medium comprising instructions which, when executed by the hardware, performs the steps of claim 10.

13. A method comprising a plurality of steps, each being performed by hardware executing software, wherein the steps include: receiving, at a merchant, information for a transaction for a purchase of a promotion item and a non-promotional item, wherein: information includes an identifier for: an account issued by an issuer to the accountholder for the transaction which is being conducted on the account between the merchant and the accountholder; and the promotional item; and any said transaction on the account can only be conducted with the merchant; sending, from the merchant, an authorization request for the transaction for delivery to the issuer through a communication path through an acquirer and a transaction handler before the delivery to the issuer; receiving, at the merchant from the acquirer, an authorization response to the authorization request; sending, in a transmission directly from the merchant to the issuer, a promotional item settlement request that includes: the identifier for the promotional item; the identifier for the account; and an identifier for the transaction; sending, from the merchant, a transaction clearing request for the transaction for delivery to the issuer through a communication path through the acquirer and the transaction handler before the delivery to the issuer; receiving, at the merchant, a promotional item clearing response to the promotional item settlement request, wherein the promotional item clearing response includes settlement information corresponding to promotional financing from the issuer to the account holder derived from the identifier for the promotional item; and receiving, at the merchant from the acquirer, a transaction clearing response to the transaction settlement request.

14. The method as defined in claim 13, wherein the issuer is the acquirer.

15. The method as defined in claim 13, wherein the authorization response includes an indicator that the transaction is the first said transaction conducted on the account. 16. The method as defined in claim 15, wherein: the authorization request and the authorization response include different amounts for the transaction; and the difference between the respective said amount in the authorization request and the authorization response is based upon at least one of: the transaction is the first said transaction conducted on the account; and the identifier for the promotional item.

17. The method as defined in claim 13, wherein the transaction is processing for authorization, clearing and settlement in an open loop system.

18. The method as defined in claim 13, wherein:

the transaction handler respectively receives and sends a plurality of: other said authorization requests; and other said authorization responses; each of the other said authorization requests and the other said authorization responses are for other said transactions; each of the other said transactions is conducted on a respective other said account; each of the other said accounts are issued by other said issuers to other said accountholders; and each of the other said accountholders can conduct a transaction the other said account issued thereto with a plurality of different said merchants.

A computer readable medium comprising instructions which, when executed by the hardware, performs the steps of claim 13.

In order to address various issues and advance the art, the entirety of this application for LOYALTY PROMOTION APPARATUSES, METHODS AND SYSTEMS (including the Cover Page, Title, Headings, Field, Background, Summary, Brief Description of the Drawings, Detailed Description, claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a L-PROMO individual and/or enterprise user, database configuration and/or relational model, data type, data transmission and/or network framework, syntax structure, and/or the like, various embodiments of the L-PROMO, may be implemented that enable a great deal of flexibility and customization. For example, aspects of the L-PROMO may be adapted for electronic wallet. While various embodiments and discussions of the L-PROMO have been directed to loyalty programs, however, it is to be understood that the embodiments described herein may be readily configured and/or customized for a wide variety of other applications and/or implementations.

What is claimed is:

1. A promotion redemption processor-implemented method, comprising:
receiving consumer identifying information from a consumer electronic wallet vehicle;
receiving merchant information and a proposed transaction from a merchant terminal;
initiating consumer payment by sending a payment approval to an electronic wallet account;
receiving a request to apply a promotional offer;
determining consumer eligibility to apply the promotional offer to the proposed transaction;
applying the promotional offer to the proposed transaction by returning credits to the consumer based on terms of the promotional offer;
sending transaction details to the consumer; and
sending a message to a social network indicating the transaction on the consumer's social media page.

2. The method of claim 1, wherein the consumer identification information comprises a card number.

3. The method of claim 1, wherein the merchant information comprises a merchant ID.

4. The method of claim 1, wherein the promotional offer is provided by the merchant.

5. The method of claim 1, wherein the consumer receives the promotional offer in an email.

6. The method of claim 1, wherein the consumer receives the promotional offer via social network news feeds.

7. The method of claim 1, wherein the consumer receives the promotional offer via in-store messages.

8. The method of claim 1, wherein the consumer receives the promotional offer via mobile messages.

9. The method of claim 1, further comprising:
receiving information related to consumer opt-in activities related to the promotional offer;
presenting the promotional offer to the consumer.

10. The method of claim 9, wherein the opt-in activities comprise click on a social media news feed related to the promotional offer.

11. The method of claim 10, wherein the social media news feed is posted by a merchant on the merchant social media page.

12. The method of claim 10, wherein the social media news feed is posted by a friend of the consumer's on the friend's social media page.

10. The method of claim 1, further comprising:
retrieve a record of merchant offers;
generating a query based on the received information on the record of merchant offers;
obtaining a list of matched offers from the query; and
sending the list of matched offers to the consumer.

11. The method of claim 1, wherein the promotional offer comprise a loyalty requirement.

12. The method of claim 11, further comprising determining whether the proposed transaction of the consumer satisfies the loyalty requirement.

13. The method of claim 1, wherein the message is automatically populated on the consumer's social network page as a social news feed.

14. The method of claim 13, wherein the social news feed comprises a link to a page describing the promotional offer.

15. The method of claim 14, wherein the link directs to the merchant's social media page.

16. The method of claim 14, wherein the link directs to a stand alone merchant's website.

17. The method of claim 1, further comprising retrieving consumer social media account credentials provided for registration, and sending the credentials to the social network for verification.

18. The method of claim 1, wherein the returned credits are applied as a rebate amount.

19. A promotion redemption system, comprising:
means for receiving consumer identifying information from a consumer electronic wallet vehicle;
means for receiving merchant information and a proposed transaction from a merchant terminal;
means for initiating consumer payment by sending a payment approval to an electronic wallet account;
means for receiving a request to apply a promotional offer;
means for determining consumer eligibility to apply the promotional offer to the proposed transaction;
means for applying the promotional offer to the proposed transaction by returning credits to the consumer based on terms of the promotional offer;
means for sending transaction details to the consumer; and
means for sending a message to a social network indicating the transaction on the consumer's social media page.

20. A promotion redemption processor-readable medium storing processor-issuable-and-generated instructions to:
receive consumer identifying information from a consumer electronic wallet vehicle;
receive merchant information and a proposed transaction from a merchant terminal;
initiate consumer payment by sending a payment approval to an electronic wallet account;
receive a request to apply a promotional offer;
determine consumer eligibility to apply the promotional offer to the proposed transaction;
apply the promotional offer to the proposed transaction by returning credits to the consumer based on terms of the promotional offer;
send transaction details to the consumer; and
send a message to a social network indicating the transaction on the consumer's social media page.

21. A promotion redemption processor-implemented method, comprising:
receiving a consumer registration request;
receiving consumer information for registration;
creating a new account and establishing login credentials based on the received consumer information;
prompting the consumer to provide social media account credentials;
linking to a social media platform to verify the social media account credentials; and
associating the social media account to the created new account.

22. The method of claim 21, further comprising:
receiving consumer specification of interests.

23. The method of claim 22, further comprising:
forming a query on registered merchants and promotional offers based on the received consumer interest.

24. The method of claim 22, further comprising linking a merchant social media page to the created new account based on the query.

25. The method of claim 22, further comprising adding a list of promotional offers to the created new account based on the query.

26. A merchant campaign processor-implemented method, comprising:
instantiating a merchant campaign component;
establishing merchant campaign parameters via the merchant campaign component;
generating and submitting promotional offers;
receiving consumer opt-in activities indicative of usages of the promotional offers;
analyzing campaign performance based on the received consumer activities; and
adjusting campaign parameters based on the performance analytics.

27. The method of claim 26, wherein the merchant campaign component is a web application.

28. The method of claim 26, wherein the merchant campaign component is an add-on tool to the merchant's social media page.

29. The method of claim 26, further comprising providing merchant information to enroll in a campaign management community.

30. The method of claim 26, wherein the merchant campaign parameters comprise offer types, target audience, duration, terms, budget.

31. The method of claim 26, further comprising establishing a campaign objective.

32. The method of claim 26, further comprising loading data from data sources to determine evaluative metrics indicating campaign performance.

33. The method of claim 32, wherein the data sources comprises one of:
campaign component logs, Google analytics, social media logs.

34. The method of claim 32, wherein the evaluative metrics comprising a cost per event parameter.

35. The method of claim 34, wherein the event comprises one of:
consumer awareness of an offer, consumer engagement of an offer, consumer usage of an offer, consumer sharing of an offer.

36. The method of claim 1, further comprising:
receiving an offer redemption request without consumer triggering after the transaction.

37. The method of claim 1, further comprising:
determining an offer identifier associated with the offer;
verifying whether the offer is valid based on the offer identifier; and
determining a sponsor of the offer, wherein the sponsor may be one of a merchant, a third party, an offer issuer and a processing network.

38. The method of claim 1, wherein the determining consumer eligibility to apply the promotional offer to the proposed transaction comprises:
determining whether the consumer has sufficient loyalty to redeem the offer.

39. The method of claim 38, further comprising:
determining whether the offer permits loyalty point conversion; and
prompting the consumer to authorize loyalty point conversion.

40. The method of claim 1, further comprising:
calculating the returning credits based on the offer; and
automatically crediting the returning credits to the consumer without the consumer's triggering after the transaction.

41. The method of claim 40, further comprising:
obtaining payment of the returning credits from a sponsor of the offer.
